(19) United States
(12) Patent Application Publication
(10) Pub. No.: US 2026/0154553 A1
(43) Pub. Date: Jun. 4, 2026

(54) System for Cross-Domain Animal, Human and Robot Communication and Collaborative Action Coordination

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 19/339,295

(22) Filed: Sep. 24, 2025

Related U.S. Application Data
(63) Continuation-in-part of application No. 19/315,860, filed on Sep. 2, 2025.
Application No. 19/315,860 is a continuation-in-part of application No. 19/308,299, filed on Aug. 24, 2025.
Application No. 19/308,299 is a continuation-in-part of application No. 19/264,846, filed on Jul. 9, 2025.
Application No. 19/264,846 is a continuation-in-part of application No. 19/252,175, filed on Jun. 27, 2025.
Application No. 19/252,175 is a continuation-in-part of application No. 19/183,827, filed on Apr. 19, 2025.
Application No. 19/183,827 is a continuation-in-part of application No. 19/080,768, filed on Mar. 14, 2025.
Application No. 19/080,768 is a continuation-in-part of application No. 19/079,358, filed on Mar. 13, 2025.
Application No. 19/079,358 is a continuation-in-part of application No. 19/056,728, filed on Feb. 18, 2025.
Application No. 19/056,728 is a continuation-in-part of application No. 19/041,999, filed on Jan. 31, 2025.
Application No. 19/041,999 is a continuation-in-part of application No. 18/656,612, filed on May 7, 2024.
Application No. 19/252,175 is a continuation-in-part of application No. 19/180,100, filed on Apr. 15, 2025.
(63) Continuation-in-part of application No. 19/280,079, filed on Jul. 24, 2025.
Application No. 19/280,079 is a continuation-in-part of application No. 19/183,828, filed on Apr. 19, 2025.
Application No. 19/183,828 is a continuation-in-part of application No. 19/177,640, filed on Apr. 14, 2025.
Application No. 19/177,640 is a continuation-in-part of application No. 19/172,638, filed on Apr. 7, 2025.
Application No. 19/172,638 is a continuation-in-part of application No. 19/094,808, filed on Mar. 28, 2025.
Application No. 19/094,808 is a continuation-in-part of application No. 19/078,192, filed on Mar. 12, 2025.
(60) Provisional application No. 63/551,328, filed on Feb. 8, 2024.

(51) Int. Cl. G06N 3/088; G06N 3/045

(52) U.S. Cl. CPC G06N 3/088; G06N 3/045

(57) ABSTRACT

Disclosed embodiments provide a system and method for animal-to-human translation. Disclosed embodiments can accept multimodal non-human animal communication data as input, such as vocalizations, gestures, brainwaves, and/or biometric indicators, and apply a machine-learning enabled debate-based oversight approach for determining a likely translation outcome. Disclosed embodiments perform a debate-based oversight process to obtain a decision on one or more meanings for received non-human animal communication data. The one or more meanings are associated with a human interpretation. A cross-species operation is performed based on the human interpretation. The cross-species operation can include rendering and/or presenting a translation on an output device such as an electronic display and/or audio speaker. The cross-species operation can include issuing a robot control command based on the human interpretation.

### CROSS-REFERENCE TO RELATED APPLICATIONS

Priority is claimed in the application data sheet to the following patents or patent applications, each of which is expressly incorporated herein by reference in its entirety:
Ser. No. 19/315,860
Ser. No. 19/308,299
Ser. No. 19/264,846
Ser. No. 19/252,175
Ser. No. 19/183,827
Ser. No. 19/080,768
Ser. No. 19/079,358
Ser. No. 19/056,728
Ser. No. 19/041,999
Ser. No. 18/656,612
63/551,328
Ser. No. 19/180,100
Ser. No. 19/280,079
Ser. No. 19/183,828
Ser. No. 19/177,640
Ser. No. 19/172,638
Ser. No. 19/094,808
Ser. No. 19/078,192

### BACKGROUND OF THE INVENTION

### Field of the Art

The present disclosure relates to the field of animal and robot and human interactions and coordination enablement. More specifically, the present disclosure pertains to systems and methods that relate to communication with software and animals and robots and people.

### Discussion of the State of the Art

Throughout history, humans and animals have shared profound interactions that span practical, emotional, and symbiotic dimensions. Horses, for instance, revolutionized transportation and agriculture, offering speed and strength that transformed societies. Dogs, initially domesticated for hunting and protection, have evolved into loyal companions, enriching lives with their affection and utility. Cats were once revered for their role in controlling rodent populations, yet today they are cherished for their companionship and independent charm. Beyond individual relationships, humans and animals have developed symbiotic partnerships, such as farmers relying on bees for pollination or shepherds depending on dogs to manage livestock, therefore creating systems that benefit both species. These diverse interactions highlight a deep interdependence, underscoring the value of coexistence and mutual respect between humans and animals.

### SUMMARY OF THE INVENTION

Disclosed embodiments provide a system and method for animal-to-human, robot and software translation, communication, planning, coordination and collaborative action. Disclosed embodiments can accept multimodal non-human animal communication data as input, such as vocalizations, gestures, brainwaves, and/or biometric indicators, and apply a machine-learning enabled debate-based oversight approach for determining a likely translation outcome. Disclosed embodiments perform a debate-based oversight process to obtain a decision on one or more meanings for received non-human animal communication data. The one or more meanings are associated with a human interpretation. A cross-species operation is performed based on the human interpretation. The cross-species operation can include rendering and/or presenting a translation on an output device such as an electronic display and/or audio speaker. The cross-species operation can include issuing a robot control command based on the human interpretation. In this way, animals can directly control robotic equipment and engage in collaborative actions with humans and machines, opening up a wide array of possibilities in both animal-human and animal-machine interactions through genuine communication and coordination rather than just translation.

Disclosed embodiments provide systems and methods that can enable animal-to-human and animal-to-machine communication, providing potentially groundbreaking opportunities across diverse fields, fostering better understanding, care, and collaboration between species. In wildlife monitoring and conservation, disclosed embodiments can help decode animal vocalizations or behaviors to alert researchers to threats such as poaching, habitat degradation, or health issues. Disclosed embodiments can enable animals to play an active role in conservation efforts by triggering drones and/or robotic monitors when they detect danger, creating a more responsive and less intrusive approach to ecosystem management, environmental protection, and urban development. Disclosed embodiments may also assist in gathering critical data for studying animal behavior and ecology, aiding in the preservation of endangered species.

For service animals, disclosed embodiments can enable communication systems to significantly enhance their functionality and the safety of their human companions. A service dog, for example, can use vocalizations and/or multimodal data detected by a wearable electronic device to directly summon help and/or activate medical devices when sensing an emergency such as a seizure. In disaster response and search-and-rescue operations, trained animals equipped with communication devices can relay detailed information about their findings to human teams or coordinate with robotic units to navigate dangerous environments, improving efficiency and reducing risks to both humans and animals.

On a personal and institutional level, disclosed embodiments can promote improved animal care, rehabilitation, and enrichment. For example, pet owners could better understand their animals' needs, such as hunger, stress, or affection, improving welfare and deepening bonds. In rehabilitation centers, disclosed embodiments can enable injured or distressed animals to convey their comfort levels or specific needs more clearly, speeding recovery and reducing stress. Zoos may also benefit from disclosed embodiments for behavioral enhancement, allowing animals to interact with their environment in more meaningful ways, and providing new types of stimulus, such as requesting specific enrichment activities or meals. By bridging the communication gap, disclosed embodiments may enhance human-animal relationships, and also promote a more compassionate and symbiotic coexistence across species.

According to a preferred embodiment, there is provided a system for animal-to-human communication, comprising: a computing device comprising at least a memory and a processor; and a plurality of programming instructions that, when operating on the processor, cause the computing device to: receive non-human animal communication data; and process the non-human animal communication data through a machine-learning system, wherein the machine-learning system is trained using unsupervised training techniques, and wherein the machine-learning system is configured to: perform a debate-based oversight process to obtain a decision on one or more meanings for the non-human animal communication data; associate the one or more meanings with a human interpretation; and perform a cross-species operation based on the human interpretation.

According to another preferred embodiment, there is provided a method for animal-to-human communication, comprising: receiving non-human animal communication data; and processing the non-human animal communication data through a machine-learning system, wherein the machine-learning system is trained using unsupervised training techniques, and wherein the machine-learning system is configured to: perform a debate-based oversight process to obtain a decision on one or more meanings for the non-human animal communication data; associate the one or more meanings with a human interpretation; and perform a cross-species operation based on the human interpretation.

According to another embodiment, the plurality of programming instructions further includes instructions to perform an additional translation stage, wherein the additional translation stage comprises converting the human interpretation to a robot command.

According to another embodiment, the plurality of programming instructions further includes instructions to perform a debate-based oversight process on the additional translation stage as part of the converting the human interpretation to the robot command.

According to another embodiment, the plurality of programming instructions further includes instructions to store the non-human animal communication data, debate-based oversight outcome data, and human interpretation in an embeddings cache.

According to another embodiment, the debate-based oversight process is configured to use a primary debate machine-learning system and a secondary debate machine-learning system, wherein the primary debate machine-learning system is trained on a primary dataset, and wherein the secondary debate machine-learning system is trained on a secondary dataset, wherein the primary dataset is larger than the secondary dataset.

According to another embodiment, the primary debate machine-learning system comprises a large language model, and the secondary debate machine-learning system comprises a small language model.

According to another embodiment, the primary debate machine-learning system comprises a large language model, and the secondary debate machine-learning system comprises a generative adversarial network (GAN).

According to another embodiment, the debate-based oversight process is configured to use a first expert debate machine-learning system, a second expert machine-learning system, and a judge machine-learning system, wherein the first expert debate machine-learning system and second expert debate machine-learning system are trained on a primary dataset, and wherein the judge machine-learning system is trained on a secondary dataset, wherein the primary dataset is larger than the secondary dataset, and wherein the judge machine-learning system is configured to select a human interpretation result from one of the first expert debate machine-learning system and the second expert debate machine-learning system.

According to another embodiment, the plurality of programming instructions further includes instructions to perform a Monte Carlo Tree Search process to prune a branch corresponding to the human interpretation result that was selected, based on multimodal input data.

According to another embodiment, there is provided a non-transitory, computer-readable medium comprising programming instructions for an electronic computation device executable by a processor to cause the electronic computation device to: receive non-human animal communication data; and process the non-human animal communication data through a machine-learning system, wherein the machine-learning system is trained using unsupervised training techniques, and wherein the machine-learning system is configured to: perform a debate-based oversight process to obtain a decision on one or more meanings for the non-human animal communication data; associate the one or more meanings with a human interpretation; and perform a cross-species operation based on the human interpretation.

### BRIEF DESCRIPTION OF THE DRAWING FIGURES

FIG. 1 shows an exemplary environment in which a system for multimodal orchestration for human-animal-robot collaborative task execution can be used, in accordance with one or more embodiments.

FIG. 2 is a block diagram illustrating components of a system for multimodal orchestration for human-animal-robot collaborative task execution, in accordance with one or more embodiments.

FIG. 3 is a block diagram illustrating details of a neural interface component, in accordance with one or more embodiments.

FIG. 4 is a block diagram illustrating details of a translation processing unit, in accordance with one or more embodiments.

FIG. 5 is a block diagram illustrating details of a multi-species output unit, in accordance with one or more embodiments.

FIG. 6 is a block diagram illustrating details of a multi-species collaboration layer, in accordance with one or more embodiments.

FIG. 7 is a block diagram illustrating details of a large language model (LLM) orchestration system, in accordance with one or more embodiments.

FIG. 8 is a block diagram illustrating details of a Simultaneous Localization and Mapping (SLAM) system, in accordance with one or more embodiments.

FIG. 9 is a block diagram illustrating an exemplary training system for cross-domain animal-to-human communication, in accordance with one or more embodiments.

FIG. 10 shows an exemplary environment in which a system for cross-domain animal-to-human communication can be used, in accordance with one or more embodiments.

FIG. 11 shows another exemplary environment in which a system for cross-domain animal-to-human communication can be used, in accordance with one or more embodiments.

FIG. 12 shows a block diagram of an exemplary non-invasive sensor, in accordance with one or more embodiments.

FIG. 13 is a block diagram illustrating components of a system for animal-to-human communication with debate-based oversight, in accordance with one or more embodiments.

FIG. 14 is a block diagram illustrating details of a debate-based oversight module, in accordance with one or more embodiments.

FIG. 15 is a flow diagram illustrating an exemplary method for animal-to-human communication with debate-based oversight, according to one or more embodiments.

FIG. 16 is a flow diagram illustrating an exemplary method for training a system for animal-to-human communication, according to one or more embodiments.

FIG. 17 is a block diagram illustrating an expanded multimodal orchestration system with integration of a multimodal foundation model for universal translation (MFUT).

FIG. 18 is a block diagram illustrating an expanded neural interface component with real-time bidirectional neural input and output.

FIG. 19 is a block diagram illustrating an expanded LLM orchestration system with integration of a cross-application agent grid.

FIG. 20 is a block diagram illustrating an expanded simultaneous localization and mapping (SLAM) system with stimulus-resolved world-model reinforcement learning.

FIG. 21 is a block diagram illustrating an expanded neural interface component with integration of a behavioral economy interdiction and negotiation system (BE-INS).

FIG. 22 is a flow diagram illustrating an exemplary method for multimodal universal translation across species and modalities.

FIG. 23 is a flow diagram illustrating an exemplary method for real-time bidirectional neural input and output.

FIG. 24 is a flow diagram illustrating an exemplary method for distributed agent collaboration using a cross-application grid.

FIG. 25 is a flow diagram illustrating an exemplary method for stimulus-resolved world-model learning and reinforcement calibration.

FIG. 26 is a flow diagram illustrating an exemplary method for longitudinal interest estimation across species and modalities.

FIG. 27 is a flow diagram illustrating an exemplary method for behavioral economy interdiction and negotiation in opportunistic animal societies.

FIG. 28 is a flow diagram illustrating an exemplary method for bio-complexity-aware pragmatic world-modeling and planning.

FIG. 29 is a flow diagram illustrating an exemplary method for frequency-persona curriculum learning and developmental co-optimization.

FIG. 30 illustrates an exemplary computing environment on which an embodiment described herein may be implemented, in full or in part.

FIG. 31 is a flow diagram illustrating an exemplary method for multimodal integration with large language model (LLM) and non-LLM artificial intelligence models, according to one embodiment.

FIG. 32 is a flow diagram illustrating an exemplary method for memory-mosaic fabric integration into the multimodal orchestration system for cross-species communication and collaboration, according to one embodiment.

FIG. 33 is a flow diagram illustrating an exemplary method for the CIF/TAUMOS-orchestrated cross-species multimodal integration, according to one embodiment.

The drawings are not necessarily to scale. The drawings are merely schematic representations, not intended to portray specific parameters of the disclosed embodiments. The drawings are intended to depict only typical embodiments of the invention, and therefore should not be considered as limiting in scope.

### DETAILED DESCRIPTION OF THE INVENTION

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to use in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “small language model (SLM)” refers to a natural language processing model designed with a smaller architecture, fewer parameters, and reduced computational requirements compared to large language models. Despite its smaller size, an SLM can be highly effective for specific tasks when fine-tuned or trained on well-curated, domain-specific data.

As used herein, “brainwave sensor” refers to a device that detects and records electrical activity in the brain, such as using electroencephalography (EEG) or similar technology. These sensors work by measuring the small voltage fluctuations generated by neural activity and translating them into readable signals.

As used herein, the term “cognitive condition,” in the context of non-human animals, refers comprehensively to their current mental and emotional state, encompassing their subjective experiences, internal perceptions, and motivational readiness. It broadly includes factors such as attentiveness, alertness, engagement, curiosity, focus, stress levels, anxiety, relaxation, boredom, fatigue, confusion, fear, excitement, and contentment, as well as motivational conditions like willingness or reluctance to participate in tasks. Additionally, cognitive condition may reflect complex emotional states derived from environmental interactions, social contexts, and training experiences. The cognitive condition can be inferred through the analysis of neural patterns derived from brain activity, behavioral indicators such as body posture, vocalizations, movements, and facial expressions, and physiological markers including but not limited to heart rate variability, cortisol or other stress-related hormone levels, respiratory patterns, temperature fluctuations, pupil dilation, and galvanic skin response. Furthermore, cognitive condition assessments may incorporate multisensory input integration, environmental context evaluation, historical behavioral trends, and predictive modeling techniques to provide a robust and nuanced understanding of the animal's internal state. This multidimensional characterization allows the cognitive condition to reflect combined mental, emotional, and physiological states, such as simultaneously experiencing boredom and physical fatigue, nervousness coupled with high energy levels, or curiosity tempered by uncertainty, thus facilitating precise and effective animal management interventions.

As used herein, “large language model” (LLM) is a type of artificial intelligence model, typically based on deep learning, that is designed to process, understand, and generate human language. These models are trained on massive datasets of text, enabling them to predict the likelihood of sequences of words, understand context, and produce coherent and contextually relevant responses.

As used herein, “Canine” refers to members of the Canidae family, which includes domestic dogs (Canis lupus familiaris), and particularly to domestic dogs.

### Conceptual Architecture

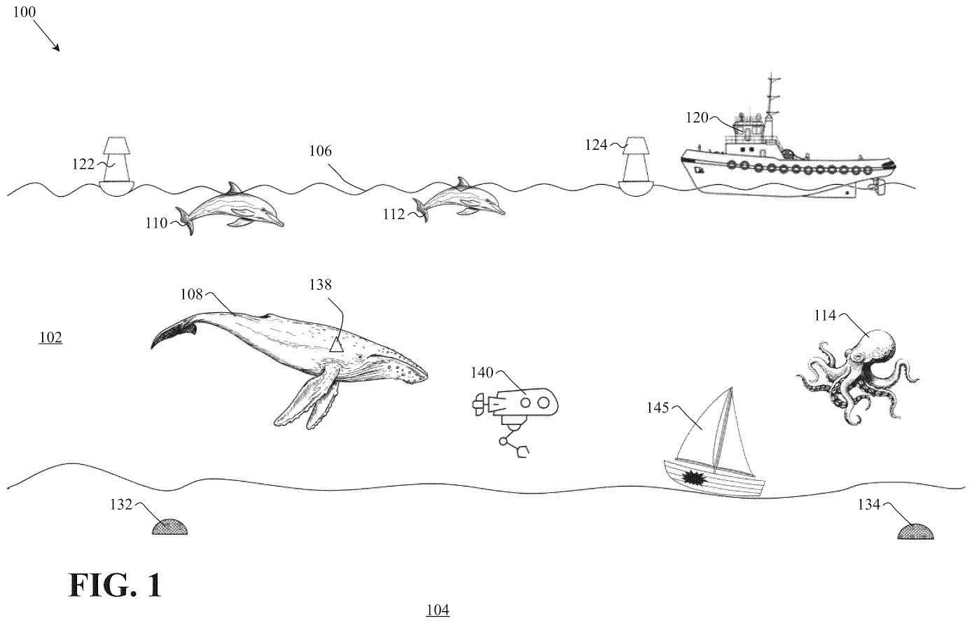

FIG. 1 shows an exemplary environment in which a system for multimodal orchestration for human-animal-robot collaborative task execution can be used, in accordance with one or more embodiments. Environment 100 can include a large body of water 102. However, disclosed embodiments are not limited to use in aquatic environments. Some embodiments may interact with land animals and/or flying animals and may be used in environments involving aquatic, land-based, and/or above-ground environments. Large body of water 102 can include an ocean (e.g., Pacific Ocean, Atlantic Ocean, etc.), a sea, (e.g., Mediterranean Sea, Baltic Sea, etc.), a lake (e.g., Lake Superior, Lake Victoria, etc.), a river (e.g., Mississippi River), a gulf (e.g., Gulf of Mexico), a bay (e.g., Hudson Bay), a strait (e.g., Bering Strait), a fjord, an estuary, a man-made reservoir, and/or other suitable large body of water.

The environment 100 can include one or more buoys, indicated as 122 and 124 in environment 100. In one or more embodiments, the buoys (122, 124) float on the surface 106 of the body of water 102, and can include a variety of equipment for sensing, receiving, storing, and/or transmitting data, as well as one or more output devices. The buoys can include one or more atmospheric sensors. The atmospheric sensors can include a wind speed sensor, wind direction sensor, air temperature sensor, air humidity sensor, barometric pressure sensor, solar radiation sensor, microphone, and/or other suitable atmospheric sensors.

The buoys can include one or more water-based sensors. The water-based sensors can include temperature sensors (to measure surface water temperature), salinity sensors (to determine the salt content of the water), pH sensors (to measure acidity/alkalinity), dissolved oxygen sensors (to monitor oxygen levels for aquatic life), and/or turbidity sensors (to measure water clarity). The water-based sensors may include wave height and direction sensors to measure ocean swell and surface conditions, current velocity sensors (to track underwater currents), tide and sea level sensors, and/or chlorophyll sensors (to estimate plankton levels and water productivity). The water-based sensors may include underwater microphones to detect underwater sounds from aquatic life and/or marine craft. The buoys can include one or more meteorological sensors, such as rain gauges and/or lightning detectors.

The buoys can include a variety of communication equipment, such as satellite transmitters (e.g., Iridium) for long-range communication. The buoys may include cellular modems, suitable for communication within areas of network coverage. The buoys may include radio transmitters to enable short-range transmission for local stations or vessels. The buoys may include Wi-Fi and/or Bluetooth modules to support local data access when in close proximity. The buoys may include GPS receivers to track buoy position and movement. Other communication systems may be present on the buoys in one or more embodiments. The buoys can include a wide variety of output devices, including, but not limited to, signal lights, audible alarms, underwater speakers, out-of-water speakers, and/or digital displays. The buoys can include a variety of computing devices, such as embedded microcontrollers, edge processors, data loggers, and/or other suitable computing equipment. In one or more embodiments, the buoys may include AI-based edge devices for advanced tasks such as detecting patterns, identifying marine life, and/or predictive analysis.

The environment 100 may further include one or more seafloor detection devices, that are located on seafloor 104, indicated at 132 and 134. Each seafloor detection device (132, 134) can include a seismometer, hydrophone array, and a wide range of other sensors and technologies for monitoring vibrations, seismic activity, and underwater sounds. The seafloor detection device can include a broadband seismometer for capturing a wide range of seismic frequencies. The seafloor detection device can further include a short-period seismometer to focus on high-frequency vibrations. The seafloor detection device can further include one or more accelerometers for measuring ground accelerations for vibrations caused by earthquakes, underwater landslides, or human-made activities such as drilling.

The hydrophone array within the seafloor detection devices can enable detecting soundwaves from marine mammals such as whales and dolphins. Other sounds may also be detected by the hydrophone array. These sounds can include sounds from underwater explosions, ship noise, or submarine movements. One or more hydrophones within the hydrophone array may be tuned for capturing low-frequency sounds from large marine animals and/or geological events. The seafloor detection devices may further include a current meter to track underwater currents that may result from tectonic and/or seismic activity.

In one or more embodiments, the seafloor detection devices may be communicatively coupled to one or more surface devices, such as buoys (122, 124), and/or ship 120. The communicative coupling can include cables, such as copper cables, fiber-optic cables, or the like, between a seafloor detection device and a buoy. The communicative coupling can include wireless communication such as electromagnetic wave-based communication and/or acoustic modems that can transmit data via sound waves to nearby surface buoys, ships, or other underwater devices.

In one or more embodiments, the seafloor detection devices may be communicatively coupled not only to fixed surface platforms (such as buoys (122, 124) or ship 120) via traditional hard-wired connections (e.g., copper cables, fiber-optic cables), but also to an array of additional surface and mobile devices. In these embodiments, the coupling architecture is expanded to include hybrid interconnects that integrate both cabled and wireless communication methods. For example, fiber-optic cables may be deployed in a dual role where they serve as both high-bandwidth data conduits and distributed acoustic sensors (DAS) capable of real-time seismic and ambient sound monitoring. In parallel, inductive modem telemetry may be employed along these cables, facilitating real-time data relay from the seafloor to surface nodes even under conditions of cable movement or dynamic environmental stresses.

Furthermore, the system optionally integrates a comprehensive suite of sea sensors, whereby the seafloor detection device is equipped with a modular sensor pod that includes:
Environmental Monitoring Sensors: Embedded microelectromechanical systems (MEMS) that measure parameters such as temperature, salinity, turbidity, pH, dissolved oxygen, and chlorophyll levels. These sensors are calibrated to operate across a wide range of oceanographic conditions and are integrated into self-diagnostic arrays for continuous quality assurance.
Motion and Depth Sensors: Precision pressure transducers and inertial measurement units (IMUs) to capture fine-grained metrics of depth, tilt, and acceleration, enabling accurate mapping of both the seafloor topography and the dynamic response of the detection device to underwater currents.
Acoustic Sensors: Broadband hydrophones and DAS-enabled fiber-optic sensors that capture ambient and transient acoustic signatures, enabling the detection of seismic activity, marine life vocalizations, and anthropogenic noise. These acoustic channels are integrated with digital signal processing modules that implement robust error correction and adaptive filtering algorithms.
Electromagnetic and Optical Sensors: Advanced electromagnetic (EM) sensors for controlled-source electromagnetic (MCSEM) measurements, and optical sensors (such as low-light CCD or CMOS arrays) for capturing light intensity variations, which can be used for biodetection and habitat mapping. Integrated sensor systems may combine these modalities to provide a composite picture of both the chemical and physical state of the underwater environment.

In addition to fixed sensor modules, the system architecture supports integration with mobile sensor platforms. Autonomous underwater vehicles (AUVs) and remotely operated vehicles (ROVs) may be dynamically linked into the network via short-range optical communication or low-power acoustic modems. These mobile nodes serve both as data mules—relaying high-resolution sensor data from hard-to-reach areas—and as adaptive measurement platforms that can reposition in response to detected anomalies. Wireless Sensor Networks (WSNs) based on protocols such as ZigBee or custom cluster-based routing algorithms are utilized to form a mesh network, which allows for robust, energy-efficient inter-node communication over large spatial scales. The network architecture further supports multi-hop relay strategies to overcome the intrinsic limitations of underwater radio-frequency propagation, thereby ensuring reliable data transmission even in the presence of severe attenuation or multipath effects.

To enable scalable and real-time data fusion, the communications framework incorporates a hierarchical protocol stack. At the lowest level, raw sensor data is pre-processed using on-board microcontrollers employing advanced signal conditioning and compression algorithms. This pre-processed data is then transmitted either over a dedicated cabled channel (using fiber-optic or copper-based links) or via an RF/acoustic/wireless interface to a surface gateway. At the gateway, a high-performance computing module aggregates data streams from multiple seafloor devices and mobile platforms, executing machine learning-driven analytics to extract environmental trends and detect anomalies. The system is further configured for bi-directional communication, allowing for remote reconfiguration of sensor parameters and adaptive control of the mobile nodes in response to real-time analysis.

Collectively, these embodiments describe a versatile and integrative underwater monitoring system that leverages state-of-the-art sensor technologies and a multi-modal communication framework. By enabling both fixed and mobile sensor integration through a combination of wired and wireless methodologies, the system provides a robust, scalable solution for continuous, high-resolution monitoring of underwater environments. This innovative approach is particularly advantageous for applications in oceanographic research, habitat monitoring, maritime security, and sustainable resource management, where comprehensive real-time data acquisition and analysis are critical.

The environment 100 can include ship 120. Ship 120 can contain one or more computing devices, such as a data server, virtualized computing environment, and/or other computing devices for enabling and/or supporting the multimodal orchestration system of disclosed embodiments. Additionally, ship 120 can provide long range communication to one or more remote servers, via the Internet. In one or more embodiments, ship 120 may be equipped with satellite communication (SATCOM). In embodiments, the ship 120 can be equipped with a satellite antenna. The satellite antenna can enable a connection with a geostationary satellite and/or a low-Earth-orbit (LEO) satellite, that in turn relays data to a ground station connected to the internet. The ship 120 may further be equipped with a cellular transceiver to utilize a cellular network when within the range of coastal areas.

Within the body of water 102, a wide variety of aquatic life may be present. The aquatic life can include one or more dolphins/porpoises, indicated at 110 and 112. These can include the Bottlenose Dolphin (Tursiops truncatus), Common Dolphin (Delphinus delphis), Dusky Dolphin (Lagenorhynchus obscurus), Harbor Porpoise (Phocoena phocoena), Spectacled Porpoise (Phocoena dioptrica), Orca or Killer Whale (Orcinus orca), and/or other varieties of dolphin/porpoise. These intelligent and diverse marine mammals contribute significantly to marine ecosystems and hold a special place in human culture and scientific research. Each species has its unique adaptations to its habitat, from the open ocean to coastal regions and even rivers. In embodiments, communication between the dolphins/porpoises for the multimodal orchestration system of disclosed embodiments may be accomplished by sending acoustic signals to the dolphins/porpoises and/or receiving acoustic signals from the dolphins/porpoises via buoys (122, 124) and/or seafloor detection devices (132, 134).

The aquatic life within body of water 102 can include one or more octopus/squid, indicated at 114. The octopus can include a Common Octopus (Octopus vulgaris), Giant Pacific Octopus (Enteroctopus dofleini), Mimic Octopus (Thaumoctopus mimicus), and/or other types of octopus. The squids can include a Giant Squid (Architeuthis dux), Colossal Squid (Mesonychoteuthis hamiltoni), Common Squid (Loligo vulgaris), and/or other types of squids. Both octopuses and squids are among the most intelligent invertebrates, exhibiting behaviors that suggest advanced cognitive abilities, such as learning, problem-solving, and communication. In particular, octopuses have been known for their ability to solve complex puzzles, such as opening jars, navigating mazes, and manipulating objects in creative ways. Octopuses like the common octopus (Octopus vulgaris) have demonstrated learning through observation and trial-and-error. Additionally, some squids can learn to avoid predators by associating specific cues (like the presence of certain predators) with danger. These traits and abilities can be used for enabling multimodal orchestration for human-animal-robot collaborative task execution.

The aquatic life within body of water 102 can include one or more whales, indicated generally at 108. The whales can include Baleen whales (Mysticeti) and/or toothed whales (Odontoceti). The Baleen whales can include the Blue Whale (Balaenoptera musculus), Humpback Whale (Megaptera novaeangliae), Fin Whale (Balaenoptera physalus), Minke Whale (Balaenoptera acutorostrata), and/or other varieties of Baleen whale. The toothed whales can include a Sperm Whale (Physeter macrocephalus), Beluga Whale (Delphinapterus leucas), Narwhal (Monodon monoceros), and/or other types of toothed whale.

Beyond whales, embodiments of the present invention provide for communication with a broad array of underwater animals—including marine mammals, fish, reptiles, invertebrates, and amphibians—each of which employs distinct modalities such as acoustic, electrical, optical, chemical, or tactile signals. In one exemplary embodiment, the system comprises a communication interface that integrates multi-modal sensors, wireless transceivers, and advanced signal processing units that are configured to capture and decode the native communicative signals of underwater species and, reciprocally, translate human-generated commands into stimuli that these animals can interpret.

For instance, with respect to marine mammals, the system incorporates specialized hydrophones and piezoelectric transducers that capture the rich vocal repertoire of dolphins (e.g., Tursiops truncatus), including clicks, whistles, and burst-pulse signals used both in echolocation and social communication. These sensors are coupled with digital signal processors (DSPs) that execute real-time spectral analysis, employing Fourier and wavelet transforms to extract key frequency and temporal features. Machine learning algorithms—trained on extensive acoustic datasets—map these features to behavioral or cognitive states, thereby enabling the system to recognize, for example, signature whistle patterns or mimicry cues. Similar sensor and processing arrangements are applied to seals and sea lions, where low-frequency vocalizations are analyzed in conjunction with visual data from integrated underwater camera arrays to resolve context-dependent social signals such as mother-pup calls or territorial disputes.

For communication with fish species, embodiments extend to the use of bioelectrical sensors and high-precision analog-to-digital converters (ADCs) that capture electric organ discharges (EODs) in electric fish, such as electric eels. The system digitizes these bioelectrical signals and subjects them to advanced pattern recognition techniques, including principal component analysis (PCA) and convolutional neural networks (CNNs), to classify signals corresponding to aggressive, courtship, or aggregation behaviors. In addition, for drumming fish (e.g., croakers and drums), piezoelectric pressure sensors are tuned to detect the rhythmic low-frequency sounds produced by swim bladder vibrations. These signals are processed using adaptive time-frequency analysis and error-correction algorithms to separate them from environmental noise and to decode specific communicative markers.

Communication with reptiles, such as sea turtles, is enabled through the integration of ultra-sensitive directional acoustic arrays and low-noise pre-amplifiers capable of capturing the subtle vocalizations or vibratory signals that synchronize hatching events or indicate mating readiness. The captured signals undergo denoising via adaptive filtering and are then analyzed by neural network classifiers to isolate the unique low-amplitude sound patterns from ambient underwater noise.

In embodiments addressing invertebrates, the system leverages high-resolution, underwater imaging sensors that monitor rapid chromatophore changes in octopuses. Advanced computer vision algorithms analyze color and texture dynamics to interpret communicative gestures that may be analogous to language. Additionally, miniature piezoelectric sensors affixed to specific invertebrate habitats capture the transient clapping sounds of cleaner shrimp, while micro-accelerometers and substrate vibration sensors monitor the rhythmic tapping of fiddler crabs. These data streams are processed via a combination of statistical pattern recognition and unsupervised clustering techniques, allowing the system to discern communicative patterns that can be correlated to social or territorial behaviors.

Finally, embodiments extend to aquatic amphibians, such as pipid frogs, where waterproof acoustic sensors and synchronized high-speed video capture the dual auditory-visual signatures of underwater clicking noises and associated behavioral cues. Here, the system employs synchronized time-frequency analysis and deep learning-based classifiers to decode the signals used for mate attraction or territory defense.

In a comprehensive communication framework, all sensor outputs are integrated within a hierarchical network. At the device level, raw signals are conditioned using on-board microcontrollers that perform initial analog filtering and digital compression. Data is then transmitted via a combination of cabled (copper, fiber-optic) and wireless links—including acoustic modems, electromagnetic transceivers, and short-range optical communication modules—to surface nodes or mobile platforms (e.g., autonomous underwater vehicles or remotely operated vehicles). These nodes serve as gateways that relay the pre-processed data to a centralized processing system, where high-performance computing units perform real-time data fusion, anomaly detection, and bi-directional signal translation. The central processor employs a multi-layer neural network architecture incorporating recurrent and convolutional elements to map animal signals to behavioral states and to generate corresponding stimuli (acoustic, electrical, or haptic) for human-to-animal communication.

Collectively, these embodiments provide a novel, bold, and fully enabled interspecies communication system that not only captures the diverse natural signals of underwater animals but also translates and transmits human-generated commands into stimuli intelligible to these species. This integrative approach—leveraging environmental, motion, acoustic, electromagnetic, optical, and multi-modal sensor technologies—opens new avenues for environmental monitoring, scientific research, and marine resource management by enabling dynamic, two-way communication across a broad spectrum of underwater life.

The environment 100 may include one or more marine life wearable electronic devices, such as indicated at 138, affixed to whale 108. The marine life wearable electronic device 138 can include one or more sensors, such as a GPS receiver. The GPS receiver may obtain geolocation data for the whale 108 at times when the whale surfaces. The marine life wearable electronic device 138 may further include one or more acoustic positioning sensors for using triangulation with other devices, such as buoys (122, 124) and/or seafloor detection devices (132, 134) to determine a relative position. The marine life wearable electronic device 138 may further include an accelerometer and gyroscope for tracking movement data, including swimming behavior, diving depth, and/or orientation.

Since whales may communicate via sound, and some whales use echolocation to navigate and find prey, the marine life wearable device 138 may include sensors to detect these sounds or transmit sounds to communicate with the whale 108. The sensors can include a hydrophone to detect vocalizations from the whale (such as songs, calls, or clicks) and record ambient underwater sounds. The marine life wearable device 138 may further include a transducer configured and disposed to emit sounds or vocalizations that can be heard by the whale, facilitating communication and/or behavioral studies. In embodiments, the transducer is tuned to output sounds in frequencies that whales can hear and interact with. In one or more embodiments, the marine life wearable device 138 may further include a haptic module. The haptic module can enable the marine life wearable device 138 to provide tactile feedback to the whale. The haptic vibrations can be delivered through components such as a waterproof vibration device that creates a physical sensation, in order to provide feedback to the whale.

The acoustic communication with whale 108 can include complex vocalizations and communication methods. These sounds can serve various purposes, including navigation, identification, mating, and social interactions. The types of sounds whales produce and the patterns they follow depend on the species, as different whales communicate in different ways. The sounds can include ‘songs.’ These songs are complex, long sequences of sounds that often repeat in patterns and can last for several minutes to hours. Male humpback whales are especially known for their songs, which may be used for mating purposes. The songs can include different “themes” that are repeated in a specific order and may change over time. The songs can carry for miles underwater, allowing males to attract females or compete with other males.

The sounds can include clicks. The clicks can be short, sharp sounds that are used primarily for echolocation (a form of biological sonar). By emitting clicks and analyzing the returning echoes, whales can navigate and detect prey. In some species, clicks are used for communication, especially in social species like orcas and dolphins, where they may serve to coordinate group behavior or signal social intentions. The sounds can include low-frequency sounds. The low-frequency sounds vary from low-frequency moans and grunts to more intense roars, which are thought to be used for communication over long distances. The sounds are often very deep and can travel hundreds of miles across the ocean. The sounds can include non-vocal sounds, such as tail slaps. Some whales, such as humpback whales, may use physical slaps of their tails (flukes) or pectoral fins to produce sounds that may be used for communication, signaling aggression, or coordinating with others in their group. In one or more embodiments, the sound patterns, and corresponding animal behaviors may be stored in a database or other suitable format to serve as training data for one or more machine learning systems to facilitate interspecies communication between humans and/or one or more non-human animal species.

The marine life wearable device 138 further includes a power source, such as a rechargeable or replaceable battery. In some embodiments, the marine life wearable device 138 may be a disposable device with a one-time use sealed battery, such as a lithium-ion battery. In one or more embodiments, the marine life wearable device 138 may be affixed via a strap to the tail fin, or other appendage of the whale. In embodiments, the strap can be comprised of a biodegradable material that dissolves or decomposes over time, enabling the marine life wearable device 138 to fall off the whale after a period of time, such that the device does not cause any permanent discomfort for the whale. In some embodiments, the marine life wearable device 138 may be affixed via a biodegradable adhesive. The biodegradable adhesive can include a starch-based adhesive, and can be formulated to wear off after a period of time, enabling the marine life wearable device 138 to fall off the whale, such that the device does not cause any permanent discomfort for the whale.

The environment 100 may further include an autonomous underwater vehicle 140. The autonomous underwater vehicle 140 can be an electromechanical device that includes an onboard computer for receiving commands and/or data from ship 120, buoys (122, 124), marine life wearable device 138, and/or seafloor detection devices (132, 134). Embodiments can include receiving additional human communication data, and outputting the additional human communication data to one or more electromechanical devices, such as autonomous underwater vehicle 140. Embodiments can include receiving additional human communication data, and outputting the additional human communication data to one or more electronic devices, such as a remote computing device located on ship 120.

The types of tasks performed by the multimodal orchestration for human-animal-robot collaborative task execution can include search and rescue, exploration, surveillance, and/or other suitable tasks. Environment 100 can include a shipwreck 145. As an example, to determine the precise location of the shipwreck, size of the debris field of the shipwreck, and/or other information, a collaborative task involving humans (e.g., on ship 120), robots (e.g., autonomous underwater vehicle 140), and non-human animals (e.g., whale 108, octopus 114, and/or dolphins 110, 112) can be executed by using AI-enabled interspecies communication techniques, along with Simultaneous Localization and Mapping (SLAM) techniques enabled by sensors, satellite receivers, radar, lidar, RF-based triangulation, and/or other suitable techniques, as will be further described in the description for the figures that follow.

In one exemplary embodiment, the SLAM subsystem is radically enhanced through the integration of a hybrid, multi-modal sensor fusion architecture that unifies deep-learning-based feature extraction with advanced geometric optimization and uncertainty-aware data association techniques. Building upon the core ideas of AirSLAM and SP-SLAM, the system employs a unified point-line network (PLNet) that concurrently detects both keypoints and structural line features under varying illumination conditions, thereby ensuring robust performance even in the presence of dramatic lighting changes. This deep network is augmented with a tri-plane encoding strategy that efficiently captures scene appearance data while preserving geometric fidelity, enabling dense 3D mapping with minimal memory overhead. The extracted features are then fused with inertial and other sensor inputs via lightweight matching algorithms—such as those inspired by LightGlue—to enable real-time visual-inertial odometry, which continuously refines camera pose estimates without relying on traditional keyframe selection.

Simultaneously, the system leverages a plane-based optimization framework reminiscent of the Eigen-Factors approach, where raw 3D point cloud data from LiDAR or RGB-D sensors is aggregated into a compact summation matrix that captures point-to-plane residuals at linear complexity. By decoupling plane estimation from trajectory optimization through a bilevel formulation, the SLAM subsystem achieves rapid convergence and enhanced accuracy even in complex, cluttered environments. Moreover, the incorporation of Bayesian inference techniques—integrating Random Finite Set (RFS) theory—allows the system to model feature uncertainty probabilistically, thereby eliminating the need for heuristic-based data association. This unified approach ensures that ambiguous or occluded features are handled in a statistically robust manner, significantly reducing localization drift and map inconsistency.

Further advancing these capabilities, the SLAM subsystem integrates uncertainty-aware sensor fusion mechanisms that explicitly model the noise characteristics of diverse sensor modalities. For instance, radar measurements are processed using a polar-coordinate uncertainty model that transforms measurement covariances into Cartesian coordinates, while visual sensors benefit from adaptive weighting schemes based on real-time confidence estimates derived from deep-learning predictions. These uncertainty-aware residuals are incorporated into a weighted least-squares optimization framework that dynamically adjusts the influence of each sensor input according to its reliability, ensuring robust performance even in adverse conditions such as low-light, high-dynamic-range, or noisy sensor environments.

In addition, the SLAM framework is further empowered by a multi-modal integration layer that synchronizes data streams from heterogeneous sources—including visible and infrared cameras, acoustic sensors, underwater LiDAR, and electromagnetic sensors—into a coherent spatial-temporal model. Advanced cross-attention mechanisms are employed to correlate features across modalities, yielding a unified representation that is then used to construct and continuously update a dense, real-time map of the environment. This layer also supports a predictive relocalization strategy, wherein a scene-dependent junction vocabulary and directed acyclic graph (DAG) representation of reasoning steps enable rapid recovery from localization failures. As new data is incorporated, the system dynamically refines both the map and the corresponding agent poses, ensuring seamless adaptation to changes in the operational environment.

Collectively, these enhancements—encompassing adaptive deep feature extraction, plane-based bilevel optimization, uncertainty-aware fusion, and multi-modal data integration—yield a SLAM subsystem that not only overcomes the limitations of conventional approaches but also surpasses state-of-the-art systems in terms of accuracy, robustness, and computational efficiency. By integrating these advanced techniques into the multispecies orchestration framework, the invention achieves unprecedented situational awareness and real-time mapping performance, thereby enabling robust, scalable, and resilient coordinated task execution across diverse domains such as terrestrial, maritime, aerial, and space environments.

In one exemplary embodiment, the SLAM subsystem is radically reengineered to integrate a hybrid, multimodal data fusion pipeline that not only overcomes the limitations of current visual SLAM systems in dynamic environments but also exceeds the capabilities of DVDS and advanced LiDAR-visual-inertial semantic mapping approaches. In this embodiment, the system first deploys a dual-phase dynamic object exclusion mechanism that simultaneously processes visual and LiDAR inputs using a multi-task deep neural network framework. This framework leverages state-of-the-art image classification, object detection, and semantic segmentation algorithms to filter out transient, moving objects from static scene elements prior to feature extraction. By doing so, the system isolates reliable features even in environments with heavy occlusions, low-texture regions, or rapidly changing illumination, thereby preventing dynamic interference from corrupting downstream optical flow estimation and point cloud registration.

Once dynamic objects are removed, the filtered data is fed into an enhanced transformer-based feature aggregation module—termed the Dispersive Transformer (DisFormer)—which builds on the concept of Top-K Sparse Attention (TKSA) and Mixed-Scale Feed-Forward Networks (MSFN). DisFormer is designed to extract robust, high-dimensional feature representations from both dense visual frames and sparse LiDAR scans by selectively focusing on the most informative signal components while discarding redundant information. This novel transformer module is seamlessly integrated with a gated recurrent unit (GRU) that iteratively refines pose estimates through dense bundle adjustment, effectively combining temporal information with deep semantic cues to continuously update camera and sensor trajectories in real time.

Further distinguishing this embodiment, an object-level semantic mapping layer is incorporated to handle complex, natural environments such as forests, urban scenes, and industrial settings where GNSS signals are unreliable. This layer employs innovative cluster-block data structures that perform object-level segmentation and tracking; for example, in forested environments, individual tree trunks are segmented from LiDAR point clouds and associated with semantic labels obtained from corresponding visual data. These object-level features are then incorporated into a global optimization framework that minimizes mapping drift by enforcing consistency constraints across multiple frames and sensor modalities. This robust semantic mapping capability not only enhances localization accuracy but also provides rich contextual information that can be used for subsequent interspecies coordination and task execution.

To ensure the system operates in real time on embedded platforms, advanced uncertainty-aware sensor fusion techniques are deployed. Each sensor input—whether visual, LiDAR, inertial, or radar—is assigned a dynamically computed confidence score based on its noise characteristics and environmental conditions. These confidence metrics modulate the weighting of individual sensor contributions within a weighted least-squares optimization framework, thereby enhancing robustness to sensor noise, illumination changes, and partial occlusions. By leveraging GPU-based acceleration and efficient inference engines, the entire SLAM pipeline is optimized for low latency, enabling continuous, real-time mapping and localization even under challenging dynamic conditions.

Collectively, these innovations yield a SLAM subsystem that not only filters dynamic elements and robustly extracts discriminative features using novel transformer-based methods but also integrates object-level semantic understanding and uncertainty-aware sensor fusion into a unified, adaptive mapping framework. This comprehensive approach significantly reduces pose estimation errors and mapping drift, while also providing the high-fidelity, context-rich spatial data necessary for coordinated task execution across heterogeneous domains—including terrestrial, maritime, aerial, and even space environments—thereby setting a new benchmark for real-world SLAM performance.

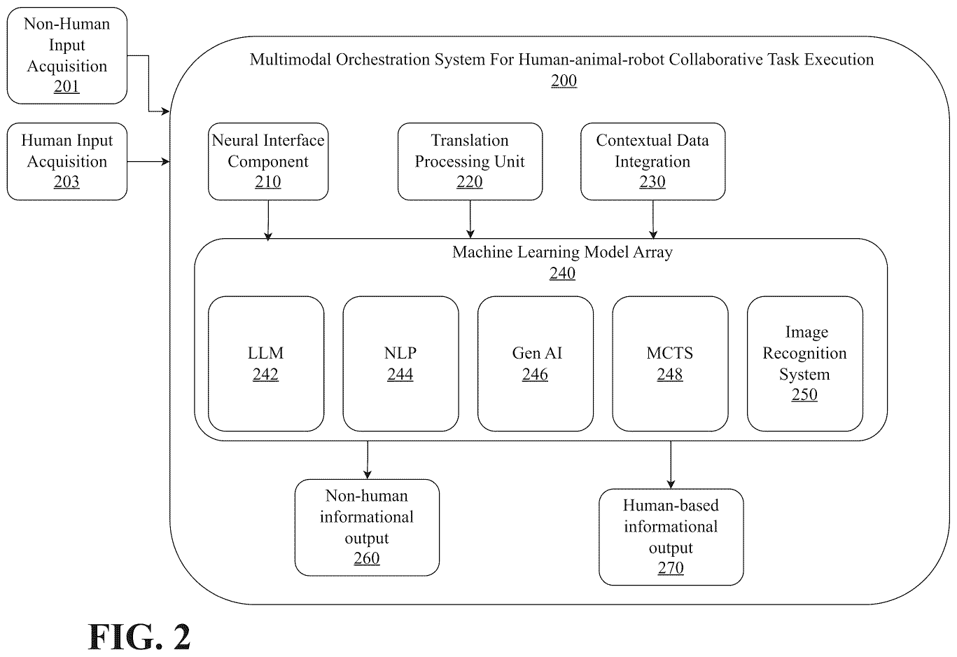

FIG. 2 is a block diagram illustrating components of a system for multimodal orchestration for human-animal-robot collaborative task execution, in accordance with one or more embodiments. System 200 can receive as input, non-human input acquisition 201, and human input acquisition 203. The non-human input acquisition 201 can include input from animals. The input can include audio input. The audio input can include vocalizations such as songs, clicks, chirps, groans, roars, and the like. The audio input can include phonemes and/or words, such as from certain species of birds that are capable of mimicking and producing phonemes from human languages. The audio input can include non-vocal sounds such as tapping or banging sounds from tapping limbs, appendages, or the like. The non-human input acquisition 201 can further include visual information such as sign language gestures, such as may be performed by various primates. The human input acquisition 203 can include spoken language, text input, sign language, and/or other suitable input. The non-human input acquisition 201 and human input acquisition 203 are input to the system for multimodal orchestration for human-animal-robot collaborative task execution 200, and the resulting output can include a non-human informational output 260, and a human-based informational output 270, thereby facilitating interspecies communication.

The system 200 can include a neural interface component 210. The neural interface component 210 can enable the detection of nuanced neural responses from animals that indicate social, emotional, and environmental interactions. The animals can include land animals, such as horses, cats, and dogs. The animals can include aquatic animals, such as whales, dolphins, fish, octopus, and squid. The animals can include birds and other flying animals. In embodiments, the neural interface component 210 may be coupled to the animals to obtain signals indicative of emotional states, and/or other communication patterns. The system 200 can include a translation processing unit 220. The translation processing unit 220 can utilize machine learning models which are trained to correlate neural patterns of animals to known behaviors, vocalizations, and intentions. The system 200 can include a contextual data integration module 230. The contextual integration module 230 can combine modalities (such as neural signals, vocalizations, gestural data, and/or scent vectors) in a multimodal fusion layer. A sliding time window provides temporal alignment, associating changes in scent concentration with concurrent neural or behavioral shifts. The outputs of the neural interface component 210, translation processing unit 220, and/or contextual data integration model 230 are input to machine learning model array 240.

The system may include phylogenic trees, pangenome graphs, or other methods to incorporate evaluation of genomic or multiomics data whenever available. Below is an exemplary embodiment that builds upon and surpasses prior ideas by integrating multiomics and phylogenomic data into the communication orchestration system. In this embodiment, an Optimal Multiomics and Phylogenomic Communication Orchestration Module (OMPCOM) is introduced. This module is designed to ingest not only the heterogeneous environmental and behavioral sensor data described previously (e.g., acoustic, olfactory, visual, and haptic signals) but also genomic and multiomics information that can be derived from available databases, field-deployed genomic sensors, or even prior ex vivo sequencing of target species. By leveraging advanced data structures such as pangenome graphs and indexing methods like the Graph Burrows-Wheeler Transform (GBWT), the system can rapidly match haplotype segments and evaluate genetic markers that correlate with sensory modalities and communication preferences. In practice, OMPCOM first receives raw multiomics data—ranging from whole-genome sequencing reads to transcriptomic and proteomic profiles—from target animals or representative samples thereof. A dedicated Genomic Data Integration Engine (GDIE) constructs pangenome graphs that capture the full spectrum of genomic variation for the species under consideration. Using GBWT-based algorithms, the system performs efficient haplotype matching to identify key genetic variations, such as allelic variants of olfactory receptor families, auditory sensitivity genes (for example, genes modulating low-frequency hearing thresholds), or vision-related opsin proteins. In parallel, the system builds phylogenetic trees from these haplotype datasets to infer evolutionary relationships and kinship, which can serve as proxies for shared sensory preferences or communication behaviors among individuals and subspecies. By establishing these genomic “communication profiles,” the system can predict the modalities that are likely to be most effective for each target animal or group. Once the genomic profiles are established, OMPCOM fuses this data with real-time environmental and behavioral sensor inputs using a neurosymbolic fusion engine. For instance, if the genomic data reveal that a particular subpopulation of whales possesses genetic markers indicative of heightened low-frequency hearing sensitivity and an evolved propensity for acoustic crypsis (as demonstrated in flight species that call below 80 Hz), then the system will favor the use of low-intensity, low-frequency acoustic signals when communicating with those individuals. Conversely, if genomic markers suggest that certain terrestrial animals, such as domesticated cattle or elephants, have a predisposition for robust olfactory reception due to expansive receptor gene families, the system may select calibrated scent emissions as the primary communication channel in environments where auditory cues are compromised by urban noise. The decision algorithm employs reinforcement learning techniques in a multi-armed bandit framework to weigh the expected utility of each communication modality—considering factors such as environmental noise, predation risk, and even the potential for inadvertent aggregation of non-target species—and updates its modality-selection policy dynamically as additional multiomics and contextual data become available. Furthermore, OMPCOM may be operated in an open, partially open or within a closed-loop feedback system. After a communication event, behavioral responses (e.g., changes in movement patterns, physiological responses measured via wearable biosensors, or even genomic stress markers captured through rapid point-of-care assays) are analyzed to refine both the genomic profiles and the modality selection policy. This iterative process is supported by adaptive caching of frequently observed genomic subgraphs and phylogenetic motifs, which are stored using run-length-compressed indices (e.g., via GBWT) to ensure near-linear space complexity even when operating at biobank scale. The integration of these genomic data structures not only enhances the precision of interspecies communication but also enables the system to adjust for evolutionary pressures—for example, by detecting shifts in haplotype frequencies that may correlate with changes in communication efficacy due to environmental stressors like noise pollution or habitat fragmentation. By combining environmental sensor fusion, real-time SLAM-derived context, and the cutting-edge processing of multiomics data through pangenome graphs and phylogenetic analyses, this embodiment achieves a truly interdisciplinary approach. It leverages computational genomics methods to inform and optimize multispecies communication strategies, thereby surpassing traditional modality selection systems. This innovative integration enables the orchestration system to adaptively choose between acoustic, olfactory, visual, and haptic outputs with unprecedented precision, ensuring that messages are delivered in a form that maximizes reception by the intended species while minimizing unintended interactions—whether in a busy urban environment, a predator-dense ocean, or a field setting where evolutionary histories dictate distinct sensory preferences.

The system 200 can optionally include neuromorphic processing units (NPUs) 235 positioned between the contextual data integration module 230 and the machine learning model array 240. The NPUs 235 can comprise specialized hardware implementing spiking neural networks (SNNs) that natively process the temporal dynamics of animal neural signals. In embodiments, the NPUs 235 operate using event-driven computation, activating only when incoming spikes exceed threshold values, thereby achieving power consumption below 100 milliwatts. The NPUs can implement spike-timing-dependent plasticity (STDP) learning rules, enabling real-time adaptation to individual animal neural patterns without requiring cloud connectivity. For deployment on marine life wearable electronic devices 138, the NPUs 235 can be fabricated using memristive crossbar arrays providing in-memory computing capabilities, further reducing power consumption and latency.

Machine learning model array 240 may include one or more machine learning models, neural networks, and/or other systems for processing and interpreting input data. The machine learning model array 240 can include a large language model 242. The large language model (LLM) 242 can be trained for specific animals (e.g., species-specific or even individual-specific) and can ingest continuous streams of neural population data recorded across multiple tasks and states. These models go beyond simple language: they become multimodal encoders of animal neural signals, motor outputs, observed behaviors, and contextual cues. By structuring training data to include “high-incentive” versus “neutral” tasks, the LLM can learn when the animal's neural signature deviates from its optimal preparatory patterns. In embodiments, the machine-learning system includes a large language model (LLM).

The machine learning model array 240 can include a natural language processing (NLP) module 244. The NLP module 244 can enable the conversion of human speech to animal-understandable patterns. The NLP module 244 can include NLP pipelines that parse human language into semantic tokens. These tokens can then be mapped onto a species-specific “neural command embedding space.” For whales, this might involve converting a request such as ‘swim to the surface’ into a neural stimulation pattern, along with an auditory output pattern such as a song or pattern of clicks. For canines, this might involve converting a request like “Fetch the red ball” into a neural stimulation pattern plus a subtle auditory or tactile cue that aligns with the dog's pre-trained internal representations of the action “fetch” and the visual concept “red ball.”

The machine learning model array 240 can include a generative artificial intelligence (Gen AI) module 246. The Gen AI module 246 can enable supplementing training data with synthesized data, such as vocal data (e.g., canine vocalizations or whale codas), where the vocal data is created with properties such as number and regularity of signal units (clicks, barks), spectral means, and/or amplitude envelopes. The Gen AI module 246 can include a generative adversarial network (GAN), such as WaveGAN, InfoGAN, fiwGAN, and/or other suitable GAN.

The machine learning model array 240 can further include a quantum-resistant cryptographic module 247. The quantum-resistant cryptographic module 247 can protect sensitive neural data during transmission between system components and storage within databases. In embodiments, the quantum-resistant cryptographic module 247 implements lattice-based encryption schemes, including CRYSTALS-Kyber for key encapsulation and CRYSTALS-Dilithium for digital signatures. The module can provide at least 128-bit post-quantum security level, ensuring that intercepted neural patterns remain secure even against future quantum computing attacks. This is particularly critical for protecting animal neural signatures that could reveal species-specific vulnerabilities or behavioral predictors that might be exploited. The quantum-resistant cryptographic module 247 interfaces with the neural interface component 210 to encrypt data at the point of capture and maintains end-to-end encryption throughout the processing pipeline.

The Gen AI module 246 can further implement advanced architectures beyond GANs for synthetic data generation. In embodiments, the Gen AI module 246 includes a conditional variational autoencoder (CVAE) specifically optimized for rare animal behavior synthesis. The CVAE operates with an encoder network that maps multimodal inputs (vocalizations, neural patterns, movement data) into a latent space Z, where the dimensionality is species-adaptive (e.g., 256 dimensions for canines, 512 for cetaceans, 1024 for primates). The decoder network is conditioned on behavioral context vectors that capture environmental factors, temporal patterns, and social dynamics. The CVAE loss function is formulated as L=Lreconstruction+β·LKL+λ·Lbehavior, where Lreconstruction ensures fidelity to real data, LKL maintains latent space structure, and Lbehavior preserves species-specific behavioral constraints. This architecture enables generation of synthetic training examples for behaviors observed fewer than 10 times in the training corpus, such as specific alarm calls, rare mating displays, or emergency distress signals.

The machine learning model array 240 can include a Monte Carlo Tree Search (MCTS) module 248. The MCTS module 248 can enable adaptive, look-ahead scheduling decisions. Instead of applying fixed heuristics or static load-balancing, disclosed embodiments can simulate and/or evaluate multiple future states of the pipeline before choosing the next action. By repeatedly exploring and exploiting different pipeline routing decisions (e.g., which specialist model to send partial outputs to, or how to scale certain pipeline segments), MCTS can minimize the cumulative regret over time, converging toward near-optimal scheduling policies that are robust to changing conditions, input distributions, and latency constraints. In one or more embodiments, the MCTS module 248 can enable enhanced resource allocation, such as allocating more GPUs, selecting specialized hardware accelerators, and/or adjusting batch sizes downstream.

In some embodiments, a bioacoustics foundation model (referred to herein as an “animal CLIP” model) is incorporated into the machine learning model array as a species-agnostic, multimodal encoder that maps heterogeneous animal signals and environmental context into a shared, low-dimensional semantic space of “meaning vectors.” The model is trained to align time-synchronized acoustic segments, posture/gesture frames, scene context, and physiological cues such that co-occurring evidence projects nearby in the embedding space, while mismatched evidence is pushed apart. The resulting embeddings are designed to serve as the canonical representation of animal communicative state for downstream translation, collaboration, and control, and are compatible with the Multispecies Collaboration Layer (MCL), which already extracts “meaning vectors” and “conceptual state embeddings” for cross-species task coordination.

In one implementation, the animal CLIP model comprises multiple encoders: an acoustic encoder that ingests vocalizations (e.g., songs, clicks, chirps, barks), a visual-kinematic encoder that ingests posture, gesture, and movement derived from camera streams and SLAM-based scene state, and a context encoder that ingests biometric and environmental signals (e.g., heart rate variability, temperature, proximity, geospatial cues). Each encoder produces a fixed-length vector through a projection head, and the vectors are trained with a contrastive objective over sliding time windows so that temporally aligned segments form positive pairs. The model leverages the system's data preprocessing and temporal alignment functions, which normalize and synchronize multimodal inputs before ingestion, and can utilize scene understanding and semantic mapping features available in, for example, a SLAM subsystem to ground embeddings in physical context.

In some embodiments, the acoustic stream is segmented into phonetic-like units (e.g., codas, call motifs) using unlabeled boundary detection; the visual stream is segmented by motion and pose change; and the physiological stream is segmented by shifts in state (e.g., HR/HRV transitions) so that each modality contributes aligned “tokens.” The generative AI modules described herein may be used to synthesize additional paired segments—such as artificial vocal patterns with specified spectral envelopes or cadence—to improve coverage of rare states, perform hard-negative mining, and stress-test the embedding space. Synthetic examples can be produced by the disclosed GAN components and mixed with natural recordings during pretraining.

The animal CLIP embeddings integrate directly with the LLM orchestration system. Nodes in the orchestration DAG store the current world state; replacing or augmenting those node states with animal-CLIP meaning vectors provides a compact, information-rich prior that guides expansions during search. When the MCTS module proposes which specialist to consult or which hypothesis to expand, the policy can be biased toward branches whose node embeddings are both internally coherent (high cross-modal similarity) and historically successful (similar to cached embeddings associated with correct judgments). Iterative preference learning (e.g., DPO) can further refine how these embedding-conditioned heuristics steer exploration/exploitation, thereby reducing the conditions that produce super-exponential regret in tree search.

In embodiments that employ debate-based oversight at selected nodes, the animal CLIP vectors furnish a shared evidentiary substrate for expert agents and the judge. Because debate outcomes and associated inputs are stored in an embeddings cache, subsequent nodes that are embedding-neighbors of previously adjudicated situations can inherit calibrated priors: nodes near “validated-danger-alarm” clusters receive higher value estimates; nodes near “rejected-false-alarm” clusters receive penalties or are pruned. The system can thus convert debate results into MCTS-ready value/policy hints without re-deriving evidence from scratch.

During inference, the encoders operate continuously on streaming sensor data. For each time step, the system computes an embedding tuple (acoustic, visual-kinematic, context) and fuses them into a single meaning vector. This vector becomes the node's state embedding in the LLM orchestration DAG; the judge/detector may query the embeddings cache for nearest neighbors and associated adjudications; and MCTS updates the node's value. When a branch is selected, the LLM output module emits the appropriate human-readable text, symbology, or structured data, and the MCL output generation module renders species-appropriate audio, visual, haptic, or neural signals for animal or robot consumption. Where applicable, the robot command interface is driven by the selected interpretation, while maintaining consistency with the shared embedding-conditioned state.

Training the animal CLIP model can be conducted within the disclosed training system. Large volumes of unlabeled multimodal data are curated, preprocessed, and split into training/validation/test sets; optimization proceeds with contrastive losses over synchronized segments, optionally combined with auxiliary reconstruction or clustering losses. Hyperparameters and model scorecards are tracked, and deployed models continue to improve via continual learning as new field data arrives. These procedures fit the unsupervised training regime already contemplated for animal-to-human translation systems.

In one non-limiting example, whales in an aquatic environment are instrumented with audio and video capture; SLAM-derived scene state and hydrophone arrays provide localization and context. The animal CLIP encoders align specific coda patterns with co-occurring surface behaviors and relative positions. When the orchestration DAG evaluates competing hypotheses about a call's intent, nodes whose embeddings cluster with previously judged “cohesion” or “alert” states are preferentially expanded, and nodes inconsistent with those clusters are pruned early, improving latency and accuracy. The resulting selection is rendered both to humans (e.g., text/speech) and to animals/robots via species-appropriate outputs.

In another non-limiting example, canine vocalizations and posture are recorded while a handler issues tasks. The animal CLIP model learns a joint embedding where distinctive bark motifs and tail/torso dynamics align with handler intent and environmental affordances. The NLP module maps human commands into the same task representation, and the MCL converts selected meanings into species-appropriate audio or haptic cues and, where enabled, neural stimulation patterns for rapid, low-latency feedback. This shared embedding expedites MCTS selection of action branches that historically led to correct execution.

To support fast, repeated decision-making, the embeddings cache stores meaning vectors associated with prior debates and outcomes. When a new node's meaning vector is within a threshold distance of a cached cluster, the judge can adopt the prior's calibration and MCTS can immediately increase or decrease the node's value, often eliminating the need for full debate at that point. Conversely, when a node falls in a sparse region of the embedding space, the system can trigger a richer debate, generate synthetic counterfactuals via GANs, and defer commitment until additional context arrives.

The animal CLIP integration improves the MCTS pipeline in at least three ways. First, it provides compact, informative state representations that reduce branching factor by collapsing redundant hypotheses into tight clusters, enabling earlier pruning of low-quality subtrees according to the disclosed MCTS pruning mechanisms. Second, it supplies value/policy priors derived from neighborhood structure in the embedding space and from stored debate outcomes, thereby accelerating convergence and mitigating regret in the exploration/exploitation tradeoff addressed by the orchestration system. Third, it amortizes computation across time by retrieving previously adjudicated states from the cache rather than recomputing evidence, reducing latency and energy for real-time deployments.

In implementations where the system performs cross-species operations such as issuing robot commands, the embedding-conditioned DAG allows the same meaning vector to drive both human-readable outputs and machine-ready actions, while remaining within the safety envelope enforced by the debate and search layers. When a judge selects an interpretation at a node, the MCTS process may prune or reinforce the corresponding branch, and the selected meaning can be converted to commands through the existing robot interface while preserving links back to the evidentiary embeddings for auditability.

Accordingly, the animal CLIP foundation model supplies a principled, contrastive pretraining layer that unifies acoustic, visual, and physiological evidence into a single representation that the disclosed orchestration, debate, and MCTS components can consume. By aligning co-occurring animal signals with their environmental context and caching the adjudicated results, the system increases translation accuracy, reduces search cost, and improves responsiveness across dynamic field conditions without departing from the disclosed modules and claim framework.

The machine learning model array 240 can include an image recognition system 250. Image recognition system 250 may utilize machine learning to identify objects and gestures in images and video clips. The training can include obtaining a large dataset of labeled images or video clips that include the objects and/or gestures that are to be identified. Using techniques such as convolutional neural networks (CNNs), relevant features from the images are automatically extracted. A machine learning model (e.g., a deep learning model) is trained on the extracted features. Once trained, the model can be used to predict the presence of objects or gestures in new, unseen images and/or video clips. The images and/or video clips can include images of non-human animals exhibiting facial expressions, performing gestures, and/or other interpretable behaviors. Image recognition system 250 may further utilize Haar cascades for object detection. One or more embodiments can include training the Haar cascade classifier using a combination of positive samples and negative samples. The training process can include selecting the most relevant features and creating a cascade of classifiers.

The machine learning model array 240 can include, as an output, non-human informational output 260. The non-human informational output 260 can include audio output. The audio output can include species-specific audio waveforms such as clicks and songs for cetaceans, growling and/or barking sounds for canines, and so on. In an aquatic environment such as depicted in FIG. 1, the audio output may be provided by underwater speakers or other suitable transducers. The non-human informational output can include visual output, such as flashing lights, and/or patterns rendered and presented on an electronic display that is visible to the animals that are participating in the system and/or method for multimodal orchestration for human-animal-robot collaborative task execution.

The machine learning model array 240 can include, as an output, human-based informational output 270. The human-based informational output 270 can include visual information such as text and/or symbology. The human-based informational output 270 can include audio information. The audio information can include synthesized speech, tones, and/or other sounds to convey information identified by the machine learning model array 240. Referring again to the example depicted in FIG. 1, for investigation of the shipwreck 145, the non-human informational output 260 can include audio waveforms that may be interpreted by a whale 108 to swim to a location proximal to the shipwreck 145. The whale 108 may then output audio vocalizations in response to viewing the shipwreck. The output audio vocalizations can be translated by the system 200 to human-based informational output 270 for interpretations by humans. In this way, the non-human informational output 260 and the human informational output 270 can work in tandem to enable human-animal-robot collaborative task execution.

The machine learning model array 240 can be extended to support federated learning capabilities, enabling collaborative model training across geographically distributed research sites without centralizing sensitive animal data. In embodiments, the federated learning system comprises a central aggregation server, which may be hosted on ship 120 or within cloud-based services 90, coordinating training rounds among participating institutions. Each institution maintains local training data and only shares encrypted gradient updates computed on their local animal communication datasets.

The federated learning implementation can utilize secure aggregation protocols based on secret sharing and homomorphic encryption, ensuring that individual gradient contributions remain private even from the central server. The system implements (ε, δ)-differential privacy by adding Gaussian noise with variance σ²=2 log(1.25/δ)S²/ε² to gradient updates, where S is the sensitivity bound. This privacy guarantee is particularly important when training on data from endangered species, where location information must be protected. The federated averaging algorithm is adapted for multimodal inputs by implementing separate aggregation strategies for neural, acoustic, and behavioral modalities, with importance weighting based on data quality metrics from each site.

To implement robust machine learning and pattern recognition, the system may include a neural network architecture that processes time-series EEG data using a hybrid model combining convolutional neural networks (CNNs) and recurrent neural networks (RNNs), such as long short-term memory networks (LSTM) or gated recurrent unit (GRU), to capture both spatial and temporal features of the neural signals. For example, a dataset could be assembled that includes annotated brainwave recordings from a variety of species—dogs, cats, horses, and even aquatic mammals like dolphins—collected under controlled conditions. This dataset would label neural patterns corresponding to known emotional states (e.g., excitement, stress, calm) and would be enriched with synthetic data generated by a generative adversarial network (GAN) to augment underrepresented classes. The training process would involve preprocessing steps such as noise filtering, normalization, and segmentation of the EEG signals into fixed-length time windows. Each species' data could be tagged with a unique species embedding vector, allowing the network to learn intrinsic differences across species while sharing common features for emotion recognition.

Hyperparameter tuning would be essential to optimize model performance. For example, techniques like grid search or Bayesian optimization can systematically explore the hyperparameter space to identify the best configuration. Early stopping based on validation loss, coupled with cross-validation across species-specific splits, would ensure that the model generalizes well. Additionally, incorporating a multi-head attention mechanism allows the model to focus on the most informative segments of the neural data, which is crucial when handling the inherent variability of signals from different species. This attention layer helps to dynamically weight features that are particularly indicative of certain emotional states. By jointly training the network on multiple tasks—such as classifying emotional states and reconstructing input signals—the model can further regularize its learning and improve robustness across diverse neural inputs. These combined strategies offer a concrete pathway for developing a machine-learning system capable of accurately interpreting complex and diverse brainwave data across multiple animal species.

The translation processing unit could be implemented using, for example, a sequence-to-sequence model that is specifically trained to map neural signal patterns to structured outputs in human language and vice versa. For example, once a machine learning model has extracted features from the raw neural data—such as temporal patterns indicative of excitement or stress—the translation processing unit takes these features and passes them through an encoder-decoder architecture. The encoder condenses the neural signal embeddings into a latent representation that captures the key elements of the animal's emotional state. The decoder then transforms this representation into a human-understandable output, such as a textual description (“The dog is excited”) or an actionable command (“Sit” or “Come here”). This process can be further enhanced with an attention mechanism, allowing the model to focus on the most informative parts of the neural signal when producing the final output.

In an example implementation, a training dataset can be assembled that pairs neural signal recordings with corresponding behavioral observations and expert annotations, effectively serving as a parallel corpus for training the translation model. For instance, neural recordings captured during a dog's response to a command could be aligned with the known action and emotional label assigned by a trainer. The model could be trained using standard techniques such as teacher forcing during the early stages, gradually transitioning to using its own predictions in a scheduled sampling framework. Additionally, fine-tuning on species-specific subsets of the data allows the translation unit to learn subtle differences between species while maintaining a generalizable mapping framework. This ensures that the system can not only translate between the neural signals and human language but also accurately reflect the intended meaning behind the signals, thereby facilitating more effective and intuitive interspecies communication.

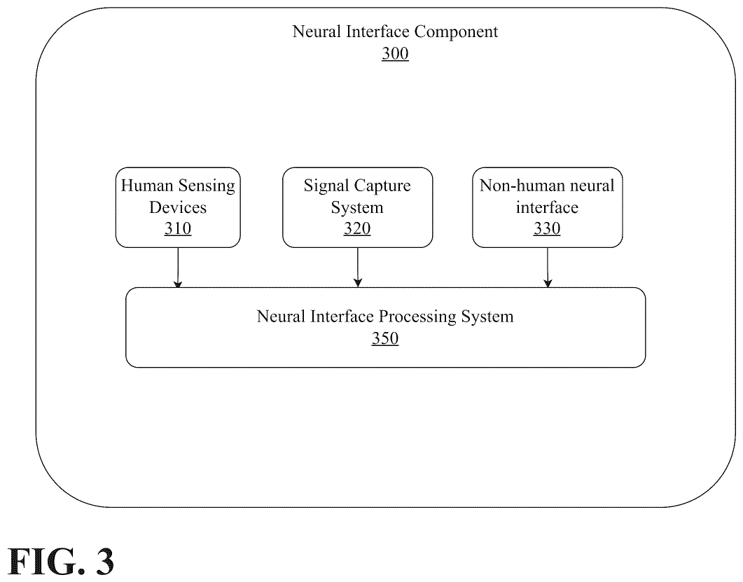

FIG. 3 is a block diagram illustrating details of a neural interface component, in accordance with one or more embodiments. Neural interface component 300 may be similar to neural interface component 210 of FIG. 2, and can include one or more human sensing devices 310. The human sensing devices 310 can include wearable sensors, such as pulse sensors, brainwave monitors, and the like. The human sensing devices 310 can further include cameras, microphones, and/or other sensors for obtaining cognitive state information from a human. The data received by the human sensing devices may be used with NLP module 244 to extract additional context and sentiment from humans participating in human-animal-robot collaborative task execution.

Neural interface component 300 can include a signal capture system 320. The signal capture system 320 can include one or more sensors for capture of neural and physiological signals without distress, adjusted for the physical characteristics of animals, such as cetaceans. In embodiments, neural sensors are embedded within wearable and/or attachable devices suited for underwater and open-ocean deployment. In embodiments, the neural interface includes components tailored to the species' specific anatomy, such as the head or dorsal regions in whales, and made from materials that ensure durability and comfort even in the deep-sea environment.

Neural interface component 300 can include a non-human neural interface 330. The non-human neural interface 330 can include non-invasive sensors that can detect and measure animal brain activity without causing discomfort. These sensors capture neural signals associated with emotions, intentions, and responses to stimuli. The non-human neural interface 330 can further include implanted sensors. Embodiments can include surgically implanting sensor probes inside an animal's brain. In embodiments, this technique can be used in place of a non-invasive sensor package, and can yield additional control and benefits that include the ability to record specific thoughts, evaluate mental state, and other aspects outside of the direct intent to communicate. This also enables capturing the animal's sensory data such as vision and scent. This allows human/animals to not only communicate freely, but opens additional options for working animals. For example, a dog must pass extensive training before it can sniff drugs. With disclosed embodiments, the training may be drastically shortened by reading the animal's brain patterns directly and identifying targeted substances via this data. As part of the training, the non-human informational output 260 (of FIG. 2) may produce a signal to cause happiness or the notion of correctness as a positive reward and drastically speed training times and animal willingness.

The output of the human sensing devices 310, signal capture system 320, and non-human neural interface 330 can be input to neural interface processing system 350. Neural interface processing system 350 can include an AI-based processing unit that analyzes and interprets vocalization data, behavioral cues, and environmental contexts to foster bidirectional communication between humans and non-human animals. Disclosed embodiments can be well-suited for applications ranging from enhancing human-animal interactions for conservation to advancing scientific understanding of animal languages, particularly in highly social and intelligent species such as sperm whales. Furthermore, disclosed embodiments can enable the use of environmental and behavioral metadata integration, as well as robust machine learning frameworks, allowing creation of an adaptable model for studying communication across various species, making disclosed embodiments adaptable to diverse animal communication needs beyond cetaceans, such as canines, primates, and other species.

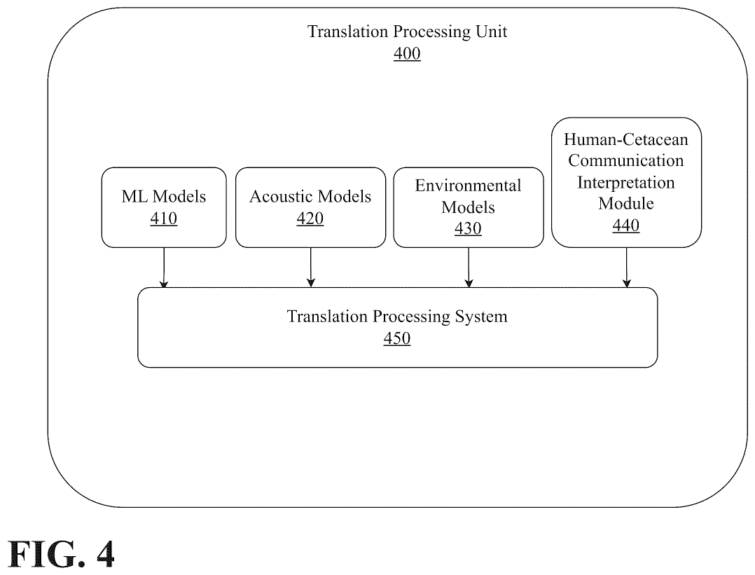

FIG. 4 is a block diagram illustrating details of a translation processing unit, in accordance with one or more embodiments. Translation processing unit 400 may be similar to translation processing unit 220 of FIG. 2, and can include one or more machine learning models 410. In embodiments, the machine learning models 410 can be trained to identify patterns in vocalization, such as codas, tempo, rhythm, ornamentation, and contextual variations like rubato. This training enables disclosed embodiments to decode structured and nuanced elements of cetacean communication, potentially revealing hierarchical or associative structures similar to human language. The translation processing unit 400 can include one or more acoustic models 420. The acoustic models 420 may enable replication of fricative production. This includes adjusting tongue position, airflow velocity, and constriction points. The translation processing unit 400 can further include one or more environmental models 430. The environmental models 430 can include probabilistic models to capture the uncertainty and variability inherent in fricative sound production and perception. The translation processing unit 400 can further include a human-cetacean communication interpretation module 440. In embodiments, the human-cetacean communication interpretation module 440 can enable mappings between humans and cetaceans. As an example, the clicks, songs, and codas of whales can be processed via machine learning, and mapped to human sentiments, such as danger, affection, joy, aggression, curiosity, and/or cooperation. In embodiments, the human sentiment can be derived from animal outputs, such as sounds made by animals, gestures made by animals, facial expressions made by animals, and so on. The danger may be represented by high-pitched whistles, rapid clicks, and/or abrupt calls. Affection may be represented by soft clicks, whistles, and/or low-pitched moans. Joy may be represented by rapid clicks, whistles, and/or varied, upbeat vocalizations. Aggression may be represented by loud, forceful vocalizations, grunts, or low-frequency rumbles. Curiosity may be represented by short bursts of clicks. Cooperation may be represented by repetitive clicking patterns. In general, cetacean sounds may be catalogued and correlated to a behavioral context.

In some embodiments, a mapping, scene understanding, and digital twins subsystem is integrated with the system for multimodal orchestration for human-animal-robot collaborative task execution and provides a persistent, machine-readable representation of the physical environment and the agents operating within it. The subsystem receives multimodal sensor inputs and performs, for example, Simultaneous Localization and Mapping (SLAM) to estimate camera/agent pose while constructing and updating a map of salient features. As described for SLAM system 800, inputs can include visible cameras, infrared imaging sensors, sonic sensors such as microphones and hydrophones, and electromagnetic sensors; these signals are fused within a SLAM processing engine to yield a consistent spatial model.

The SLAM processing engine can include a point merging module configured to combine redundant observations of the same real-world feature, thereby refining the map and improving pose accuracy under noise and occlusion. A semantic mapper can augment geometric reconstructions with machine-interpretable labels and semantic constraints, and may further enable humans to interpret animal emotional states or intentions through augmented-reality interfaces linked to embeddings and semantic mapping. The engine can also include a species-agnostic scene-state estimation module that ingests, by way of non-limiting example, visible spectrum, ultraviolet/hyperspectral, lidar, radar, and acoustic measurements to produce a 3D reconstruction with species-relevant affordances, including beamforming and signal processing to localize vocalizations and identify distress calls or other meaningful patterns.

The output of the SLAM processing engine can include a geospatial summarization that is renderable on electronic displays and consumable by downstream modules. This summarization can depict animal locations, terrain features, environmental conditions, and dynamically updated icons indicating status indicators such as color-coded stress levels and activity patterns; data can be emitted in raster, vector, or other suitable formats to support both operator displays and machine interfaces. By linking the semantic mapper to augmented-reality visualization, handlers can observe intent, stress, or other semantics overlaid on the live scene while the underlying representations remain available to automated reasoning components.

In certain embodiments, the mapping and scene understanding outputs instantiate a “digital twin,” which is a time-evolving, queryable model that mirrors the physical environment, agents, and objects, including non-human animals, humans, robots, and relevant environmental features. The digital twin maintains state variables for positions, velocities, predicted trajectories, environmental fields, and semantic annotations derived from the species-agnostic scene-state estimation and geospatial summarization. The training system used elsewhere to produce models for interspecies communication can also be employed to train segmentation, detection, and tracking models that populate and maintain the twin from raw sensor streams, leveraging the same data preprocessing, model training, and deployment primitives described for system 900.

The digital twin provides a standardized interface to the Multispecies Collaboration Layer (MCL). Conceptual state embeddings or “meaning vectors” generated by the MCL can be bound to entities and regions within the twin so that intentions and tasks are spatially grounded. For example, cross-species behavioral descriptors maintained by the MCL can be attached to tracked animals or robots as attributes in the twin's state, allowing task allocators to reason jointly over intent and geometry. The MCL's output generation module can consume twin state to time and route species-appropriate outputs, ensuring that audio, visual, haptic, or neural stimulation is delivered with correct spatial context (e.g., line-of-sight, range, and environmental occlusion).

The mapping, scene understanding, and digital twin subsystem also feeds the Large Language Model (LLM) orchestration system by providing compact, structured encodings of the current world state as node representations in the directed acyclic graph (DAG) of reasoning steps. Each node can encode, among other things, positions and behaviors of animals, textual instructions from humans, and robot sensor readings as extracted from the twin. During search, expansions correspond to hypothetical scene evolutions or task decompositions, and are guided by mechanisms already disclosed, including embedding caches, semantic knowledge graphs, preference learning, and Monte Carlo Tree Search (MCTS) with super-exponential regret awareness. By exposing a consistent, semantically labeled state from the twin, the orchestration layer reduces ambiguity, leading to earlier pruning of low-value branches and improved convergence.

MCTS benefits directly from the twin by evaluating look-ahead consequences in a stateful environment model rather than from unstructured signals alone. Value and policy estimates at nodes can condition on twin features such as proximity of agents, visibility constraints, or recent stress-level trajectories, and the regret-aware adjustments disclosed for MCTS improve selection among competing expansions. Reinforcement-learning style value functions can be learned over twin-derived metrics—including correctness, complexity minimization, and task utility—to prioritize branches that historically map to validated outcomes. This coordination of twin-aware scoring and dynamic pruning yields near-optimal scheduling and routing policies that adapt to changing conditions, input distributions, and latency constraints.

Debate-based oversight can operate over twin-anchored evidence. At designated nodes, expert agents can reference twin state (e.g., animal pose, acoustic source localization, environmental occlusions) to support or refute hypotheses about meaning or next actions; the judge can arbitrate using knowledge-graph alignments and cached embeddings. The outcome of the debate can modify node values used by MCTS; when debate indicates inconsistency with twin evidence, branches are down-weighted or pruned, whereas high-confidence, twin-consistent interpretations are promoted. Storing the inputs, twin snapshots, and outcomes in the embeddings cache amortizes future decisions when similar spatiotemporal configurations recur.

The subsystem further supports closed-loop control by connecting twin state to human-readable outputs and machine-actuated commands. The LLM output generation module can produce text, symbology, or structured data that references twin entities and regions, while the robot command interface receives commands that are parameterized by twin coordinates, movement directions, and speed. Because the digital twin maintains spatial context, robots can be instructed to navigate to, avoid, or monitor specific twin-identified regions associated with interpreted animal states (e.g., stress hotspots), and policy constraints such as geofences or standoff distances can be enforced at the interface.

During streaming operation, the mapping and scene understanding components update the twin as new sensor data arrives, triggering re-scoring of affected nodes in the orchestration DAG. If new measurements contradict prior assumptions, the system can initiate re-judging or a renewed debate at the relevant nodes and propagate value changes through the search tree, yielding revised outputs with lower latency than recomputing from scratch. Because the twin stores both geometric and semantic history, preference-learning updates and reinforcement-learning rewards can be computed over meaningful, time-aligned trajectories rather than isolated events, improving data efficiency in the training system.

Accordingly, the mapping, scene understanding, and digital twins subsystem provides a unified spatial and semantic substrate for the disclosed architecture. By fusing heterogeneous sensors into a semantically labeled map, summarizing geospatial state for both operators and machines, grounding interspecies meanings in physical context via the MCL, and supplying twin-aware state to the LLM orchestration and MCTS components (with optional debate-based oversight), the subsystem increases translation accuracy, reduces search cost, and enables safe, context-aware actuation of robots and delivery of species-appropriate outputs. These capabilities are realized using the SLAM system and geospatial summarization mechanisms already described, the orchestration and MCTS modules that consume and act upon stateful representations, and the outputs and command interfaces that render and apply decisions across species.

The translation processing system 450 receives input from the ML models 410, acoustic models 420, environmental models 430, and human-cetacean communication interpretation module 440. The translation processing system 450 can be configured to convert animal neural patterns into human-comprehensible language, conveying the emotional state, intentions, and/or needs of the animal. The translation processing system 450 can further be configured to translate human speech into neural signals or cues that are meaningful and understandable to animals, allowing the animals to comprehend specific commands or sentiments directly. In embodiments, the translation processing system 450 may be configured to produce spoken translations of animal communications, thereby allowing humans to understand an animal's emotions or needs. For instance, the system might translate a dog's neural signals into phrases like “I am hungry” or “I'm feeling anxious.”

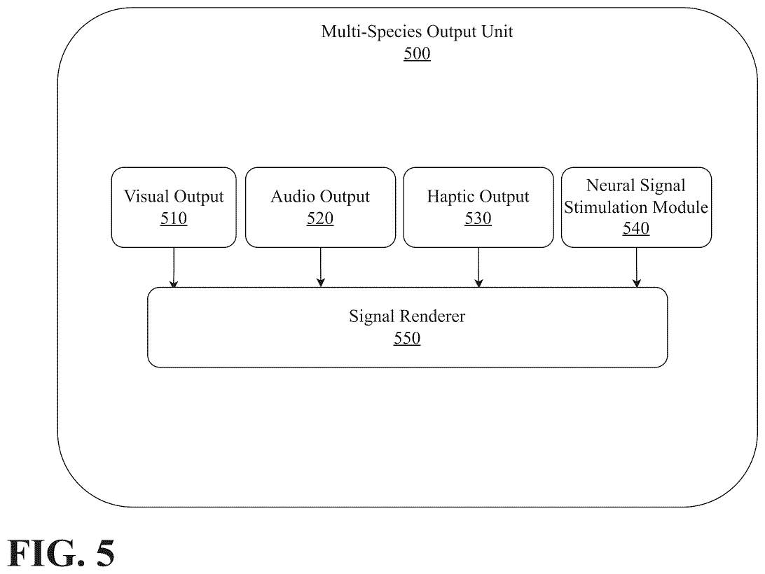

FIG. 5 is a block diagram illustrating details of a multi-species output unit 500, in accordance with one or more embodiments. The multi-species output unit is an innovative computerized system designed to facilitate communication between humans and animals by integrating multiple sensory modalities for output. The visual output subsystem 510 processes and assembles video and image data for output on an electronic display. The visual output is tailored to the perceptual capabilities of the target species, ensuring that animals or humans can interpret the visual signals effectively. The audio output subsystem 520 can be configured to generate audio waveforms that can be output through speakers or other audio devices. The audio output can include species-specific sounds, such as vocalizations, frequencies, or tones, enabling communication in a form recognizable by the intended animal. The haptic output subsystem 530 generates and modulates signals to drive vibratory devices, creating tactile sensations that can be detected via wearable sensors or directly on the animal's skin. The haptic feedback can convey information such as alerts, directions, or emotional cues. The neural signal stimulation module 540 can include electrodes capable of monitoring and interacting with brainwaves of an animal. It can record neural activity and deliver carefully modulated stimulation to influence or reinforce specific neural patterns. This capability offers potential for advanced applications, such as training, behavior modification, or facilitating direct neural communication. The signal renderer module 550 serves as the central decision-making unit, determining the most appropriate output device for each signal. It integrates the outputs from the visual, audio, haptic, and neural modules and ensures that the signals are delivered in a coherent and species-appropriate manner. In embodiments, the multi-species output unit 500 may be integrated into, or communicatively coupled with, non-human informational output 260 and/or human-based informational output 270.

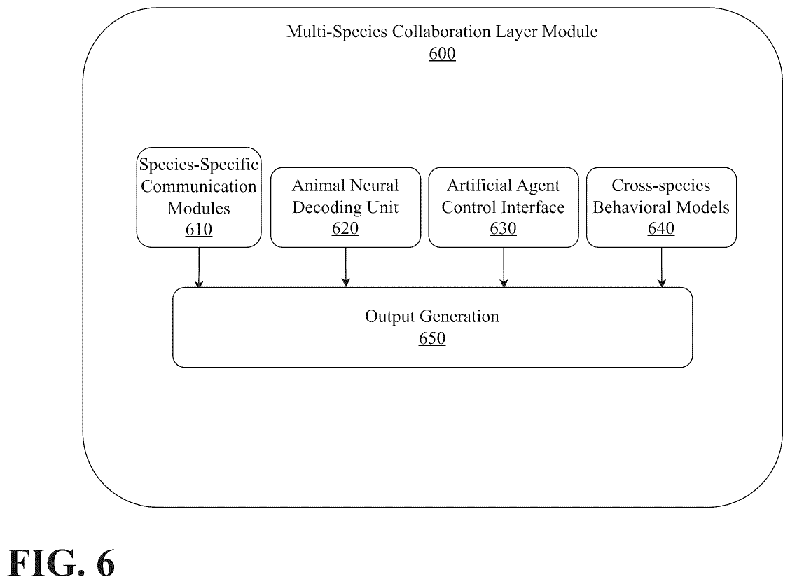

FIG. 6 is a block diagram illustrating details of a multi-species collaboration layer module 600, in accordance with one or more embodiments. The Multispecies Collaboration Layer (MCL) builds on the foundational capabilities of neural interfaces, multimodal sensory processing, and language modeling techniques, extending them to facilitate purposeful, synchronized interaction across species or between animals and machines. Its key functions are to understand interspecies “vocabularies,” align goals, and orchestrate collaborative tasks. The MCL module 600 can include one or more species-specific communication modules 610. In embodiments, each participating species (e.g., dogs, elephants) or artificial agent (e.g., a drone) has its own communication interface and representation layer.

The MCL module 600 can further include an animal neural decoding unit 620. The animal neural decoding unit 620 can be configured to extract interpretable “meaning vectors” from the animal's neural signals and observed behavior. As an example, for a dog, neural patterns plus posture/vocalization cues can produce a “conceptual state embedding” representing intentions and emotional states. The MCL module 600 can further include an artificial agent control interface 630. For a drone, sensor data (LIDAR, camera, GPS) and command frameworks are translated by the artificial agent control interface into abstract action representations (e.g., “search pattern initiated,” “altitude adjustment needed”). The MCL can further include one or more cross-species behavioral models 640. These models can utilize a library of known behavioral cues and tasks common to various species (e.g., “move towards scent,” “alert upon detection of target”) to produce standardized action and intention descriptors.

The MCL module 600 further includes an output generation module 650 that receives input from the species-specific communication modules 610, animal neural decoding unit 620, artificial agent control interface 630, and/or cross-species behavioral models 640. The output generation module 650 then generates an appropriate output signal, which can include a video signal, audio signal, haptic signal, and/or other bioelectrical signal for conveying sentiment and/or meaning among humans and non-human animals. The output generation module 650 can output data in a wide variety of digital and/or analog formats, including pulse code modulated (PCM) audio, raw video formats, compressed video formats, and/or other suitable formats.

In embodiments, the Multispecies Collaboration Layer can be configured to provide a unified, context-driven platform enabling animals of different species, as well as robots and/or drones, to collaborate effectively on shared tasks. By creating and refining interspecies dictionaries, using ML models to align intentions, and carefully timing and routing these concepts through a shared task representation space, the MCL module 600 can enable synchronized, purposeful action. This can profoundly enhance capabilities in wildlife conservation, service support, and environments where diverse species and agents work in concert to achieve common goals. In embodiments, the MCL module 600 can be integrated with, or communicatively coupled to, system 200 of FIG. 2.

In one practical implementation, the multi-species output and collaboration module can be architected as a unified system that dynamically translates processed neural data into species-specific output signals, while also synchronizing tasks among humans, animals, and robotic agents. For example, after a machine learning model interprets a dog's neural signals to indicate a specific emotional state—such as excitement—the system can trigger a haptic feedback module on a wearable collar that vibrates in a particular pattern the dog has been trained to recognize as a cue to perform a desired behavior, such as fetching an object. Simultaneously, the system can generate an audio signal customized for canine hearing frequencies, reinforcing the behavioral cue with sound. This dual-modality approach not only improves the clarity of the command for the dog but also provides redundant channels for communication, ensuring that the animal accurately receives the intended message.

To further illustrate, consider a scenario where humans, dogs, and a robotic drone collaborate on a search-and-rescue mission in a disaster zone. The system continuously processes neural and environmental data and utilizes a collaboration layer that integrates inputs from diverse sensors—ranging from the dog's wearable sensor to the drone's cameras and environmental detectors. When the neural interface detects that the dog has identified a potential victim based on its brainwave patterns, the multi-species output module concurrently dispatches a visual signal on the drone (such as a highlighted map marker) and a corresponding auditory cue through a portable speaker for the human responders. This synchronized output ensures that all parties—animal, human, and robot—receive the same situational information in a form they can understand, thereby optimizing coordinated responses in high-stakes environments.

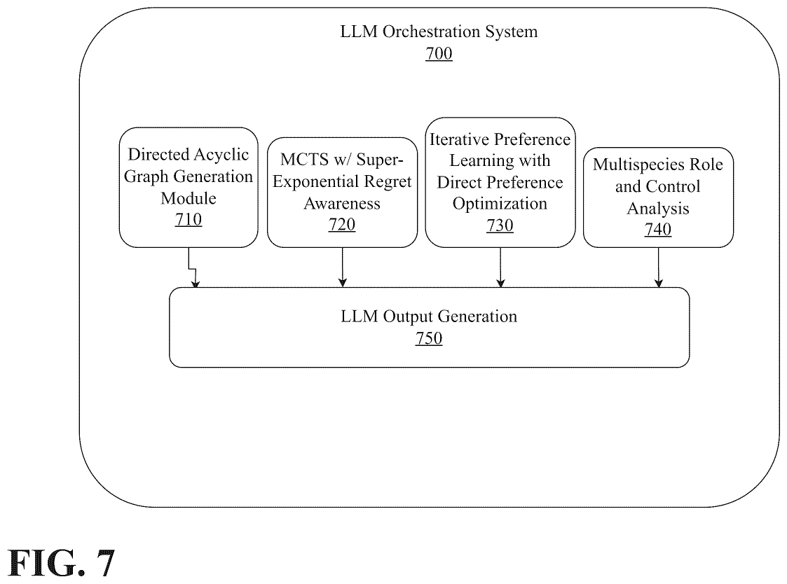

FIG. 7 is a block diagram illustrating details of a large language model (LLM) orchestration system 700, in accordance with one or more embodiments. In embodiments, LLM orchestration system 700 may be integrated with, or communicatively coupled to, LLM 242 of FIG. 2. LLM orchestration system 700 can include directed acyclic graph (DAG) generation module 710. The DAG generation module 710 can create a DAG representing complex workflows in which nodes are reasoning steps, and edges represent transitions from one partial solution to another. In some embodiments, each node encodes the current state of the environment, such as position and behavior of animals, humans' textual instructions, and/or robot sensor readings. The DAG's expansions can correspond to MCTS-like searches over possible reasoning paths, guided by previously described methods (e.g., embedding caches, semantic KGs, preference learning). Embodiments can include generating a directed acyclic graph to represent a plurality of reasoning steps corresponding to the multispecies coordinated task execution.

The LLM orchestration system 700 can include MCTS/Super Exponential Regret Awareness module 720. In this context, “super-exponential regret” refers to the phenomenon where certain algorithms, specifically the Upper Confidence bounds applied to Trees (UCT) and its variants like AlphaGo's Monte Carlo Tree Search (MCTS), can experience regret that grows at a super-exponential rate under specific conditions. Regret, in this setting, measures the difference between the actual performance of the algorithm and the optimal performance it could have achieved. This module 720 may adjust model parameters to reduce or minimize regret, thereby improving performance. The adjustments made by module 720 can include modifying exploration-exploitation tradeoffs (e.g., fine-tuning of exploration constants in UCT).

The LLM orchestration system 700 can include iterative preference learning with direct preference optimization module 730. In embodiments, each node's expansions produce step-level preference data: which partial expansions yield better outcomes (improved translation quality, correct interpretation of animal signals). After collecting these preferences (through MCTS expansions and intermediate verification from debate steps), module 730 can apply Direct Preference Optimization (DPO) to refine the LLM's underlying policy. Over multiple cycles, on-policy sampled data enable the LLM's decision-making to improve at picking high-value expansions from the start. This reduces reliance on brute-force exploration and counters the conditions leading to super-exponential regret.

The LLM orchestration system 700 can include multispecies role and control analysis module 740. In embodiments, module 740 can model agents as having different influence roles, which can dynamically encourage certain agents to lead expansions in known-productive directions. Moreover, module 740 can be configured to let other agents anchor or block suspicious expansions (such as an octopus punching unhelpful fish), which are translated into immediate pruning of subgraphs in the reasoning DAG.

The LLM orchestration system 700 can include an LLM output generation module 750 which receives as input, outputs from the directed acyclic graph generation module 710, MCTS with Super Exponential Regret Awareness module 720, include iterative preference learning with direct preference optimization module 730, and/or multispecies role and control analysis module 740. The output from the LLM output generation module 750 can include information for human consumption, such as textual information, knowledge-based outputs, and/or structured data. The output from the LLM output generation module 750 can include information for robot consumption, such as commands, sensor data, and/or other command and control information. The output from the LLM output generation module 750 can include information for animal consumption, such as audio waveforms intended for interpretation by animals, such as tones and/or click patterns for cetaceans, tones and/or sounds for canines, and so on. Other signals for representation in visual and/or haptic domains may also be output by LLM output generation module 750 in some embodiments.

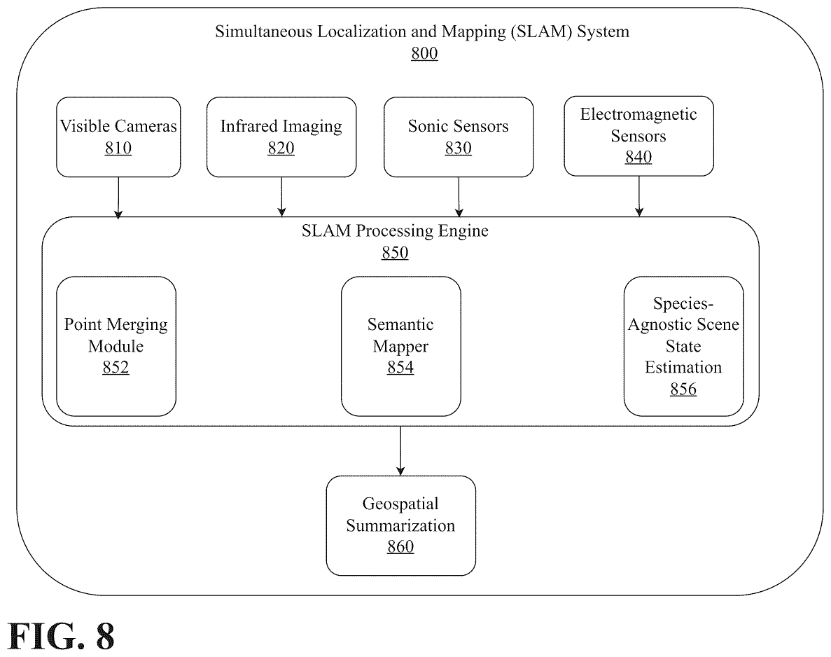

FIG. 8 is a block diagram illustrating details of a Simultaneous Localization and Mapping (SLAM) system 800, in accordance with one or more embodiments. In embodiments, SLAM system 800 may be integrated with, or communicatively coupled to, system for multimodal orchestration for human-animal-robot collaborative task execution 200 of FIG. 2. System 800 can include visible cameras 810, infrared imaging sensors 820, sonic sensors 830, and/or electromagnetic sensors 840. The visible cameras 810 may be configured to detect light in the visible spectrum (roughly 400-700 nanometers), which is the range of light perceptible to the human eye, and capture colors and details as humans see them, relying on external light sources (e.g., sunlight or artificial lighting) to illuminate a scene. The visible cameras can include wide-angle cameras, telephoto cameras, and so on. The infrared imaging sensors 820 can be configured to detect light in the infrared spectrum (beyond 700 nanometers), which is invisible to the human eye. In some embodiments, the infrared imaging sensors 820 can include thermal cameras that can capture emitted heat radiation from objects, even in complete darkness, without requiring external illumination. The sonic sensors 830 can include microphones and/or hydrophones. The microphones can include dynamic microphones, condenser microphones, electret microphones, and/or other suitable types of microphones. The hydrophones can include piezoelectric hydrophones that use piezoelectric materials to detect pressure changes in water caused by sound waves. The hydrophones can include vector sensors that measure both sound pressure and particle motion within water. The hydrophones can include a hydrophone array that includes multiple hydrophones arranged in a specific geometry to detect sound from multiple directions.

The electromagnetic sensors 840 can be configured to detect and measure electromagnetic fields or properties, such as electrical conductivity, magnetic fields, and electromagnetic radiation. The electromagnetic sensors 840 can include fluxgate magnetometers, suitable for detecting magnetic anomalies from seafloor rocks, or identifying metallic objects like shipwrecks or submarines. The electromagnetic sensors 840 can include proton precession magnetometers that can measure the magnetic field based on the precession of protons in water or a fluid. In one or more embodiments, the electromagnetic sensors can include optically pumped magnetometers, electric field detectors, capacitive sensors, electromagnetic induction sensors, and/or other suitable types of electromagnetic sensors.

The inputs from visible cameras 810, infrared imaging sensors 820, sonic sensors 830, and electromagnetic sensors 840 can be input to SLAM processing engine 850. SLAM processing engine 850 can include a point merging module 852. In embodiments, the point merging module 852 can include functions and instructions for combining multiple data points that correspond to the same real-world feature. This helps refine the map, reduce noise, and improve localization accuracy. SLAM processing engine 850 can include a semantic mapper 854. In embodiments, the semantic mapper 854 can include functions and instructions for enabling humans to interpret animal emotional states or intentions through augmented reality interfaces linked to embeddings and semantic mapping. The semantic mapper 854 may further include a Semantic Alignment Agent that can refine cross-domain mappings accordingly. Moreover, SLAM processing engine 850 can further include a species-agnostic scene state estimation module 856. In embodiments, the species-agnostic scene state estimation module 856 can include functions and instructions for utilizing data from visible light cameras to determine color and depth of a scene, enabling a 3D reconstruction of an environment. The species-agnostic scene state estimation module 856 can further include functions and instructions for utilizing data from ultraviolet (UV) and/or hyperspectral sensors, which can provide benefits as some animal signals might be visible only in UV or certain spectral bands, revealing hidden patterns (like UV-reflective markings on fish or subtle changes in an octopus's skin). The species-agnostic scene state estimation module 856 can further include functions and instructions for utilizing data from lidar scanners that produce high-resolution point clouds for both indoor and outdoor environments. In one or more embodiments, radar can complement lidar in poor visibility conditions. The species-agnostic scene state estimation module 856 can further include functions and instructions for utilizing data from sonic and/or acoustic sensors to capture vocalizations from a wide variety of animals. Embodiments can further utilize beamforming and/or signal processing in order to locate sound sources and/or identify distress calls, barks, or other meaningful vocal patterns in non-human animals.

The output of the SLAM processing engine 850 can include a geospatial summarization 860. The geospatial summarization 860 can include data that can be rendered and presented on an electronic display to show features such as a map panel that indicates animal locations, terrain features, and environmental conditions. One or more embodiments can further include icons representing animals that are updated in real-time, displaying status indicators such as color-coded stress levels, activity patterns, and the like. The data output of geospatial summarization 860 can include data in a variety of raster, vector, and/or other suitable formats.

An example of how the system can address environmental awareness by integrating a robust SLAM (Simultaneous Localization and Mapping) module that leverages multiple sensor modalities to construct and update a real-time map of the environment is an implementation that involves a network of underwater sensors—such as visible-light cameras, infrared sensors, hydrophones, and electromagnetic detectors—deployed on buoys, autonomous underwater vehicles, and seafloor detection devices. These sensors collect diverse data streams that are fed into a centralized SLAM processing engine. The engine employs sensor fusion algorithms to merge the disparate data points, calibrate them using techniques like point cloud merging and temporal alignment, and generate an accurate three-dimensional map of the surrounding environment. This map not only identifies static features like underwater rock formations or shipwreck debris but also dynamically tracks moving entities, such as marine life, which could be critical for coordinated search-and-rescue operations. The sensor fusion step is critical, as it involves aligning data with different noise profiles and update rates into a coherent representation. For example, one approach might use an Extended Kalman Filter (EKF) to merge the visual data from cameras with sonar measurements from hydrophones. The EKF can predict the system state by modeling the sensor dynamics and then correct the state estimates using incoming measurements. Alternatively, GraphSLAM techniques can be employed to optimize the global map by representing sensor observations as nodes in a graph and refining the map through iterative least-squares optimization, which can be particularly effective in complex underwater environments where sensor data is noisy or sparse.

In a real-world scenario, consider a rescue operation where a shipwreck is located in a complex underwater terrain. The SLAM module can continuously receive inputs from high-resolution cameras and acoustic sensors on a dolphin, and hydrophones mounted on buoys. The cameras capture detailed visual features, dolphin based acoustic sensors in combinations with buoy hydrophones detect acoustic signatures of marine life or subtle structural sounds from the wreck. The system processes these inputs through a semantic mapper that overlays additional information—such as depth, temperature gradients, and object classifications—onto the base map. An example implementation might use LIDAR and sonar fusion techniques to achieve a high-fidelity reconstruction of the wreck site. This fused map is then transmitted to both human operators via a tablet interface displaying a real-time 3D model and instructions sent to the dolphins that adjust their search patterns accordingly. The comprehensive integration of SLAM not only enhances environmental awareness but also supports synchronized decision-making across human, animal, and robotic agents in high-stakes, dynamic environments.

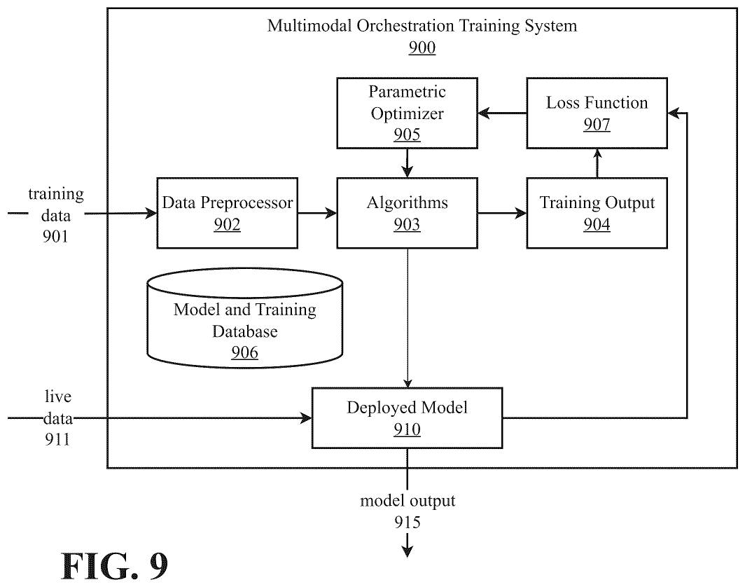

FIG. 9 is a block diagram illustrating an exemplary training system for tasks such as multimodal orchestration for human-animal-robot collaborative task execution and/or a system for cross-domain animal-to-human communication, in accordance with one or more embodiments. In embodiments, system 900 may comprise a model training stage comprising a data preprocessor 902, one or more machine and/or deep learning algorithms 903, training output 904, a parametric optimizer 905, and a model deployment stage comprising a deployed and fully trained model 910 configured to perform tasks described herein such as enabling multimodal orchestration for human-animal-robot collaborative task execution. The system 900 may be used to train and deploy a plurality of AI subsystems in order to support the services provided by the system for multimodal orchestration for human-animal-robot collaborative task execution.

At the model training stage, a plurality of training data 901 may be received by the training system 900. Data preprocessor 902 may receive the input data (e.g., human feedback, human input data, animal input data, animal feedback, robot/sensor inputs, and the like) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 902 may also be configured to create a training dataset, a validation dataset, and/or a test set from the plurality of input data 901. For example, a training dataset may comprise 80% of the preprocessed input data, the validation set 10%, and the test dataset may comprise the remaining 10% of the data. The preprocessed training dataset may be fed as input into one or more machine and/or deep learning algorithms 903 to train a predictive model for tasks that can include interspecies communication, geospatial mapping, and/or object monitoring and detection.

During model training, training output 904 is produced and used to measure the accuracy and usefulness of the predictive outputs. During this process a parametric optimizer 905 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLU, Tanh, etc.), the choice of cost or loss function the model will use, number of hidden layers in a neural network, number of activation unites in each layer, the drop-out rate in a neural network, number of iterations (epochs) in training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the training system 900 to evaluate a model's performance. Metrics can include, but are not limited to, word error rate (WER), word information loss, cetacean response times, predicted animal response compared with actual animal response, and normalization error rate, to name a few. In one embodiment, the system may utilize a loss function 907 to measure the system's performance. The loss function 907 compares the training outputs with an expected output and determines how the algorithm needs to be changed in order to improve the quality of the model output. During the training stage, all outputs may be passed through the loss function 907 on a continuous loop until the algorithms 903 are in a position where they can effectively be incorporated into a deployed model output 915.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 910 in a production environment making predictions based on live input data 911 (e.g., user preferences, user feedback, user inputs). Further, model correlations and restorations made by deployed model can be used as feedback and applied to model training in the training stage, wherein the model is continuously learning over time using both training data and live data and predictions. A model and training database 906 is present and configured to store training/test datasets and developed models. Database 906 may also store previous versions of models.

According to some embodiments, the one or more machine and/or deep learning models may comprise any suitable algorithm known to those with skill in the art including, but not limited to, LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 903 may comprise a deep learning algorithm such as neural networks (e.g., recurrent, convolutional, long short-term memory networks, etc.).

In some implementations, the training system 900 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 906.

The training system 900 can further implement cross-species transfer learning pipelines that leverage evolutionary relationships to accelerate model development for new species. In embodiments, the system maintains a phylogenetic knowledge graph encoding genetic distances between species, which informs transfer learning strategies. The base architecture comprises a universal encoder trained on a diverse corpus spanning at least 50 mammalian species, capturing fundamental patterns in neural oscillations, vocalization structures, and behavioral sequences. When adapting to a new species, the system applies low-rank adaptation (LoRA) with rank r selected based on phylogenetic distance: r=rmax×(1−similarity_coefficient), where similarity_coefficient ∈[0,1] represents genetic similarity. For closely related species (e.g., domestic dogs to wolves), r≤8 suffices, while distant species require r≤32. The system further implements meta-learning through Model-Agnostic Meta-Learning (MAML), enabling rapid adaptation with as few as 100 species-specific samples by optimizing for parameters that are sensitive to gradient updates in the direction of new species data.

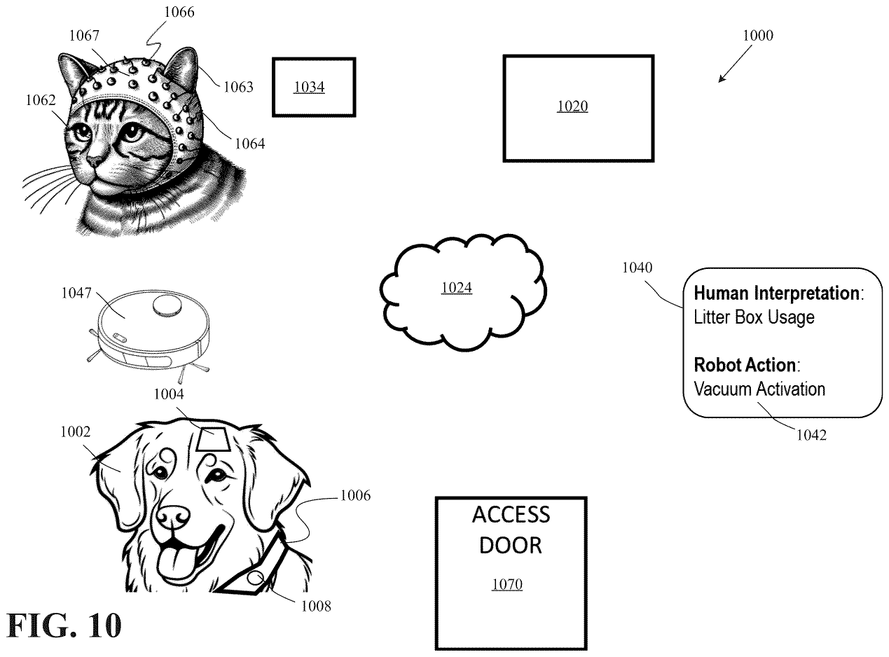

FIG. 10 shows an exemplary environment 1000 in which a system for animal-to-human communication can be used, in accordance with one or more embodiments. Dog 1002 is shown, wearing a non-invasive brainwave sensor 1004. In embodiments, the non-invasive brainwave sensor 1004 may be comprised of a spray-on conductive polymer ink. In embodiments, the conductive polymer ink can include (Poly(3,4-ethylenedioxythiophene):poly(styrenesulfonate)) (PEDOT:PSS). In embodiments, the conductive polymer ink can be applied directly to the scalp or skin using a microjet printing system. In some embodiments, a small area of the dog may be shaved to expose bare skin for applying the conductive polymer ink. The ink can include additives to optimize conductivity, reduce skin impedance, and ensure mechanical durability during prolonged wear. Once applied, the ink dries into a thin, flexible film that conforms seamlessly to the skin surface, even in the presence of hair or irregular contours. In some embodiments, instead of, or in addition to, a spray-on conductive polymer ink, pre-patterned tattoo electrodes can be transferred onto the skin for neural signal acquisition. These electrodes can be composed of biocompatible materials and provide low contact impedance. In some embodiments, the epidermal tattoo sensor can include carbon nanotubes (CNTs), gold nanomaterials, and/or other suitable materials. These sensors can detect brain or muscle activity through electrical signals with high signal-to-noise ratios (SNRs), rivaling traditional invasive systems. In embodiments, the non-invasive brainwave sensor comprises a sensor comprised of conductive polymer ink. In embodiments, the conductive polymer ink comprises (Poly(3,4-ethylenedioxythiophene):poly(styrenesulfonate)) (PEDOT:PSS).

In one or more embodiments, the signals acquired by brainwave sensor 1004 are sent to a non-invasive brainwave sensor auxiliary module 1008 that may be attached to a collar 1006 worn by the dog 1002. In embodiments, the signals acquired by brainwave sensor 1004 can be sent to the brainwave sensor auxiliary module 1008 via near field communication (NFC) techniques, Bluetooth Low Energy (BLE), or other suitable techniques. One or more embodiments may utilize a custom UUID characteristic for EEG data to enable specifying the sample rate, data format, and/or other parameters for transmission of EEG data. The brainwave sensor auxiliary module 1008 can send the acquired signals to a system for animal-to-human communication 1020, via network 1024. In embodiments, network 1024 can include a cellular network, WiFi network, local area network (LAN), wide area network (WAN), satellite communication network, and/or the Internet. The system for animal-to-human communication 1020 can include functions and instructions to acquire brainwaves obtained by brainwave sensor 1004. The system for animal-to-human communication 1020 can further include functions and instructions to perform filtering, data conditioning, and analyzing the brainwaves via machine learning models. The results of the analysis can be sent to a client device 1040 via network 1024. The client device can include a laptop computer, desktop computer, tablet computer, and/or other suitable computing device. The results produced from the system for animal-to-human communication 1020 can be rendered and presented on electronic display 1042. In embodiments, the results can include a human interpretation of animal communication data, which can include vocalizations, gestures, biometric data, and/or brainwave patterns that are received and analyzed by the system for animal-to-human communication 1020. In embodiments, the biometric data can include heart rate, breathing rate, body temperature, and so on. Embodiments can include a non-invasive brainwave sensor, wherein the non-invasive brainwave sensor is configured and disposed to obtain brainwave data from a non-human animal, and wherein the non-invasive brainwave sensor is configured to provide the brainwave data to the computing device. The human interpretation can include an emotion, such as anger, fear, curiosity, concern, and so on. The human interpretation can include an action, such as biting, digging, walking, running, jumping, etc.

The environment 1000 can further include a feline (cat) 1062. The cat 1062 can wear a sensor array 1064 to obtain brainwaves from the cat 1062. The sensor array 1064 can be implemented as a knit or crocheted headgear 1067 that the cat 1062 can wear. The headgear can include cutouts to accommodate the ears 1063 of the cat 1062. The headgear 1067 can include multiple brainwave sensors, indicated generally as 1066. The brainwaves can include signals such as EEG (Electroencephalography), EMG (Electromyography), and/or specific sensory patterns for communication or training purposes. In embodiments, the non-invasive brainwave sensor comprises a plurality of contact sensors affixed to a cap that is configured and disposed to be worn on the head of the non-human animal. The brainwaves can include different types of brainwaves (e.g., alpha, beta, delta, and/or theta waves) that can be used to analyze cognitive states. The brainwaves can be acquired and stored by data acquisition module 1034. Data acquisition module 1034 can send the brainwave data to the system for animal-to-human communication 1020 via network 1024. This can enable animal-machine interactions based on detection and interpretation of animal brainwaves. As an example, the cat 1062 may generate brainwaves that are detected by sensor array 1064, and acquired by data acquisition module 1034. The data acquisition module 1034 can then send the acquired brainwave data to the system for animal-to-human communication 1020 via network 1024, where the system for animal-to-human communication 1020 analyzes the brainwaves, and translates the brainwaves into a meaning corresponding to a human intention for the animal. In embodiments, a robot command can be performed in response to determining a given human interpretation. As shown in FIG. 10, rendered and presented on display 1042 of client device 1040 there is shown a human interpretation of litter box usage. The human interpretation can be based on multimodal information obtained from cat 1062, including from sensor array 1064. The environment 1000 can further include a robotic vacuum cleaner 1047. The robotic vacuum cleaner 1047 can include hardware and software to vacuum a region such as a room or series of rooms. The non-robotic vacuum cleaner 1047 can include a receiver to receive a robot command from the system for animal-to-human communication 1020, based on information provided by an animal, such as dog 1002 and/or cat 1062. In this way, an animal can directly interface with, and influence the operation of, a machine. The robot vacuum cleaner 1047 is simply one example of a device that can be used in disclosed embodiments. Other devices can include drones, access doors, robotic gantries, autonomous vehicles, and more. Embodiments can include performing an additional translation stage, wherein the additional translation stage comprises converting the human interpretation to a robot command.

In embodiments, the system for animal-to-human communication 1020 can interact with an animal, such as dog 1002 via a haptic and/or audio feedback the brainwave sensor auxiliary module 1008 via network 1024. The brainwave sensor auxiliary module 1008 can have one or more output devices that include speakers and/or haptic output devices such as vibrators and/or buzzers, to provide biofeedback stimulation to the dog. The dog can be trained to interact with access door 1070. As an example, a particular vocalization provided by dog 1002 can be identified as a human interpretation of wanting to go outside. In response to determining the human interpretation of the dog wanting to go outside, the access door 1070 can be issued a command to open, or be enabled to open when the dog 1002 is in close proximity to the access door 1070. In this way, disclosed implementations can facilitate animal to human communication, as well as animal-machine interactions.

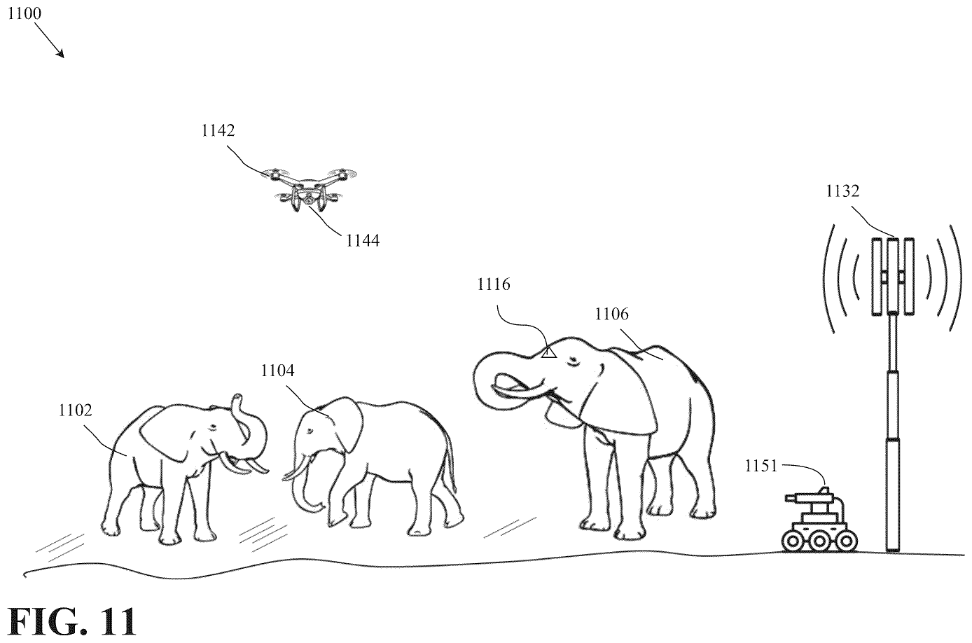

FIG. 11 shows another exemplary environment 1100 in which a system for animal-to-human communication can be used, in accordance with one or more embodiments. Environment 1100 includes multiple elephants, indicated at 1102, 1104, and 1106. While elephants are shown in this example, the environment 1100 can include other animals, including wild animals, as well as livestock and domestic animals. In embodiments, a drone 1142 can operate airborne above the elephants. The drone 1142 can include a sensor array 1144 which can include one or more visible cameras, infrared cameras, hyperspectral cameras, LiDAR, and/or other sensing devices. The drone 1142 can further include a wireless data transceiver that can transmit data to radio tower 1132 to enable sending of data acquired by the drone 1142 to the system for animal-to-human communication 1020 of FIG. 10 as well as receiving of data from the system for animal-to-human communication 1020 of FIG. 10 that is sent to the drone 1142.

One or more of the elephants may further include a non-invasive biosensor, such as indicated at 1116 on elephant 1106. The non-invasive biosensor may include one or more electrodes, a power source, a signal acquisition module, a position tracker (e.g., GPS), and/or a wireless communication module. In embodiments, the non-invasive biosensor 1116 may send data to the drone 1142 and/or radio tower 1132 for upload to the system for animal-to-human communication 1020 of FIG. 10. In embodiments, the non-invasive biosensor can obtain biometric data from an animal, such as heart rate, body temperature, perspiration rate, breathing rate, and so on. The biometric data can further include brainwave signals. The combination of the biometric data and the data from the sensor array 1144 of the drone 1142 may be sent to the system for animal-to-human communication 1020 of FIG. 10 for analysis to determine a human interpretation based on input data from the elephants. The input data can include vocalizations, biometric data, brainwave data, and so on. The human interpretation can include an emotion, such as anxiety or fear. In embodiments, an emotion such as anxiety and/or fear can cause a command to be issued to the drone 1142 from the system for animal-to-human communication 1020 of FIG. 10. The command can include a command to increase altitude and/or move further away from the elephants in order to reduce stress levels and/or anxiety within the elephants. In addition, a human interpretation of the elephant data may be rendered and presented on an output device, such as shown at 1042 of FIG. 10.

Thus, disclosed embodiments can strike a balance between utilizing technology for protection while respecting the natural behavior and well-being of the animals. For example, enabling elephants to influence drone behavior based on their vocalizations or stress signals introduces a level of autonomy that provides new capabilities in animal monitoring. In addition to controlling drone operations, disclosed implementations may further deploy one or more ground-based robotic units, such as indicated at 1151, to patrol the area where the elephants are, and/or create a barrier between potential threats and the herd. Similar to as with control of the drone 1142, control of the ground-based robotic unit 1151 can be based on a human intention derived from non-human animal communication data. In embodiments, control of the robotic devices (e.g., drone 1142 and/or ground-based robotic unit 1151) can be performed automatically, without human involvement, thereby shortening response times between when an animal provides input data, and a change in operation of the robotic devices.

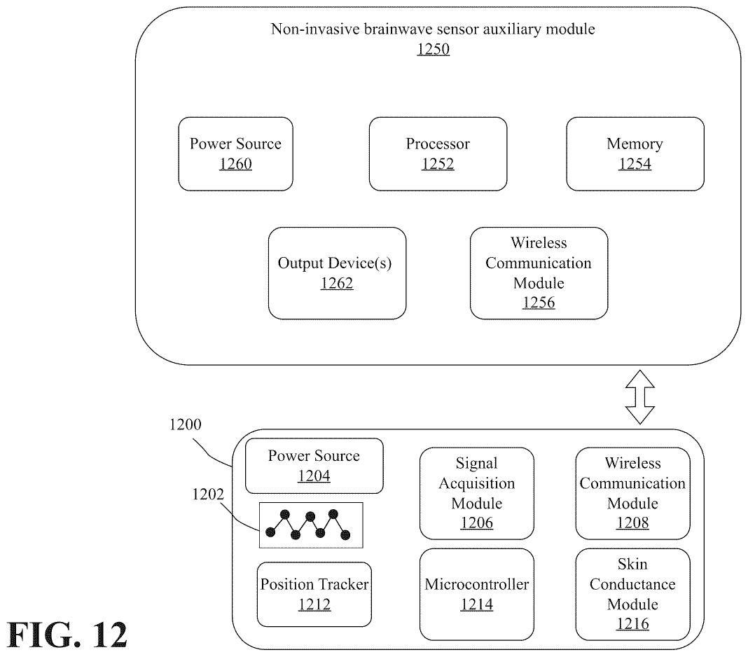

FIG. 12 shows a block diagram of an exemplary non-invasive sensor, in accordance with one or more embodiments. Sensor 1200 can include a substrate 1202 that can serve as electrodes. The substrate can include a spray-on conductive polymer ink (e.g., PEDOT:PSS) and/or ultra-flexible tattoo electrodes to map neural signals from the dog's head. In embodiments, the substrate 1202 can be applied to the skin of an animal via a biodegradable adhesive. In some embodiments, a small area of the dog's head may be shaved to expose a patch of skin for application of the substrate 1202. Thus, embodiments can include a flexible, biocompatible film that is applied to targeted regions of the dog's scalp, avoiding areas of thick fur by carefully shaving an area. Other embodiments may utilize an optimized spray formula that can penetrate sparse fur layers. In some embodiments, the conductive polymer ink is doped with additives such as sodium chloride (NaCl) for low contact impedance and enhanced signal acquisition.

In embodiments, captured signals are amplified by lightweight, on-body electronics integrated into the tattoo design or attached nearby on a collar-mounted processing unit. In embodiments, the tattoo is formulated for high adhesion and stretchability to withstand the dog's natural movements and environmental conditions, such as running, jumping, or exposure to moisture. In embodiments, the dog's fur may be trimmed in the area where the sensor 1200 is to be applied, prior to applying the sensor 1200. Sensor 1200 can be a scalp-mounted sensor, such as depicted at 1004 in FIG. 10. The sensor 1200 can further include a power source 1204. The power source 1204 can include a replaceable coin cell battery, rechargeable battery, and/or other suitable battery type. The battery can include a lithium-ion battery. The battery can provide power to signal acquisition module 1206, wireless communication module 1208, and other components within the sensor 1200. The signal acquisition module 1206 can include an ADC (analog-to-digital converter) that is fed a filtered input from a filter section that can include low-pass filters to remove high-frequency noise. The signal acquisition module 1206 can further include instrumentation amplifiers, programmable gain amplifiers, and/or other suitable amplifiers for boosting weak signals for further processing. The signal acquisition module 1206 may further include a clock generator to provide timing for the ADCs. The signal acquisition module may further include a microcontroller for control of the amplifiers and/or ADCs. In embodiments, the microcontroller can include an ARM Cortex processor, RISC-V processor, and/or other suitable processor type.

The wireless communication module 1208 can support protocols such as Near Field Communication (NFC), Bluetooth Low Energy (BLE), RFID (Radio Frequency Identification), and/or other suitable protocols. The wireless communication module 1208 can include one or more modulators that may provide FSK (Frequency Shift Keying), ASK (Amplitude Shift Keying), and/or PSK (Phase Shift Keying) modulations. The wireless communication module may further include a microcontroller for control of the modulators and/or amplifiers and other associated components. In some embodiments, the wireless communication module 1208 may include longer range communication capabilities such as WiFi, cellular, and/or satellite communication capabilities, which can enable the sensor 1200 to communicate with the system for animal-to-human communication 1020 via the internet or other suitable techniques. In embodiments, the non-invasive brainwave sensor further comprises a wireless data transmission module. In embodiments, the wireless data transmission module includes a Bluetooth Low Energy (BLE) module. The sensor 1200 can further include a position tracker 1212. The position tracker 1212 can include a Global Positioning System (GPS) receiver, and/or other suitable position tracking system. The sensor 1200 can further include a skin conductance module 1216. The skin conductance module 1216 can include hardware and/or software for determining skin conductance as measured via substrate 1202. In embodiments, the skin conductance can be used to determine a rate and/or level of perspiration of an animal. The sensor 1200 can further include a microcontroller 1214. The microcontroller can be coupled to the signal acquisition module 1206, position tracker 1212, and/or wireless communication module 1208, for control of various operations. In embodiments, the microcontroller 1214 can include an ARM Cortex processor, RISC-V processor, and/or other suitable processor type.

The sensor 1200 can interoperate with the non-invasive brainwave sensor auxiliary module 1250. The non-invasive brainwave sensor auxiliary module 1250 can be a collar-mounted processing unit such as depicted at 1008 in FIG. 10. The non-invasive brainwave sensor auxiliary module 1250 can include a processor 1252. The processor 1252 can include an ARM Cortex processor, RISC-V processor, and/or other suitable processor type. The processor 1252 can be coupled to memory 1254. The memory 1254 can include a non-transitory computer-readable medium. The memory 1254 can include a combination of random-access memory (RAM), read-only memory (ROM), Flash memory, and/or other suitable memory type. The non-invasive brainwave sensor auxiliary module 1250 can include a power source 1260. The power source 1260 can include a replaceable battery, rechargeable battery, or other suitable battery type. The non-invasive brainwave sensor auxiliary module 1250 can include a wireless communication module 1256. The wireless communication module 1256 may include components to enable communication with wireless communication module 1208 of the sensor 1200. As stated previously, this can include antennas and modulators for as Near Field Communication (NFC), Bluetooth Low Energy (BLE), RFID (Radio Frequency Identification), and/or other suitable protocols. Additionally, the wireless communication module 1256 may include components to support longer distance communication, such as WiFi, cellular network communication, and/or satellite-based communication. This can enable relay of brainwave data to the system for animal-to-human communication 1020 as shown in FIG. 10. The non-invasive brainwave sensor auxiliary module 1250 can include one or more output devices 1262. The output devices can include one or more LED (light-emitting diode) lights, a speaker, a haptic device (e.g. vibrator, buzzer, etc.), and/or other suitable output devices. The LED light can convey an operational status, such as being online, offline, low battery, etc. The speaker can be used to emit sounds and/or voice data that can be heard by the dog 1002 or other animal that is wearing brainwave sensor auxiliary module 1250. The haptic device can impart sensations of vibration or pulsing that can be felt by an animal as stimulus in response to commands that are verbally given or feedback to a correct response during a training exercise. In one or more embodiments, non-invasive biosensor 1116 of FIG. 11 may be similar to sensor 1200.

To support real-time applications requiring sub-second response times, the non-invasive brainwave sensor auxiliary module 1250 can implement advanced edge computing optimizations. The processor 1252 can execute quantized neural networks where weights and activations are reduced to INT8 or even INT4 precision while maintaining accuracy within 5% of full-precision models. The module can employ temporal convolutional networks (TCNs) with dilated convolutions capturing dependencies across 2-10 second windows of neural data using 10× fewer parameters than equivalent RNN architectures. For extreme low-latency requirements such as seizure prediction, the module implements a hierarchical processing pipeline: a lightweight anomaly detector running continuously at 1000 Hz identifies potential events, triggering a more complex classifier only when anomalies are detected. Common behavioral patterns identified during training are cached in memory 1254 using a locality-sensitive hashing scheme, enabling sub-millisecond pattern matching for frequently observed behaviors. These optimizations enable the auxiliary module 1250 to provide real-time feedback to the animal through output devices 1262 without perceptible delay.

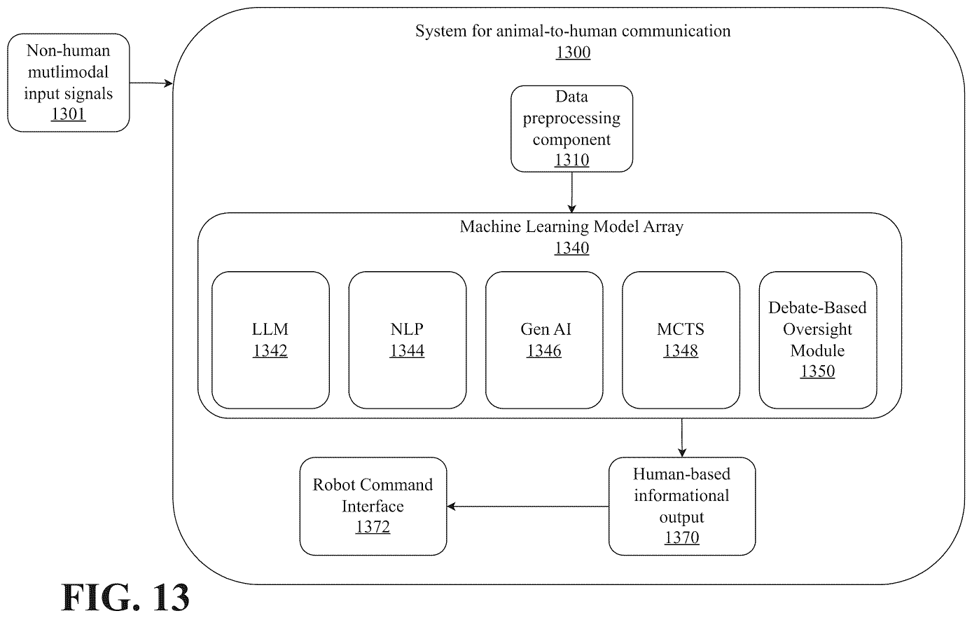

FIG. 13 is a block diagram illustrating components of a system for animal-to-human communication with debate-based oversight, in accordance with one or more embodiments. System 1300 can receive as input, non-human multimodal input signals 1301. The multimodal input signals can include vocalizations, gestures, movement patterns, biometric data, brainwaves, and so on. The brainwaves that can be included in the input signals 1301 can include brainwave signals from animals that are obtained via non-invasive sensors such as spray-on conductive polymer inks, epidermal tattoo sensors, wearable headgear with sensors attached to them, and so on. The animals that the brainwaves are received from can include dogs, cats, horses, oxen, primates, birds, cetaceans, and/or other suitable animals. The input signals 1301 can be input to the system 1300 for animal-to-human communication, and the resulting output can include a human-based informational output 1370, along with an output to the robot command interface 1372, thereby enabling animal-to-human and/or animal-to-machine communication.

The system 1300 can include a data preprocessing component 1310. The data preprocessing component 1310 can perform data conditioning on signals included in the non-human multimodal input signals 1301. The signal conditioning can include noise reduction techniques such as low-pass filtering to eliminate high-frequency artifacts, frequency domain filtering to isolate specific spectral components of interest (e.g., for vocalization harmonics), and band-pass filtering to target known communication frequency bands used by particular species. Additionally, outlier removal algorithms can be applied to eliminate anomalous spikes in data caused by sensor glitches and/or environmental interference. Temporal alignment and normalization may also be included, to ensure multimodal inputs such as movement, heart rate, and/or audio signals are synchronized and comparable across species. Other preprocessing steps may include Z-score normalization, signal smoothing (e.g., via moving average), baseline drift correction, and/or the interpolation of missing data to improve data quality before feeding into machine learning pipelines. The output of the data preprocessing component 1310 can be input to machine learning model array 1340.

Machine learning model array 1340 may include one or more machine learning models, neural networks, and/or other systems for processing and interpreting input data. The machine learning model array 1340 can include a large language model 1342. The large language model (LLM) 1342 can be trained for specific animals (e.g., species-specific or individual-specific) and can ingest continuous streams of neural population data recorded across multiple tasks and states. These models go beyond simple language: they become multimodal encoders of animal neural signals, motor outputs, observed behaviors, and contextual cues. By structuring training data to include “high-incentive” versus “neutral” tasks, the LLM can learn when the animal's neural signature deviates from its optimal preparatory patterns. In embodiments, the machine-learning system includes a large language model (LLM). In embodiments, the machine-learning system includes a large language model (LLM). In embodiments, the LLM includes a multi-head attention (MHA) mechanism. In embodiments, the MHA can improve self-attention by splitting the input into multiple “heads,” allowing the model to attend to different aspects of the data simultaneously. Each head processes information independently, and their outputs are combined to create a richer representation. In embodiments, the outputs from all heads can be concatenated and passed through a linear transformation to form the final representation.

The machine learning model array 1340 can include a natural language processing (NLP) module 1344. The NLP module 1344 can enable the conversion of human speech to animal-understandable patterns, which can be beneficial for the purposes of animal training. The NLP module 1344 can include NLP pipelines that parse human language into semantic tokens. These tokens can then be mapped onto a species-specific “neural command embedding space.” For dogs, this might involve converting a particular vocalization from a dog as a request for food, request to go outside, a request to come inside, and so on.

The machine learning model array 1340 can include a generative artificial intelligence (Gen AI) module 1346. The Gen AI module 1346 can enable supplementing training data with synthesized data, such as vocal data (e.g., canine vocalizations or whale codas), where the vocal data is created with properties such as number and regularity of signal units (clicks, barks), spectral means, and/or amplitude envelopes. The Gen AI module 1346 can include a generative adversarial network (GAN), such as WaveGAN, InfoGAN, fiwGAN, and/or other suitable GAN.

The machine learning model array 1340 can include a Monte Carlo Tree Search (MCTS) module 1348. The MCTS module 1348 can enable adaptive, look-ahead scheduling decisions. Instead of applying fixed heuristics or static load-balancing, disclosed embodiments can simulate and/or evaluate multiple future states of the pipeline before choosing the next action. By repeatedly exploring and exploiting different pipeline routing decisions (e.g., which specialist model to send partial outputs to, or how to scale certain pipeline segments), MCTS can minimize the cumulative regret over time, converging toward near-optimal scheduling policies that are robust to changing conditions, input distributions, and latency constraints. In one or more embodiments, the MCTS module 1348 can enable enhanced resource allocation, such as allocating more GPUs, selecting specialized hardware accelerators, and/or adjusting batch sizes downstream.

The machine learning model array 1340 can include a debate-based oversight module 1350. Debate-based oversight module 1350 may utilize machine learning techniques to provide a framework that can enable robust debates between models trained on different domains and/or datasets. The debate-based oversight module 1350 can implement consensus building, serving as a digital mediator for multiple machine-learning models and/or agents, aggregating and synthesizing diverse human interpretations based on animal input data, such as vocalizations, brainwaves, gestures, movement patterns, and/or biomarkers. Embodiments can include performing a debate-based oversight process on the additional translation stage as part of converting the human interpretation to the robot command.

The machine learning model array 1340 can include, as an output, human-based informational output 1370. The human-based informational output 1370 can include visual information such as text and/or symbology. The human-based informational output 1370 can include audio information. The audio information can include synthesized speech, tones, and/or other sounds to convey information identified by the machine learning model array 1340.

The human-based informational output 1370 can be used to generate a command to a robot command interface 1372. The robot command interface can include an API, such as a RESTful API. In embodiments, the command data is encapsulated in one or more JSON files to include robot parameters such as a command, movement directions, movement speed, and so on. Thus, disclosed embodiments can provide a feature enabling animal-machine control. An example use case can include the integration of wearable electronic devices for service dogs in crime scenes, potentially providing remarkable benefits. Disclosed embodiments can leverage the unique capabilities of animals, such as their exceptional sense of smell, while enhancing their effectiveness through collaboration with machines. The hybrid approach of disclosed embodiments can streamline the investigative process by enabling real-time communication between the service dog and ground-based robotic units. For instance, when the dog detects a scent of interest, its brainwaves and/or vocalizations interpreted as “curiosity” could instruct the robot to slow down or stop. This coordinated effort ensures that both the dog and robot can explore the area systematically, reducing human intervention and increasing efficiency in complex environments.

In disclosed embodiments, the machine-learning models employ advanced parameter-efficient tuning techniques to adapt to individual animal behaviors without requiring excessive computational resources. Once the signal is processed, the output can trigger a robot command API to relay instructions such as “slow down” or “stop.” Additional embodiments can include integrating environmental data, such as the layout of the crime scene or the proximity of objects, to enable more contextual responses.

Reinforcement Learning (RL) is a branch of machine learning where agents can learn to make decisions by interacting with an environment and receiving feedback in the form of rewards or penalties. In embodiments, assigning a reward or value function to nodes can be based on RL principles, such as optimizing actions or decisions based on objective metrics like correctness and/or complexity minimization. This approach can be used in scenarios requiring iterative decision-making, such as search algorithms and/or dynamic optimization problems. Disclosed embodiments can enable adaptive performance improvements through reinforcement learning, improving the ability to interpret nuanced signals and refining decision-making over time. Disclosed embodiments can provide a blend of animal-machine interaction that enhances operational capabilities and increases the potential for technology to work in harmony with the natural instincts of animals.

In an embodiment, a debate-based oversight system is instantiated as a module within the machine-learning model array and orchestrated pipeline to arbitrate between competing hypotheses produced by specialist models. The module can include multiple “expert” agents and a separate “judge” agent. The expert agents interface with large-language models and/or small-language models to generate alternative interpretations of the same multimodal animal input, while the judge agent—preferably a weaker or differently trained model with constrained context—selects the more plausible interpretation. The same framework can incorporate generative adversarial networks as additional expert or adversarial components.

In operation, the experts are trained on a primary dataset and the judge is trained on a secondary dataset that is smaller or otherwise differentiated, which encourages the judge to evaluate arguments rather than memorize outcomes. The judge may consider similarity to known vocalization patterns, alignment with environmental and physiological context, and confidence estimates from the experts; it can also consult a knowledge graph and an embeddings cache to ground its decision in prior adjudications. This arrangement, including primary/secondary training regimes and the expert/judge division of labor, is described both in the detailed description and in the claims.

The debate-based oversight system integrates with the LLM orchestration system and the Monte Carlo Tree Search (MCTS) module so that debate outcomes directly influence search and scheduling decisions. The orchestration layer represents intermediate reasoning as nodes in a search tree; at selected nodes a judging phase is triggered, in which a detector and/or judge evaluates partial solutions against intended meaning, logic, and graph-based constraints. When experts disagree at a node, the judge selects the more credible argument, and MCTS immediately updates that node's value. If the debate indicates the node lies on a promising path, MCTS increases its value and expands it; if the debate reveals inconsistencies or low plausibility, the node's value is reduced and its subtree can be pruned.

The embeddings cache stores triplets of input features, debate outcomes, and human interpretations so that future inferences encountering similar states can be resolved more quickly and with lower compute cost. When a new node's embedding is near a cached cluster that previously won a debate, the judge can reuse calibrated priors and the MCTS policy can be biased accordingly; conversely, nodes falling in sparse or contentious regions trigger fuller debates and additional sensing. The specification explains that caching reduces redundant computation, lowers energy consumption, and improves scalability for frequently encountered communication patterns.

To improve robustness in high-uncertainty scenarios, the module can synthesize counterfactual or rare examples using generative adversarial networks and present them to the experts and judge as adversarial tests. These synthetic scenarios help probe model boundaries and stress-test arbitration logic before deployment, yielding better calibrated decisions when natural data is ambiguous or noisy. The arrangement of GANs alongside LLMs and SLMs inside the debate-based oversight module, and their use for data augmentation and robustness testing, is described in the detailed description.

The same debate architecture can operate on the edge using small-language models in place of, or in addition to, larger models, enabling offline functionality in bandwidth-constrained environments such as underwater or remote terrestrial deployments. The disclosure details that SLM-based debate and judging provide a practical path to continuous operation when connectivity is intermittent, while preserving the core expert-versus-judge dynamics and subsequent integration with search.

The debate-based oversight process is connected end-to-end with cross-species outputs. After the judge selects the prevailing meaning for the non-human communication input, the system associates that meaning with a human interpretation and then performs a cross-species operation, such as rendering text or audio for human users or issuing a robot control command through a defined API. The same oversight can be applied again to the additional translation stage that converts the human interpretation into robot commands, providing a second layer of arbitration before actuation. These stages and their coupling to debate-based oversight are set forth in the summary and in method and system claims, including explicit recitations that MCTS may prune branches corresponding to selected human interpretations.

During streaming inference, the system adapts to evolving evidence. Newly arriving sensory data, such as changes in ambient noise or posture cues, can trigger node re-scoring, renewed debates, or re-judging at affected parts of the search tree. The disclosure explains that this dynamic re-evaluation allows the pipeline to revise earlier assumptions, prune outdated branches, and converge on contextually consistent interpretations with lower latency than naïve exhaustive search.

The debate-based oversight system also supports multi-objective scoring at each node, where correctness, coherence, semantic alignment to knowledge-graph concepts, and policy compliance are aggregated into a fitness value used by MCTS. Reinforcement-learning style value functions can be learned over time so that the system improves with experience, pruning suboptimal partial solutions earlier and prioritizing branches that historically align with validated outcomes. This coordination of debate-aware scoring, dynamic pruning, and RL-informed search is described in the detailed description surrounding MCTS and node valuation.

At the agent level, the disclosure provides concrete mechanics for how experts and the judge conduct and learn from debates. A first agent may propose an interpretation grounded in annotated vocalization-behavior corpora, while a second agent advances an alternative hypothesis emphasizing environmental or physiological context; the judge evaluates these proposals, logs its reasoning, and, when internal checks confirm correctness, stores the pattern in the embeddings cache for future reuse. If a later audit suggests error, self-reflection prompting modifies how the judge weighs debate signals on subsequent cases. These behaviors are explicitly described for the agents and the judge's learning loop.

Collectively, the debate-based oversight system supports and improves the existing architecture by providing a principled arbitration layer that converts model disagreement into actionable search signals, by amortizing prior decisions through an embeddings cache, by hardening performance with adversarial synthesis, and by enforcing a second oversight pass on robot-command translation when desired. The specification identifies these roles across the system diagrams and claims, and details how debate outcomes feed MCTS to accelerate convergence, improve accuracy, and reduce computation and energy costs in animal-to-human and animal-to-machine communication.

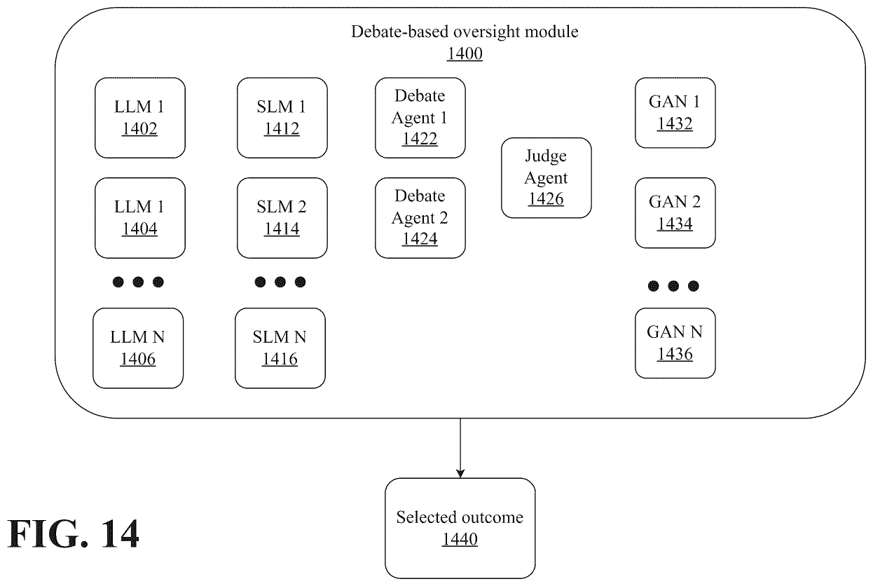

FIG. 14 is a block diagram illustrating details of a debate-based oversight module, in accordance with one or more embodiments. Debate-based oversight module 1400 can include a plurality of large language models (LLMs), indicated as LLM 1 1402, LLM 2, 1404, and LLM N 1406. In practice, there can be more or fewer LLMs than depicted in FIG. 14. Debate-based oversight module 1400 can include a plurality of small language models (SLMs), indicated as SLM 1 1412, SLM 2, 1414, and SLM N 1416. In practice, there can be more or fewer SLMs than depicted in FIG. 14. Debate-based oversight module 1400 can include a plurality of generative adversarial networks (GANs), indicated as GAN 1 1432, GAN 2, 1434, and GAN N 1436. In practice, there can be more or fewer GANs than depicted in FIG. 14.

Debate-based oversight module 1400 can include a first debate agent, indicated as debate agent 1 1422. Debate-based oversight module 1400 can include a second debate agent, indicated as debate agent 2 1424. Debate-based oversight module 1400 can include a judge agent, indicated at 1426. The agents can interface to one of the one or more LLMs to provide input to, and obtain output from the LLM. In embodiments, two or more of the LLMs within debate-based oversight module 1400 can be “expert” LLMs (with access to evidence or higher capability in reasoning about a scenario) and at least one LLM can be a judge LLM that is a “weaker” LLM judge (with limited context). The judge LLM can be configured to select the most plausible argument, effectively producing a decision even with no absolute ground truth. In additional embodiments, two expert agents argue different sides of a translation or interpretation. A weaker judge agent with no direct ground truth can use these arguments, combined with knowledge graph references and/or previously cached embeddings, and can be configured to pick the more likely correct argument. In the context of animal-to-human translation, this debate-based approach can be used to address uncertainties in animal vocalization interpretation, and aligns well with the complexities of translating non-human communication into human-understandable terms. Embodiments can include storing the non-human animal communication data, debate-based oversight outcome data, and corresponding human interpretation in an embeddings cache. In embodiments, the use of the embeddings cache can significantly enhance the efficiency of the system by storing previously computed embeddings for frequently encountered animal communication inputs. Instead of recalculating embeddings for the same inputs during every inference, the system can quickly retrieve them from the cache, reducing redundant computations. This not only speeds up the inference process but also lowers computational costs and energy consumption. Moreover, caching can improve scalability, as it allows the system to handle larger workloads without overwhelming processing resources. In embodiments, performing the debate-based oversight process comprises using a primary debate machine-learning system and a secondary debate machine-learning system, wherein the primary debate machine-learning system is trained on a primary dataset, and wherein the secondary debate machine-learning system is trained on a secondary dataset, wherein the primary dataset is larger than the secondary dataset. In embodiments, performing the debate-based oversight process comprises using a first expert debate machine-learning system, a second expert machine-learning system, and a judge machine-learning system, wherein the first expert debate machine-learning system and second expert debate machine-learning system are trained on a primary dataset, and wherein the judge machine-learning system is trained on a secondary dataset, wherein the primary dataset is larger than the secondary dataset, and wherein the judge machine-learning system is configured to select a human interpretation result from one of the first expert debate machine-learning system and the second expert debate machine-learning system.

In embodiments, a first agent interfaces with a language model (e.g., LLM-A) trained on annotated datasets of animal vocalizations and behaviors to propose an initial interpretation (e.g., “scared”). Similarly, a second agent connects to a different language model (e.g., LLM-B) that might rely on complementary data sources (e.g., environmental context, posture, or physiological data) to provide an alternate hypothesis (e.g., “angry”). The judge agent can interface with a smaller, specialized model, to evaluate and/or arbitrate the proposed hypotheses. The judge agent can weigh multiple factors such as, similarity to known vocalization patterns, alignment with contextual cues (e.g., presence of a potential threat), and/or confidence scores from the two agents. In disclosed embodiments, if the judge chooses correctly (as determined by internal consistency checks, e.g. linking to empirical evidence), embodiments can store this reasoning pattern in the embeddings cache for future quick lookups. If the judge agent errs, self-reflection prompting takes effect, guided by previously stored embeddings to refine how the judge agent uses debate signals.

Disclosed embodiments can further utilize one or more of the GANs to add more robustness to predictions, particularly when exploring high-uncertainty scenarios. Embodiments can include using synthetic data generation from GANs to augment received data. For example, the GANs can be configured to create hypothetical vocalization scenarios to test the arbitration model's decision-making capabilities, potentially leading to improved performance over time.

In embodiments a Large Language Model (LLM) generates a complex solution (e.g., a chain-of-thought response or a series of translations), we can represent the ongoing generative process as a search tree of partial outputs (nodes). Each node corresponds to a partial solution state or a candidate reasoning step. Each node within the LLM can store embeddings derived from the LLM's current hidden states (including cached information), alongside semantic alignments from the knowledge graph (KG). This context ensures that intermediate computations (e.g., partial translations, partial reasoning steps) are captured in a retrievable form. At certain nodes, a judging phase can be triggered, where an LLM-based verifier (referred to as a “detector”) evaluates the partial output's alignment with the intended meaning, logic, and constraints derived from KGs and/or previously stored embeddings.

In cases where uncertainty is high, a debate process can be initiated between two or more expert agents (stronger LLMs with access to full contextual resources) over the correctness of the partial solution at a node. The weaker judge model (or a specialized verification agent) decides which side's argument is more likely to be correct, leveraging previously discovered strategies and/or embeddings stored in information caches. In embodiments, the debate or judging step can influence MCTS node scoring (enabled by MCTS module 1348 of FIG. 13): if the debate strongly suggests node N is on a correct path, MCTS increases its value. If a node's partial reasoning fails debate checks, the MCTS reduces that node's value. Embodiments can include performing a Monte Carlo Tree Search process to prune a branch corresponding to the human interpretation result that was selected, based on multimodal input data.

Disclosed embodiments can support multiple objective functions, such as: correctness (agreement with known truths), coherence (internal consistency), semantic alignment (mapping to KG concepts), and/or compliance (adherence to the user's intent or original prompt). Each node's value comprises an aggregate score from these functions. For example, a node's potential “fitness for purpose” can be computed as a weighted sum of correctness and semantic alignment minus complexity costs. Disclosed embodiments can further include dynamic pruning, based on the aforementioned scores. Using the scores, disclosed embodiments can prune nodes (suboptimal partial solutions) early. If a debate at a node reveals severe alignment issues and/or the detector can identify a logical flaw, that node and its subtree can be pruned to save computation resources. Furthermore, in response to detecting increased uncertainty (e.g., because newly added data contradicts prior assumptions), disclosed embodiments can re-score affected nodes, potentially triggering a new debate and/or re-judging step.

An example use case can include translating animal signals into human and/or machine instructions under evolving environment conditions, such as the aquatic environment depicted in FIG. 1. For instance, an initial prompt might request: “Translate whale call pattern X into a human-equivalent intention for the robot to act upon.” The system of disclosed embodiments can form a reasoning tree with multiple candidate translations. At key nodes, a debate occurs between two experts, one advocating translation A, another translation B. A weaker judge agent, referencing KG embeddings and/or previously stored verification heuristics, selects a preferred argument. Since environments are inherently dynamic, new assessments may emerge as additional data becomes available. For example, newly acquired underwater noise data arriving mid-process can trigger rescoring of nodes based on outdated assumptions, enabling MCTS to intelligently prune irrelevant branches.

Through iterative debate and refined judging processes, the system can converge on translations that are both contextually aware and semantically precise, and provide a selected outcome 1440. These techniques can provide a translation with improved accuracy that can take less time and/or resources than a naive approach because incorrect paths were pruned early and caching avoided redundant computations. Thus, disclosed embodiments can provide functionality of machine-learning based judging and debate on intermediate results as part of a generative process, represented as a tree and managed by MCTS+RL scoring, thereby enabling a powerful decision-making and reasoning framework. By dynamically pruning low-quality branches, adapting to new data, and combining debate-based oversight with adversarial refinement and self-reflection, disclosed embodiments can improve accuracy, reduce latency, and scale to complex evolving tasks. Consequently, disclosed embodiments maintain flexibility and responsiveness, ensuring alignment with continuously updated constraints and environmental conditions.

The debate-based oversight module 1400 can interface with a blockchain-based provenance system 1450 that maintains an immutable record of all translation decisions and the evidence supporting them. In embodiments, each debate outcome is packaged as a transaction containing: the original multimodal input data hash, the competing interpretations from debate agents, the judge's decision rationale, and cryptographic signatures from all participating models. These transactions are recorded on a permissioned blockchain network operated by collaborating research institutions, using a Practical Byzantine Fault Tolerant (PBFT) consensus mechanism suitable for small-scale scientific consortiums. The system implements zero-knowledge proofs allowing researchers to verify that a particular translation was generated by certified models without revealing proprietary model architectures or training data. Smart contracts automatically enforce data usage policies, such as requiring citation of original data sources or limiting commercial use of translations from endangered species data. Integration with the Interplanetary File System (IPFS) enables distributed storage of large multimodal datasets, with only content-addressed hashes stored on-chain, reducing blockchain bloat while maintaining verifiability. While the aforementioned examples emphasized the use of LLMs, a similar approach can be achieved utilizing the small language models (SLMs) illustrated in FIG. 14, either as a replacement for or a complement to the LLMs. That is, the debate agents and/or judge agent can interface with SLMs instead of LLMs in some embodiments. One distinct advantage of SLMs lies in their suitability for execution on edge devices, such as embedded systems, low-power hardware, and/or devices that must function in offline mode due to limited or nonexistent internet connectivity. For instance, in the challenging undersea environment depicted in FIG. 1, where internet access is often sluggish, prohibitively expensive, or entirely unavailable, SLMs emerge as a practical solution for ensuring uninterrupted functionality. By integrating SLMs, disclosed embodiments can enable robust, efficient, and autonomous operations, allowing the features of the system to be fully implemented as a standalone solution. This capability not only reduces dependency on external infrastructure but also enhances reliability in critical environments, such as those with harsh conditions or restricted connectivity.

In one embodiment, the system further refines emotional state detection by computing a normalized confidence score on a 0 -100 scale, wherein a score of 100 represents the highest certainty of the detected neural pattern corresponding to a given emotional state. The computed confidence score is derived by integrating multiple factors, including signal quality metrics (e.g., signal-to-noise ratio, electrode impedance), the strength of pattern matching against pre-established emotional signatures, temporal persistence and consistency of the signal over predefined time windows, cross-correlation with supplementary physiological indicators (such as heart rate variability), and historical detection accuracy for the specific animal subject. In this embodiment, the predetermined threshold for triggering a particular emotional state determination is dynamically adjustable and may vary based on the criticality of the detected state, the operational context, and the inherent signal characteristics associated with that state.

For instance, in high-stakes applications—such as the detection of acute distress in service animals—the confidence threshold may be set at a value of 90 to 100 to minimize false-positive detections and ensure immediate corrective action. In contrast, for routine emotional monitoring, a threshold in the range of 75 may be sufficient, whereas early-warning or preliminary detection scenarios may employ thresholds as low as 60 to flag potential states for subsequent verification. Moreover, the system may implement a multi-tiered thresholding protocol, wherein detected confidence scores trigger graduated responses as follows: a high confidence range (90-100) triggers immediate action or alerts; a medium confidence range (75-89) initiates secondary validation—such as additional sensor data fusion or a brief period of intensified monitoring; a low confidence range (60-74) results in an increased sampling rate for further data acquisition; and scores below 60 are logged for analysis without immediate intervention.

Further, the system incorporates temporal factors into the confidence computation by requiring that the neural signature persist for a minimum duration (e.g., 5 seconds for acute states, 30 seconds for general states) before the score is finalized. Decay factors are applied to account for sustained signals, while hysteresis is implemented to prevent rapid oscillation between state determinations, thereby ensuring stability in emotional state classification. The rate of change of the confidence score is also monitored to detect abrupt transitions versus gradual trends.

Adaptive thresholding is achieved via a closed-loop feedback mechanism wherein the system automatically adjusts its thresholds based on real-time verification against handler observations and environmental context. For example, if repeated observations confirm that a particular emotional state (e.g., mild anxiety) is reliably detected at confidence scores in the 80-85 range, the system may autonomously lower the threshold for that state to 80 to enhance sensitivity. Conversely, if false positives occur, the threshold may be increased accordingly. Additionally, the system may tailor thresholds based on the criticality of the emotional state, historical detection performance, typical signal amplitudes, and potential consequences of misclassification. Exemplary state-specific thresholds might include values such as 95 for acute distress, 85 for mild anxiety, 80 for attention or focus, and 75 for general happiness.

The computation of the confidence score is further refined through advanced signal processing techniques. The system applies Fourier and Wavelet transforms to extract time-frequency features and employs deep neural networks with multi-head attention mechanisms to weigh various input parameters dynamically. These neural networks are trained on extensive datasets comprising annotated neural patterns and associated behavioral states, and they incorporate adaptive learning algorithms that update threshold levels based on both short-term sensor data and long-term performance trends. In certain embodiments, the system may also utilize probabilistic models and Bayesian inference to adjust thresholds in real time, taking into account environmental variables such as time of day, ambient conditions, and the animal's recent activity history.

By integrating these advanced thresholding methodologies with a dynamic, multi-tiered feedback loop, the present invention enables highly sensitive and robust emotional state detection. The adaptive thresholding not only optimizes detection sensitivity and minimizes false positives but also allows for a scalable and context-aware communication interface that can be tailored to a wide array of species-specific requirements and operational scenarios. This embodiment, by combining ultra-detailed signal analysis, adaptive learning, and graduated response protocols, represents a significant advancement over static threshold models and provides a comprehensive, self-adjusting framework for bilateral communication between humans and non-human animals.

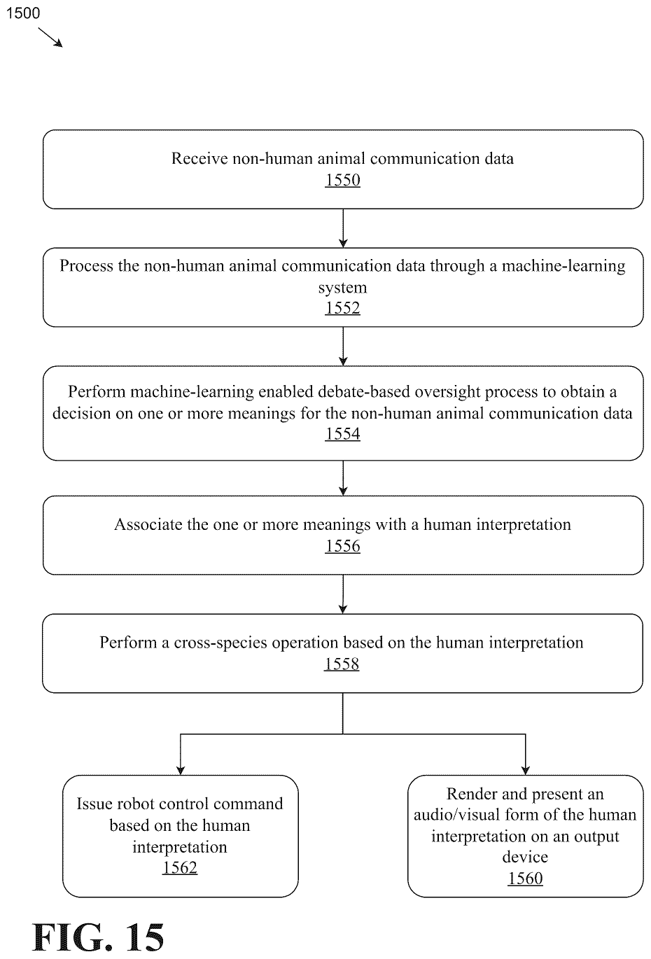

FIG. 15 is a flow diagram illustrating an exemplary method for animal-to-human communication with debate-based oversight, according to one or more embodiments. The method 1500 starts with receiving non-human animal communication data at block 1550. The non-human animal communication data can include vocalizations, movement data, biometric data, and/or brainwave data. The brainwave data can be acquired from one or more non-invasive sensors. The sensors can include sensors comprised of conductive polymer ink, tattoo electrodes, and/or other suitable sensors. In embodiments, the tattoos can be placed over regions of the brain associated with emotion (e.g., limbic system regions) in order to detect neural activity indicative of emotions and/or feelings such as stress, fear, and/or happiness. In embodiments, the non-invasive brainwave sensor comprises an epidermal tattoo sensor. In embodiments, the epidermal tattoo sensor comprises carbon nanotubes (CNTs). In embodiments, the epidermal tattoo sensor comprises gold nanomaterials. One or more embodiments can include high-sensitivity brainwave capture technology that can enable non-invasive capture of brainwave patterns associated with animal responses, such as attention, excitement, or stress. This setup is especially useful in applications like service dog training, where brainwave signals can indicate readiness for commands or stress levels in various environments. The non-invasive brainwave sensor can include sensors affixed to wearable headgear, such as shown at 1067 of FIG. 10 and/or non-invasive biosensor 1116 of FIG. 11.

The method 1500 continues with processing the non-human animal communication data through a machine-learning system at block 1552. The machine-learning system can be trained using supervised learning techniques. Training data can include sample brainwaves obtained during known emotional states, such as fear, excitement, and/or stress. The brainwave signals can include EEG signals. The brainwave signals can be mapped to known situations, to enable creation of labeled data. The labeled data can include multiple parameters, such as observed behaviors, external stimuli, and/or physiological states. The model used can include Support Vector Machines (SVM), Random Forrest, CNNs (Convolutional Neural Networks), RNNs (Recurrent Neural Networks)/LSTMs (Long Short-Term Memory), and/or other suitable machine learning systems.

The method 1500 continues with performing a machine-learning enabled debate-based oversight process to obtain a decision on one or more meanings for the non-human animal communication data at block 1554. The debate-based arbitration by machine learning of disclosed embodiments can provide a powerful mechanism for resolving uncertainty and improving decision-making. By utilizing two “expert” machine learning systems that generate distinct responses to a common prompt and a “judge” system to evaluate these responses, the framework fosters diverse perspectives while ensuring the selection of the most credible or appropriate answer. This method enables the system to draw upon multiple knowledge bases, leveraging the strengths of each expert model while minimizing the risk of bias or oversimplification. Additionally, the disclosed embodiments can refine responses through iterative reasoning, driving the quality of solutions.

The method 1500 continues to block 1556, where the one or more meanings are associated with a human interpretation, such as an emotional state (e.g., fear, excitement, anger), or an intention (wanting to dig, go outside, run, etc.). When applied to unsupervised learning for animal-to-human translation systems, the debate-based approach of disclosed embodiments can accelerate learning by creating structured feedback loops. In this paradigm, the expert machine learning systems propose candidate translations for animal vocalizations, movements, gestures, and/or brainwaves, while the judge machine learning system determines which translation aligns best with observed patterns and/or contextual cues. By pruning less accurate interpretations early in the process and constantly re-evaluating based on new data, disclosed embodiments can adapt rapidly to nuanced communication signals. The debate-based strategy of disclosed embodiments can enrich the semantic mapping of animal behaviors and foster more accurate translations, enhancing interspecies communication in applications such as pet interaction, wildlife monitoring, and/or service animal functionality.

The method 1500 continues to block 1558 where a cross-species operation is performed based on the human interpretation. The method 1500 can include continuing to block 1560, where the cross-species operation includes rendering and presenting an audio/visual form of the human interpretation on an output device, such as depicted on device 1040 of FIG. 10. The method 1500 can include continuing to block 1562, where the cross-species operation includes issuing a robot control command to a robot, based on the human interpretation, such as depicted at 1142 and 1151 of FIG. 11. In embodiments, one, or both of blocks 1560 and 1562 may be executed.

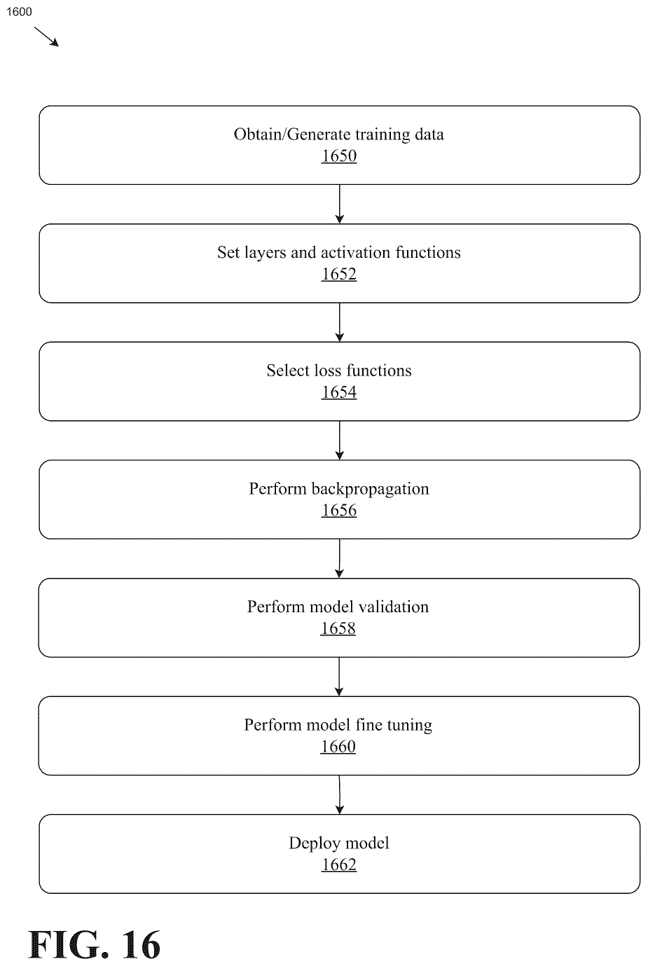

FIG. 16 is a flow diagram illustrating an exemplary method for training a system for animal-to-human communication, according to one or more embodiments. The method 1600 starts with obtaining and/or generating training data at block 1650. The training data can include multiple sensor readings collected from animals in different emotional and cognitive states. The data collected can include brainwave data. The brainwave data can be categorized based on frequency ranges and corresponding associations. In embodiments, delta brainwaves (0.5-4 Hz) can be associated with deep sleep, relaxation, or unconscious states, theta brainwaves (4-8 Hz) can be associated with to relaxation, creativity, and drowsiness, alpha brainwaves (8-14 Hz) can be associated with calmness, focus, or light relaxation, beta brainwaves (13-30 Hz) can be associated with attention, alertness, and problem-solving., and gamma brainwaves (30-100 Hz) can be associated with high-level cognition, sensory perception, and learning. Additionally, the training data can include various physiological and/or biometric data. The data can include a heart rate (HR) and/or a heart rate variability (HRV). In embodiments, an elevated HR combined with a low HRV can indicate stress, excitement, or fear. In contrast, a normal HR along with an elevated high HRV can indicate a calm or relaxed state. The data can include a breathing rate. Rapid breathing can be indicative of stress, anxiety, or high alertness, while slow, rhythmic breathing can indicate a calm state. The data can further include perspiration levels. In embodiments, the perspiration levels can be associated with an emotional state. As examples, a high perspiration level can be associated with fear, stress, and/or excitement, while a low perspiration level can be associated with relaxation and/or drowsiness. In embodiments, the training data is preprocessed, such as via normalizing, filtering, and/or other techniques. Then, the data may be labeled via expert labeling, and/or other techniques. The data can include animal vocalization data, such as barks from dogs, chirps from birds, clicks and songs from cetaceans, and so on. The data can include animal gesture data, such as tail wagging, movement of limbs, and so on. The data can include animal movement data, such as movement patterns, speed of movement, and so on.

The method 1600 continues with setting layers and activation functions at block 1652. In a neural network, layers are the building blocks that form the structure of the network. Each layer comprises a collection of neurons (also called nodes or units), and each neuron performs a specific computation on the input data. The output of one layer becomes the input to the next layer, creating a series of transformations from the input to the output. The layers can include input layers, output layers, and/or hidden layers. The activation functions introduce non-linearity into the model, allowing it to learn and represent complex patterns in the data. In embodiments, the activation functions can include a sigmoid function, a hyperbolic tangent function, a rectified linear unit (ReLU), a Leaky ReLU, softmax function, and/or other suitable activation function. The method 1600 continues to block 1654 for selecting loss functions. The loss functions are mathematical functions used in machine learning to measure the difference between the predicted values produced by the model and the actual target values from the training data. In one or more embodiments, the loss functions can include Mean Squared Error (MSE), Mean Absolute Error (MAE), Categorical Cross-Entropy, and/or other suitable loss functions. The loss functions can be used to determine if the model is sufficiently trained. The method 1600 continues to block 1656 for training the model using backpropagation. The backpropagation process can include computing gradients of the loss with respect to the weights and biases in the output layer. These gradients are propagated backward through the neural network to the hidden layer. The method 1600 continues to block 1658, where the model is validated. The validation can include using an additional set of non-human animal cognitive condition data that was not part of the original training dataset as a test dataset. In embodiments, this validation can be used to identify and correct overfitting. The method 1600 can include model fine-tuning at block 1660. The model fine-tuning can include adjusting weights and/or other hyperparameters as needed to improve model output. The method 1600 continues to block 1662, where the model is deployed for use in performing one or more aspects of animal-to-human communication, including deploying debate-based machine learning systems and/or debate agents and/or judge machine learning systems and/or judge agents, as described herein.

As can now be appreciated, disclosed embodiments can provide a machine learning system capable of translating animal vocalizations into human-understandable intentions using unsupervised learning techniques that are enabled by debate-based ML verification. These techniques can represent a significant leap forward in cross-species communication. Unlike supervised methods that require large, labeled datasets, which are often unavailable or difficult to obtain for animal communication, the unsupervised learning of disclosed embodiments allows detection of patterns, clusters, and associations in raw vocal data without prior human labeling. By interpreting pitch, duration, frequency modulation, and contextual cues, the system can begin to associate specific sounds or combinations with behavioral outcomes or environmental triggers.

One innovative feature of disclosed embodiments is the integration of debate-based verification, in which two expert ML agents analyze an input vocalization and generate competing hypotheses about the speaker's intent, for example, signaling danger, requesting food, or expressing social bonding. A third agent, acting as a judge, evaluates the quality and likelihood of these competing inferences based on consistency, prior observations, and predictive accuracy. This triadic approach can foster self-correction and refinement without human supervision, leading to a progressively more accurate model of animal intent. Beyond advancing our understanding of animal cognition, disclosed embodiments can aid in conservation, improve animal welfare in domestic and agricultural settings, and open entirely new domains in human-animal interaction.’

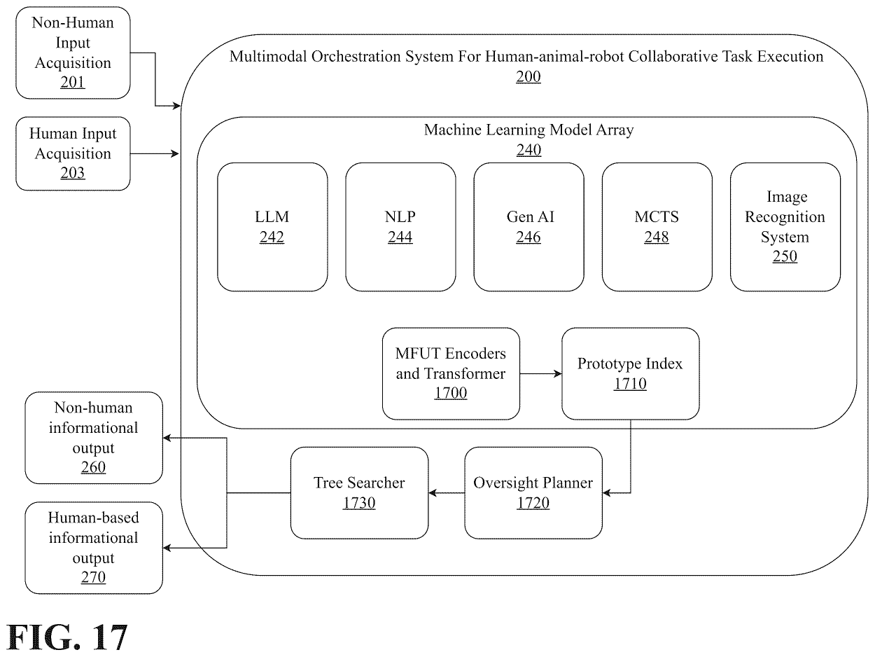

FIG. 17 is a block diagram illustrating an expanded multimodal orchestration system with integration of a multimodal foundation model for universal translation (MFUT). In one embodiment, the system includes non-human input acquisition 201 and human input acquisition 203 that provide raw multimodal signals such as animal vocalizations, body pose, neural and biometric signals, olfactory cues, human speech, and environmental context. These inputs are processed by a machine learning model array 240 that contains multiple specialized subsystems, including an LLM 242, NLP 244, and Gen AI 246, which together provide language modeling, semantic conditioning, and synthetic augmentation.

In an expanded embodiment, model array 240 is enhanced by a MFUT encoders and transformer 1700. MFUT encoders and transformer 1700 comprise a bank of modality-specific encoders coupled to a shared transformer backbone that fuses acoustic, visual, neural, proprioceptive, olfactory, and text inputs into a unified embedding space. MFUT encoders and transformer 1700 enable cross-species generalization by aligning heterogeneous signals into commensurate representations, allowing zero-shot translation of novel species, contexts, or modalities.

Outputs from the MFUT encoders and transformer 1700 are compared against a prototype index 1710. Prototype index 1710 stores semantic centroids derived from human glosses and unsupervised clusters of animal signals. When an embedding is received, prototype index 1710 retrieves nearest neighbors and candidate labels, returning meaning hypotheses with associated similarity scores. This retrieval process provides calibrated interpretations, for example recognizing an unfamiliar elephant trumpet as closely related to known alarm prototypes.

Results from MFUT encoders and transformer 1700 and prototype index 1710 are delivered to an oversight planner 1720. Oversight planner 1720 integrates evidential support from different modalities, evaluates uncertainty estimates, and enforces safety policies. When candidate interpretations conflict or carry low confidence, oversight planner 1720 can defer action, request additional modalities, or issue a conservative response.

Oversight planner 1720 interacts with a tree searcher 1730 configured to extend Monte Carlo tree search (MCTS) 248. Tree searcher 1730 explores possible downstream actions informed by translation hypotheses, assigns branch priors based on confidence, and prunes branches with weak evidence. This enables the system to perform planning that balances safety with responsiveness. For example, when a macaque vocalization may signal either aggression or play, tree searcher 1730 evaluates action paths and suppresses those that could escalate conflict, instead selecting monitoring or benign engagement.

Outputs of tree searcher 1730 are rendered through non-human informational output 260, human-based informational output 270, and robotic command interfaces, ensuring that validated interpretations propagate to all collaborators.

The embodiment extends the existing platform by integrating the MFUT encoders and transformer 1700, prototype index 1710, oversight planner 1720, and tree searcher 1730 into the orchestration system. This enables a single embedding space across species and modalities, provides calibrated uncertainty, and couples translation directly with debate-based oversight and planning.

Use cases include conservation scenarios where acoustic and visual signals from whales, dolphins, or elephants are automatically translated into human language for researchers; assistive contexts where a service dog's physiological and acoustic signals are recognized as distress cues and escalated to emergency services; and collaborative robotics where drones and ground robots subscribe to semantically grounded commands derived from animal or human intent. In each case, MFUT encoders and transformer 1700 and associated modules materially expand the platform's capacity to interpret and act upon heterogeneous communication signals in real time.

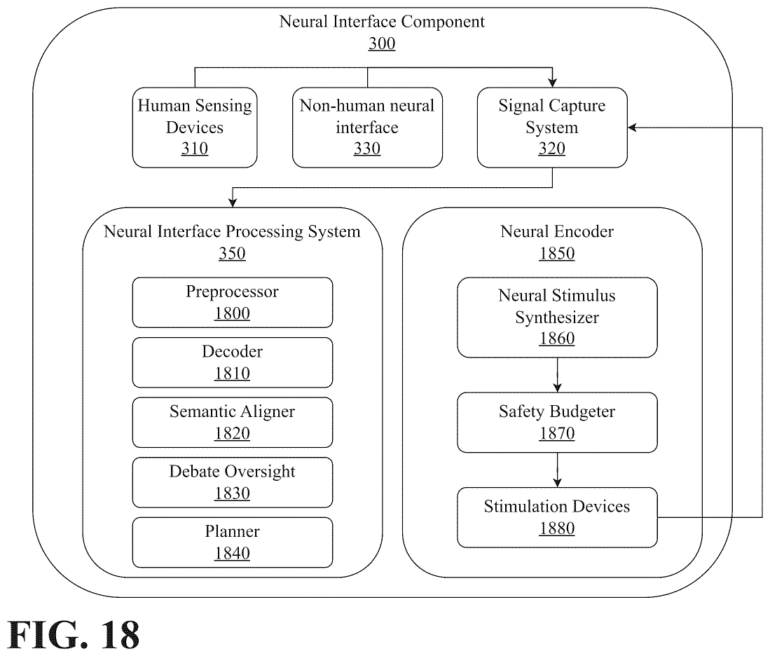

FIG. 18 is a block diagram illustrating an expanded neural interface component with real-time bidirectional neural input and output. Neural interface component 300 operates to acquire neural signals from humans and non-human animals, decode them into a universal semantic embedding, and deliver safe closed-loop stimulation that conveys meanings and commands back into nervous systems.

Neural interface component 300 includes human sensing devices 310, a signal capture system 320, and a non-human neural interface 330. These elements acquire multimodal electrophysiological and physiological signals such as EEG, ECoG, implant recordings, tattoo electrodes, peripheral biosignals, and motion traces.

Captured signals are processed by a neural interface processing system 350. Within the neural interface processing system 350, a preprocessor 1800 removes artifacts, detects spikes, and extracts time-frequency features from the acquired signals. Outputs of preprocessor 1800 are provided to a decoder 1810, which estimates latent neural states using models such as linear-nonlinear Poisson models, state-space decoders, or conformer architectures. Decoder 1810 projects decoded states into a semantic aligner 1820, which maps neural activity into the universal embedding shared with other modalities, enabling direct comparison of neural representations to acoustic, visual, or textual signals.

Semantic aligner 1820 passes candidate meanings and associated uncertainty estimates to a debate oversight 1830. Debate oversight 1830 conducts evidence-based adjudication across multiple decoding strategies or modalities and filters unsafe or low-confidence interpretations. Accepted interpretations are delivered to a planner 1840, which generates downstream action hypotheses and coordinates with tree search mechanisms and orchestration modules in the broader system.

To enable bidirectional communication, the neural interface component 300 further includes a neural encoder 1850 that prepares target latent states corresponding to meanings or commands selected by planner 1840. Neural encoder 1850 provides parameters to a neural stimulus synthesizer 1860, which compiles stimulation programs specifying electrode sets, temporal envelopes, or carrier modalities such as electrical, ultrasound, magnetic, or haptic outputs. The stimulation programs are evaluated by a safety budgeter 1870 that enforces charge, thermal, and duty-cycle limits to guarantee subject well-being. Validated programs are executed by stimulation devices 1880, which deliver patterned signals back to neural or peripheral tissue.

Stimulation responses are monitored in closed loop, with feedback routed from stimulation devices 1880 back into preprocessor 1800. This feedback ensures that evoked neural activity converges toward the intended target state and allows real-time adjustment of stimulation parameters.

The embodiment extends the baseline neural interface component 300 by introducing the preprocessor 1800, decoder 1810, semantic aligner 1820, debate oversight 1830, planner 1840, neural encoder 1850, neural stimulus synthesizer 1860, safety budgeter 1870, and stimulation devices 1880. Together, these components transform the neural interface from a one-way decoding channel into a bidirectional system capable of both reading and writing semantically grounded signals.

Use cases include assistive settings where service animals communicate distress states directly to emergency systems, conservation deployments where dolphins equipped with epidermal sensors receive cooperative task cues via safe ultrasonic pulses, and research environments where closed-loop neural stimulation facilitates controlled studies of cross-species negotiation. The real-time bidirectional neural input and output disclosed in this embodiment enables rich interspecies dialogue aligned to a shared semantic space while preserving safety, interpretability, and welfare constraints.

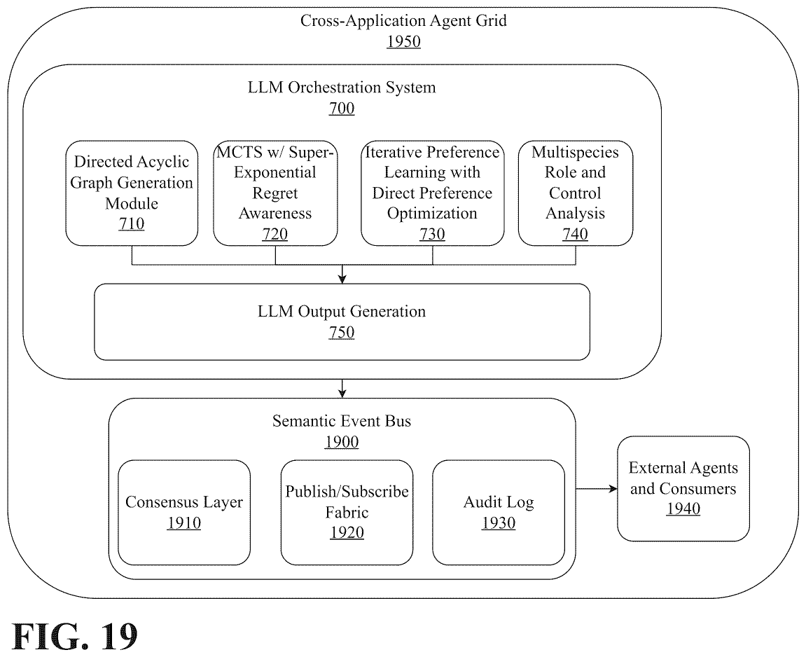

FIG. 19 is a block diagram illustrating an expanded LLM orchestration system with integration of a cross-application agent grid. The orchestration system 700 includes a directed acyclic graph generation module 710, which decomposes complex tasks into ordered sub-components. Outputs of directed acyclic graph generation module 710 are evaluated by a MCTS with super-exponential regret awareness 720, which explores decision branches while accounting for exploration-exploitation tradeoffs and pruning paths associated with poor evidential support. The orchestration system 700 further includes an iterative preference learning with direct preference optimization 730, which continuously refines policies based on feedback from human operators, non-human collaborators, or other agents.

Results are supplied to a multispecies role and control analysis 740, which assigns roles and responsibilities across humans, animals, and robotic agents according to situational demands. For example, in a field deployment, the multispecies role and control analysis 740 may assign aerial drones to surveillance, service dogs to search or alert behaviors, and human handlers to oversight functions, ensuring coordinated operation across heterogeneous collaborators. Outputs are synthesized by an LLM output generation 750, which formulates natural-language, symbolic, or multimodal messages that are consumable by downstream systems.

In this expanded embodiment, the orchestration system 700 is coupled with a semantic event bus 1900. Semantic event bus 1900 enables real-time exchange of translation events, debate outcomes, and policy decisions as schema-versioned, typed streams. Messages on the semantic event bus 1900 are processed by a consensus layer 1910, which merges interpretations from multiple agents using gossip-based eventual consistency or byzantine-fault-tolerant protocols for safety-critical actions. Events and decisions are recorded in an audit log 1930, which preserves provenance and supports replay for accountability and retraining. A publish/subscribe fabric 1920 routes events to subscribing agents based on declared filters and policies, ensuring that only relevant consumers receive particular classes of information.

Semantic event bus 1900, consensus layer 1910, publish/subscribe fabric 1920, and audit log 1930 together form a cross-application agent grid 1950. Cross-application agent grid 1950 exposes orchestration results to external agents and consumers 1940, which may include robotics platforms, ranger dashboards, research databases, or smart-home systems. These external agents and consumers 1940 can in turn issue tasks, subscribe to events, and participate in consensus protocols, thereby closing the loop between the LLM orchestration system 700 and a distributed multi-agent ecosystem.

The embodiment of expands the orchestration system 700 by embedding it within the cross-application agent grid 1950, enabling scalable interoperability across heterogeneous agents. Use cases include conservation operations where translation events are streamed in real time to ranger teams and autonomous vehicles, urban assistive contexts where service animals, home automation, and clinical dashboards synchronize via publish/subscribe channels, and safety-critical deployments where byzantine-fault-tolerant consensus ensures that only validated interpretations can trigger public alerts or robotic interventions. By integrating semantic event bus 1900 and associated components, the orchestration system 700 becomes a first-class node in a resilient, auditable, and distributed interspecies collaboration fabric.

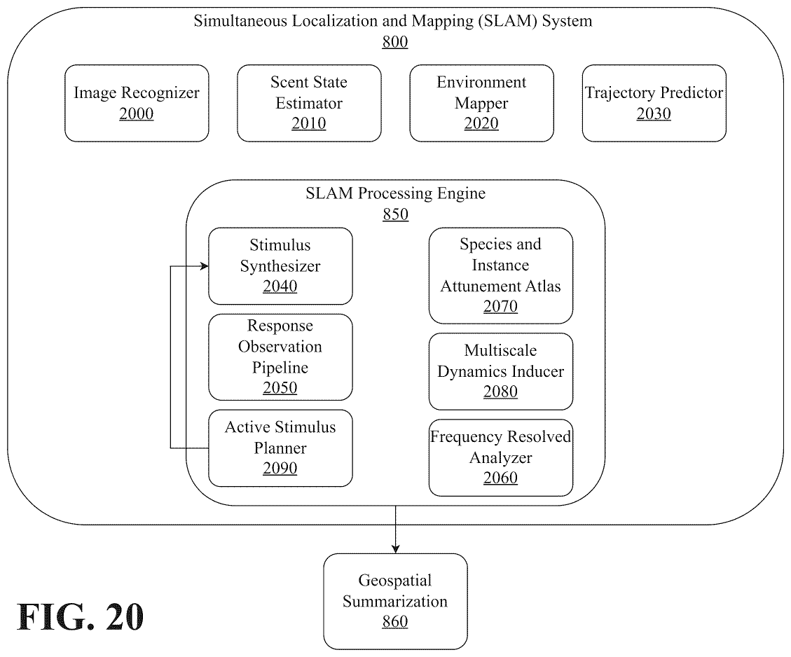

FIG. 20 is a block diagram illustrating an expanded simultaneous localization and mapping (SLAM) system with stimulus-resolved world-model reinforcement learning. In one embodiment, SLAM system 800 extends baseline localization, mapping, and trajectory prediction with active probing, frequency-resolved analysis, and species-specific world-model construction. SLAM system 800 includes a SLAM processing engine 850 that integrates geospatial and perceptual inputs. A geospatial summarization 860 compiles spatial features from diverse sensor modalities to maintain a coherent environmental representation. An image recognizer 2000 identifies landmarks, objects, and agents within the scene, while a scent state estimator 2010 incorporates olfactory or chemical cues to enrich the state map. An environment mapper 2020 constructs a spatial map of obstacles, affordances, and habitat features, while a trajectory predictor 2030 estimates likely movement paths of animals, humans, or robots.

In this expanded embodiment, the SLAM processing engine 850 is further coupled with a stimulus synthesizer 2040. Stimulus synthesizer 2040 generates auditory, visual, olfactory, or haptic probe patterns designed to evoke measurable responses from humans, animals, or robotic agents. Outputs of stimulus synthesizer 2040 are monitored by a response observation pipeline 2050, which synchronizes multi-modal sensor streams and extracts time-locked responses to the delivered stimuli.

Signals from the response observation pipeline 2050 are processed by a frequency resolved analyzer 2060, which applies generalized eigendecomposition and cross-frequency coupling analysis to isolate network-level dynamics associated with attention, arousal, or communicative intent. Frequency resolved analyzer 2060 supports identification of species-specific resonances, such as rhythmic auditory frequencies that bias macaques toward exploration rather than ransom behaviors, or cross-frequency coupling windows that indicate heightened coordination in cetaceans.

Outputs of the frequency resolved analyzer 2060 are recorded in a species and instance attunement atlas 2070. Species and instance attunement atlas 2070 stores frequency signatures, behavioral responses, and developmental profiles keyed to individuals and species, enabling personalized interpretation and calibration. For example, when a service dog responds to a vibrotactile probe with consistent heart-rate and vocalization changes, species and instance attunement atlas 2070 records the signature as a personalized marker for distress signaling.

Species and instance attunement atlas 2070 informs a multiscale dynamics inducer 2080, which discovers macro-scale models from micro-episode data using partial-differential equation discovery. Multiscale dynamics inducer 2080 generates predictive fields describing how responses propagate through groups or across environments, such as how an alarm call spreads spatially through a flock or pod.

A closed loop is maintained through an active stimulus planner 2090. Active stimulus planner 2090 uses reinforcement learning to select the next stimulus patterns based on information gain, model uncertainty, and welfare constraints. Active stimulus planner 2090 refines calibration efficiently, minimizing probing while maximizing insight into species- and instance-specific dynamics.

The embodiment expands the baseline SLAM system 800 by adding the stimulus synthesizer 2040, response observation pipeline 2050, frequency resolved analyzer 2060, species and instance attunement atlas 2070, multiscale dynamics inducer 2080, and active stimulus planner 2090. Together, these components transform SLAM from a passive mapping engine into an active, closed-loop system that probes, measures, and models interspecies responses in real time.

Use cases include marine deployments where underwater probes elicit group cohesion signals in cetaceans to update maps of pod dynamics, terrestrial conservation settings where avian alarm responses are probed to localize predators, and assistive scenarios where domestic animals are calibrated with non-invasive stimuli to communicate distress or cooperative intent. In each example, the integration of the new components into the SLAM processing engine 850 enables stimulus-resolved world-model learning that augments navigation, coordination, and safety across humans, animals, and robots.

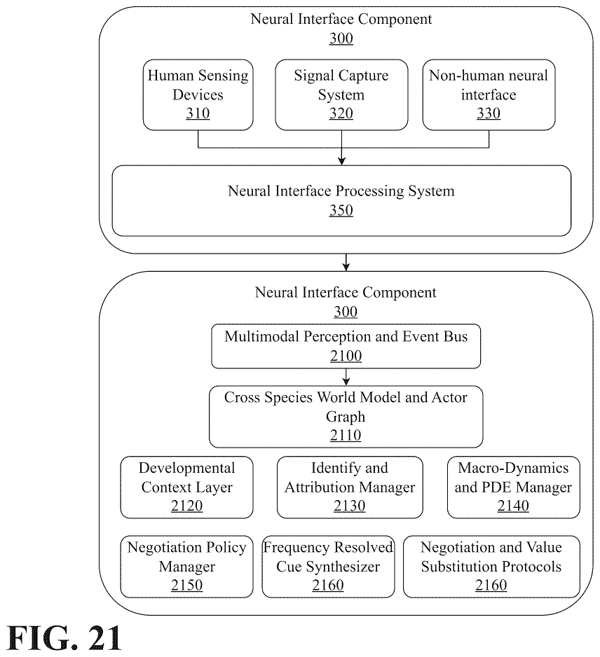

FIG. 21 is a block diagram illustrating an expanded neural interface component with integration of a behavioral economy interdiction and negotiation system (BE-INS).

Neural interface component 300, which includes human sensing devices 310, a signal capture system 320, a non-human neural interface 330, and a neural interface processing system 350, is extended to address opportunistic barter-theft behaviors observed in multi-agent animal populations.

In this expanded embodiment, neural interface component 300 is coupled with a multimodal perception and event bus 2100. Multimodal perception and event bus 2100 aggregates synchronized inputs from perimeter sensors, including cameras, microphones, depth sensors, and wireless sniffers, and publishes structured event packets with provenance for downstream analysis.

Multimodal perception and event bus 2100 supplies data to a cross species world model and actor graph 2110. Cross species world model and actor graph 2110 maintains nodes representing individual animals, coalitions, humans, and valuable objects, with edges annotated by interactions such as snatch, ransom, and exchange. Cross species world model and actor graph 2110 supports estimation of economic value functions and coalition risk dynamics.

To support context-sensitive analysis, the system further includes a developmental context layer 2120. Developmental context layer 2120 parameterizes decoding strategies based on age, sex, and social role, such that juvenile agents are modeled with short timescale features, while adults are modeled with longer horizon semantic constructs.

Identification of individual actors is performed by an identity and attribution manager 2130. Identity and attribution manager 2130 uses vocal stylometry and perplexity-based attribution to tag individual animals from short call motifs and micro-gestures, enabling accurate recognition of repeat offenders or coalition leaders without requiring collars or markers.

Outputs of the cross species world model and actor graph 2110 are further analyzed by a macro-dynamics and PDE manager 2140. Macro-dynamics and PDE manager 2140 discovers mesoscale field equations governing the propagation of theft strategies through space and time, enabling forecasting of risk hotspots and evaluation of counterfactual interventions.

Policy control is exercised by a negotiation policy manager 2150. Negotiation policy manager 2150 computes counter-strategies including deterrence, redemption, value substitution, and skill transfer, subject to ethical and welfare constraints. When imminent theft is detected, negotiation policy manager 2150 can recommend pre-emptive exchanges, handler guidance, or conservative de-escalation actions.

To deliver safe closed-loop interventions, system includes a frequency resolved cue synthesizer 2160. Frequency resolved cue synthesizer 2160 emits auditory click trains, rhythmic light cues, or vibrotactile pulses phase-locked to attentional rhythms. By biasing attention away from theft planning networks toward neutral foraging or exploration states, frequency resolved cue synthesizer 2160 mitigates ransom escalation without harm.

Negotiation policy manager 2150 also interacts with negotiation and value substitution protocols 2170. Negotiation and value substitution protocols 2170 compute exchange rates between high-value human possessions and low-risk animal rewards, enabling structured redemption and pre-emptive substitution to reduce loss and reinforce prosocial strategies.

The embodiment of expands the neural interface component 300 by introducing the multimodal perception and event bus 2100, cross species world model and actor graph 2110, developmental context layer 2120, identity and attribution manager 2130, macro-dynamics and PDE manager 2140, negotiation policy manager 2150, frequency resolved cue synthesizer 2160, and negotiation and value substitution protocols 2170. Together these components transform the baseline neural interface into a behavioral economy control system that predicts, prevents, and negotiates theft behaviors in multi-agent animal societies.

Use cases include deployment at tourist sites where macaques ransom personal objects for food, conservation areas where opportunistic corvids engage in object exchange, or urban settings where raccoons exhibit coalition raiding. In each case, the additional components operate with safety and ethical guardrails to redirect maladaptive strategies into cooperative exchanges while preserving welfare and ecological balance.

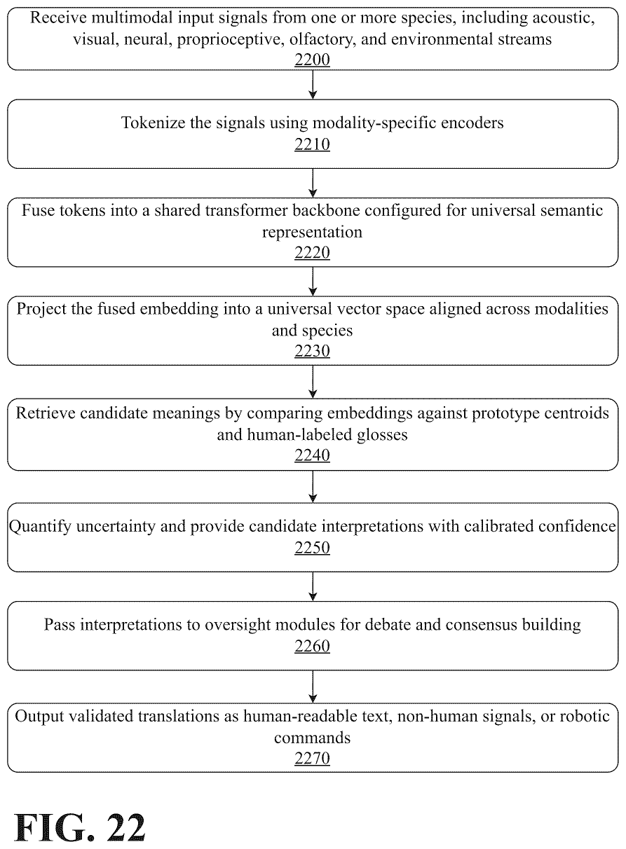

FIG. 22 is a flow diagram illustrating an exemplary method for multimodal universal translation across species and modalities. In a first step 2200, multimodal input signals are received from one or more species. These signals can include acoustic emissions such as calls or clicks, visual cues such as gestures or postures, neural activity traces, proprioceptive data from motion or balance, olfactory or chemical gradients, and environmental context. Collecting diverse input streams ensures that subtle communicative and behavioral information is captured across multiple sensory channels.

In a step 2210, the signals are tokenized using modality-specific encoders. Each raw input is transformed into a structured sequence of units suitable for further processing, such as acoustic frames, visual patches, or discretized neural states. Tokenization provides a common formatting that enables heterogeneous signals to be aligned and compared, while preserving the distinct features of each modality.

In a step 2220, the tokens are fused into a shared backbone configured for universal semantic representation. Multiple input modalities are aligned in a joint latent space where relationships between signals can be learned. By combining modalities into one representation, information from vision, sound, and physiology can reinforce each other and resolve ambiguities.

In a step 2230, the fused embedding is projected into a universal vector space aligned across modalities and species. Within this space, communicative acts from different animals, humans, or artificial agents can be represented as points that preserve semantic meaning. Aligning signals into a universal space allows comparison of signals even when the source species or modality has not been previously observed.

In a step 2240, candidate meanings are retrieved by comparing embeddings against prototype centroids and human-labeled glosses. The universal space is searched for the nearest semantic neighbors of the input signal, yielding potential interpretations such as “alarm,” “play,” or “food discovery.” Prototypes may be derived from both labeled data and unsupervised clustering, enabling the retrieval process to generalize beyond explicitly trained categories.

In a step 2250, uncertainty is quantified and candidate interpretations are provided with calibrated confidence. Probability distributions, confidence intervals, or other statistical measures are assigned to each interpretation so that end users or downstream processes understand the reliability of the translation. Explicit uncertainty measures help prevent over-commitment to incorrect interpretations and support safer decision-making.

In a step 2260, interpretations are passed to oversight modules for debate and consensus building. Multiple evaluators or reasoning agents can argue for or against candidate meanings using the available evidence. Consensus methods reconcile competing viewpoints, filter out low-confidence options, and surface the interpretations best supported by the data.

In a step 2270, validated translations are output as human-readable text, non-human signals, or robotic commands. Outputs may include natural language descriptions, synthetic vocalizations or gestures targeted back to animals, or task instructions sent to autonomous platforms. Delivering translations in appropriate formats closes the communication loop and enables collaborative action across species and machines.

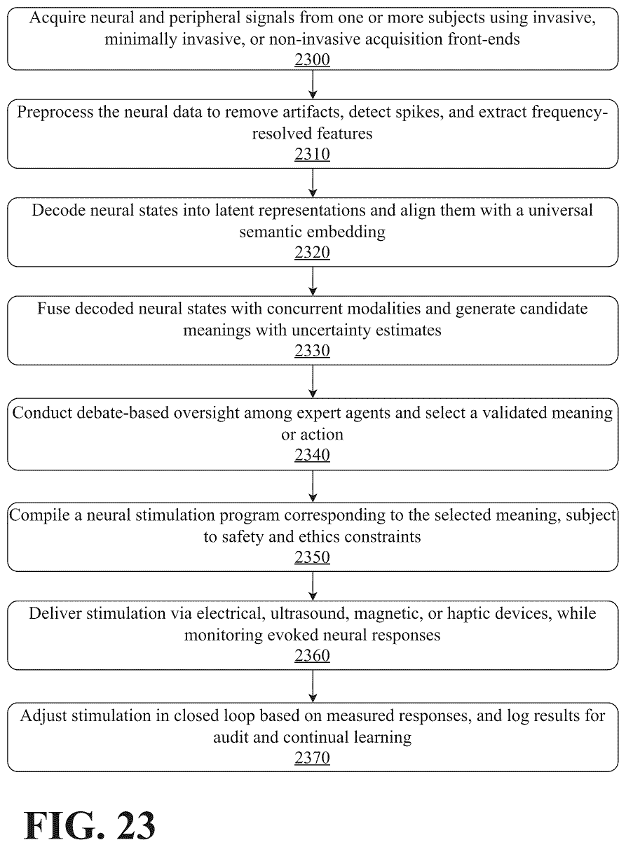

FIG. 23 is a flow diagram illustrating an exemplary method for real-time bidirectional neural input and output. In a first step 2300, neural and peripheral signals are acquired from one or more subjects using invasive, minimally invasive, or non-invasive acquisition techniques. These may include implantable electrode arrays, subdural grids, surface EEG electrodes, wearable sensors, or peripheral monitors that capture heart rate, muscle activity, or movement. Gathering neural and physiological signals across modalities ensures that both central and peripheral indicators of state and intention are available for interpretation.

In a step 2310, the neural data are preprocessed to remove artifacts, detect spikes, and extract frequency-resolved features. This may involve filtering line noise, eliminating motion or stimulation artifacts, and applying spectral decomposition to isolate frequency bands of interest. Spike trains, local field potentials, or frequency power changes are identified so that the resulting data reflect true underlying neural activity rather than environmental or equipment noise.

In a step 2320, neural states are decoded into latent representations and aligned with a universal semantic embedding. Statistical and machine learning models transform raw neural signals into higher-level features that capture intention, affect, or communicative content. These features are projected into a shared space where they can be directly compared with other modalities, such as acoustic or visual signals, enabling multimodal semantic integration.

In a step 2330, decoded neural states are fused with concurrent modalities and used to generate candidate meanings with uncertainty estimates. For example, neural patterns indicating distress may be combined with acoustic whines or posture changes to increase confidence in the interpretation. Explicit uncertainty estimates ensure that ambiguous or conflicting evidence can be recognized and managed appropriately.

In a step 2340, debate-based oversight is conducted among expert evaluators to adjudicate candidate meanings and select a validated meaning or action. Competing interpretations are weighed according to evidential support, with consensus processes filtering out unsafe or low-confidence outcomes. This ensures that any meaning or command derived from neural activity has undergone deliberation and justification before use.

In a step 2350, a neural stimulation program is compiled corresponding to the selected meaning, subject to safety and ethics constraints. Stimulation parameters are determined to evoke neural states that align with intended meanings, such as conveying acknowledgment or issuing a task command, while enforcing safety limits on charge, duty cycle, and exposure levels.

In a step 2360, stimulation is delivered via electrical, ultrasound, magnetic, or haptic devices while monitoring evoked neural responses. The stimulation program is executed in real time, and sensors track the subject's neural and physiological reactions to ensure that responses are consistent with intended effects.

In a step 2370, stimulation is adjusted in closed loop based on measured responses, and results are logged for audit and continual learning. If the evoked state deviates from the intended target, stimulation parameters are modified dynamically. All events, responses, and outcomes are recorded to refine models over time and to provide accountability for safety and welfare.

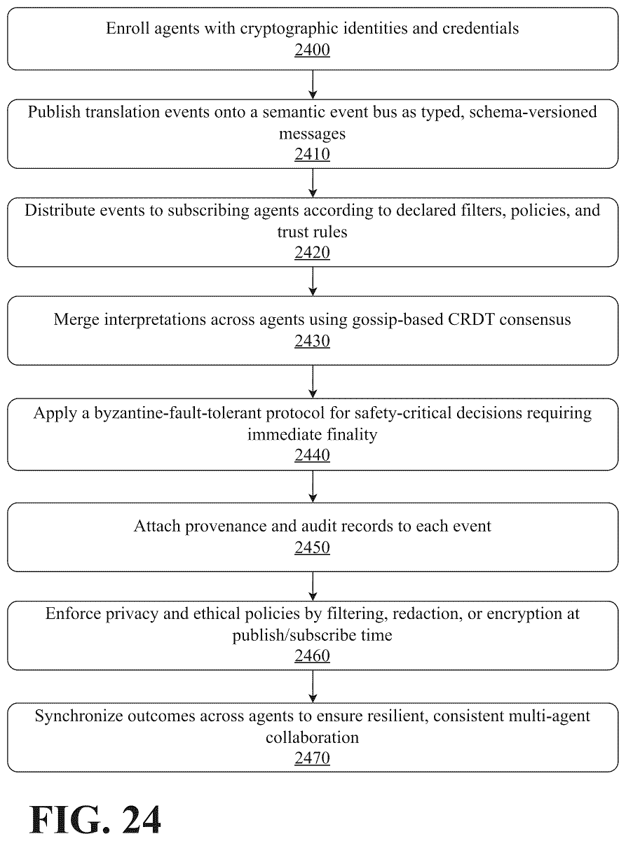

FIG. 24 is a flow diagram illustrating an exemplary method for distributed agent collaboration using a cross-application grid. In a first step 2400, agents are enrolled with cryptographic identities and credentials. Each participating entity, whether human-facing software, robotic platform, or external service, is provisioned with secure identifiers and authorization records. This establishes trust relationships and ensures that only authenticated and approved agents can participate in the collaboration framework.

In a step 2410, translation events are published onto a semantic event bus as typed, schema-versioned messages. Each event is formatted according to a shared ontology, including metadata such as source, time, and modality. Schema versioning ensures forward compatibility so that agents operating with different generations of software can still process the messages accurately.

In a step 2420, events are distributed to subscribing agents according to declared filters, policies, and trust rules. Agents may subscribe to specific species, event types, or geographic regions, and policy rules ensure that sensitive or restricted information is only delivered to authorized consumers. This selective routing allows efficient use of bandwidth and compliance with regulatory or ethical constraints.

In a step 2430, interpretations are merged across agents using gossip-based conflict-free replicated data type (CRDT) consensus. Each agent shares its observations and interpretations with peers in a decentralized manner, and CRDT structures ensure that the resulting global state converges consistently despite network delays or intermittent connectivity. This allows interpretations from multiple sources to be combined into a unified, resilient view of events.

In a step 2440, a byzantine-fault-tolerant protocol is applied for safety-critical decisions requiring immediate finality. When actions such as triggering alarms or initiating robotic interventions are at stake, a quorum of validator agents confirms the decision, protecting against errors or malicious actors. This guarantees correctness even in adversarial or unreliable environments.

In a step 2450, provenance and audit records are attached to each event. Events carry signatures, hash chains, or other cryptographic markers that preserve origin and modification history. These records enable post hoc review, forensic analysis, and regulatory compliance, while also providing evidence of accountability in collaborative contexts.

In a step 2460, privacy and ethical policies are enforced by filtering, redaction, or encryption at publish/subscribe time. Sensitive details, such as precise locations of endangered species or personally identifiable human data, can be withheld, generalized, or encrypted depending on policy requirements. This ensures that collaboration respects privacy and ethical constraints while still sharing actionable intelligence.

In a step 2470, outcomes are synchronized across agents to ensure resilient and consistent multi-agent collaboration. Consensus states, action decisions, and event interpretations are propagated across all participants, so that each agent maintains an aligned view of the shared environment. Synchronization guarantees that downstream actions are coordinated and consistent, enabling robust collaboration even under distributed and dynamic operating conditions.

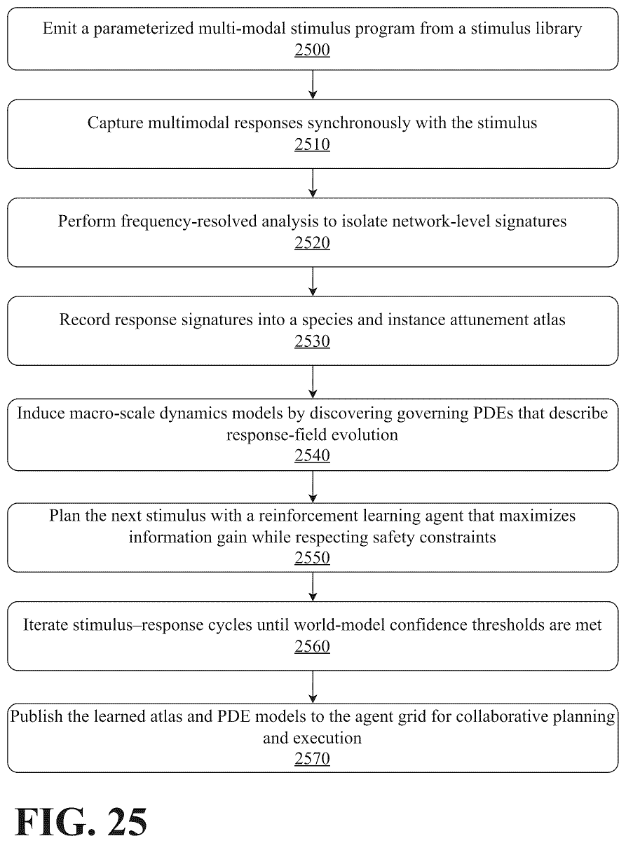

FIG. 25 is a flow diagram illustrating an exemplary method for stimulus-resolved world-model learning and reinforcement calibration. In a first step 2500, a parameterized multi-modal stimulus program is emitted from a stimulus library. Stimuli may include auditory click trains, visual flicker sequences, olfactory puffs, or haptic vibrations, and are configured with adjustable parameters such as frequency, duration, intensity, and timing. These structured probes are designed to elicit measurable responses that reveal underlying perceptual or neural dynamics.

In a step 2510, multimodal responses are captured synchronously with the stimulus. Acoustic recordings, video feeds, neural signals, biometric measurements, and motion trajectories are time-aligned with stimulus delivery. Synchronization ensures that responses can be attributed to specific probe events and analyzed in their temporal context.

In a step 2520, frequency-resolved analysis is performed to isolate network-level signatures. Computational methods such as spectral decomposition and cross-frequency coupling analysis identify oscillatory patterns and interactions that characterize attentional or behavioral states. These signatures provide a quantitative basis for mapping how individuals or species respond to controlled stimulation.

In a step 2530, response signatures are recorded into a species and instance attunement atlas. Each entry in the atlas links observed signatures to the species, individual identity, and context in which they were measured. The atlas accumulates structured knowledge of how different agents react to probes, enabling personalized calibration and comparative cross-species studies.

In a step 2540, macro-scale dynamics models are induced by discovering governing partial differential equations (PDEs) that describe response-field evolution. By analyzing how localized responses propagate through space and time, parsimonious equations are identified that predict collective behavior. These models capture how responses spread within groups, habitats, or communication networks.

In a step 2550, the next stimulus is planned with a reinforcement learning agent that maximizes information gain while respecting safety constraints. The planner evaluates possible probes, balancing exploration of uncertain dynamics with the requirement to minimize stress or risk to the subject. This closed-loop design accelerates learning while enforcing welfare boundaries.

In a step 2560, stimulus-response cycles are iterated until world-model confidence thresholds are met. Additional probing is conducted only as long as model accuracy continues to improve, preventing over-exposure to unnecessary stimuli. Once confidence criteria are satisfied, the model is considered sufficiently calibrated.

In a step 2570, the learned atlas and PDE models are published to the agent grid for collaborative planning and execution. Shared models allow distributed agents, researchers, or robotic platforms to incorporate validated response patterns into their decision-making. This dissemination ensures that knowledge gained through stimulus-resolved probing is broadly available for cross-species collaboration and planning.

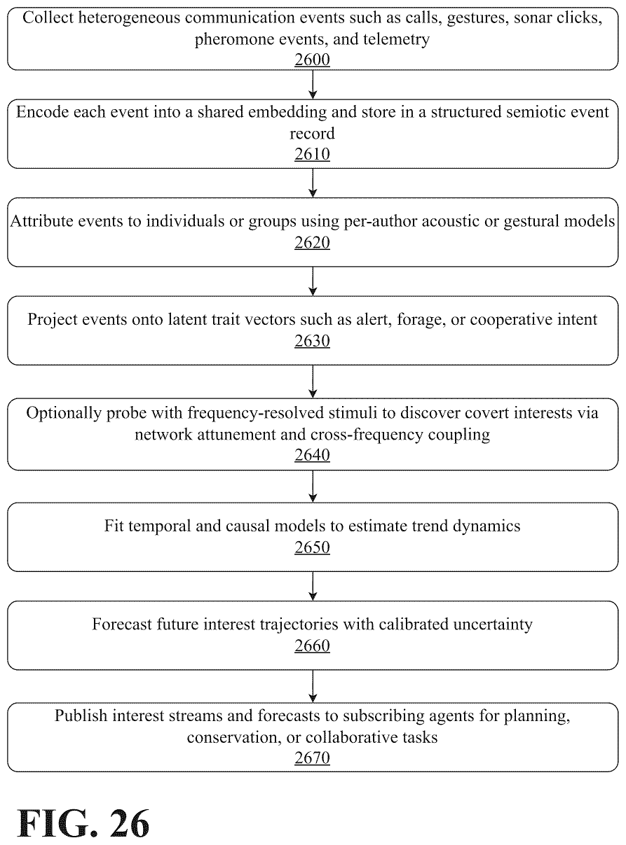

FIG. 26 is a flow diagram illustrating an exemplary method for longitudinal interest estimation across species and modalities. In a first step 2600, heterogeneous communication events are collected such as calls, gestures, sonar clicks, pheromone events, and telemetry. These raw observations capture diverse communicative acts and behavioral signals across different species and contexts, forming the foundation for trend and interest analysis.

In a step 2610, each event is encoded into a shared embedding and stored in a structured semiotic event record. The embedding represents the communicative act in a common latent space, enabling signals of different types and modalities to be directly compared. The structured event record preserves metadata such as time, location, and source context, ensuring traceability and interpretability.

In a step 2620, events are attributed to individuals or groups using per-author acoustic or gestural models. Attribution models are trained to recognize characteristic vocal patterns, gestural signatures, or other stylistic features that identify which individual or subgroup produced the event. This ensures that behavioral records are linked to the correct emitters, even in crowded or overlapping settings.

In a step 2630, events are projected onto latent trait vectors such as alert, forage, or cooperative intent. These trait directions provide interpretable axes in the embedding space that correspond to behavioral or motivational categories. Projection onto these directions enables monitoring of group or individual states over time, such as rising aggression, increasing cooperation, or shifting foraging focus.

In a step 2640, optional probing is performed with frequency-resolved stimuli to discover covert interests via network attunement and cross-frequency coupling. Controlled acoustic, visual, or tactile stimuli are presented, and frequency-resolved analysis reveals hidden interests or latent preferences that may not be expressed overtly in behavior. This probing enables weak supervision for labeling and categorization of interest states.

In a step 2650, temporal and causal models are fit to estimate trend dynamics. Methods such as point process modeling, state-space estimation, or causal graph inference capture how communication events evolve in time and how they are influenced by environmental drivers or social interactions. These models provide a structured understanding of how interests rise, spread, and dissipate within groups.

In a step 2660, forecasts of future interest trajectories are generated with calibrated uncertainty. Probabilistic forecasting methods quantify the confidence of predictions, ensuring that both the most likely trajectories and the degree of uncertainty are communicated. Forecasts can include short-term dynamics such as imminent alarm spread or long-term seasonal cycles of foraging or migration.

In a step 2670, interest streams and forecasts are published to subscribing agents for planning, conservation, or collaborative tasks. By sharing structured and forecasted interests, agents can anticipate needs, allocate resources, and coordinate actions across species and systems. This dissemination transforms raw communication events into actionable intelligence that supports long-term collaboration.

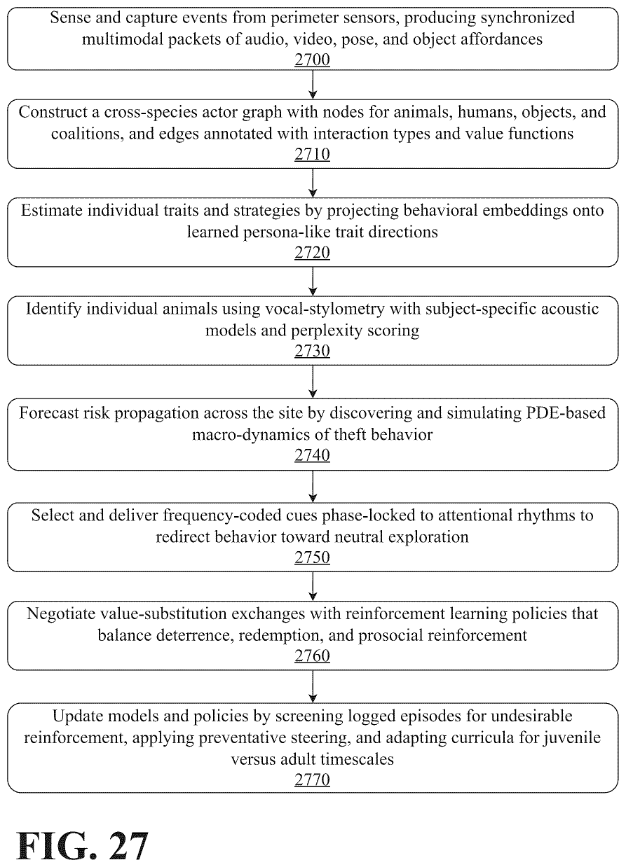

FIG. 27 is a flow diagram illustrating an exemplary method for behavioral economy interdiction and negotiation in opportunistic animal societies. In a first step 2700, events are sensed and captured from perimeter sensors, producing synchronized multimodal packets of audio, video, pose, and object affordances. These packets provide a unified description of interactions at a site, including both animal behaviors and their relation to human possessions or environmental features.

In a step 2710, a cross-species actor graph is constructed with nodes for animals, humans, objects, and coalitions, and edges annotated with interaction types and value functions. The actor graph captures the social and economic dynamics of the scene, including snatching, hoarding, or bargaining, and links them to the perceived value of the items involved.

In a step 2720, individual traits and strategies are estimated by projecting behavioral embeddings onto learned persona-like trait directions. These trait directions reflect strategies such as ransom-seeking, bluff escalation, or cooperative exchange, and enable real-time monitoring of which behavioral tendencies are emerging in a group.

In a step 2730, individual animals are identified using vocal-stylometry with subject-specific acoustic models and perplexity scoring. By analyzing unique patterns in vocalizations or call motifs, individuals can be distinguished without external tags, allowing attribution of behaviors to specific actors even under occlusion or group overlap.

In a step 2740, risk propagation across the site is forecast by discovering and simulating partial differential equation-based macro-dynamics of theft behavior. The equations describe how opportunistic behaviors spread across space and time, predicting hotspots of elevated risk and providing foresight for targeted interventions.

In a step 2750, frequency-coded cues are selected and delivered phase-locked to attentional rhythms to redirect behavior toward neutral exploration. Non-invasive auditory, visual, or vibrotactile signals are presented at frequencies shown to bias attention away from theft planning and toward benign behaviors such as foraging.

In a step 2760, value-substitution exchanges are negotiated with reinforcement learning policies that balance deterrence, redemption, and prosocial reinforcement. Exchanges involve substituting high-value items with low-risk rewards, shaping animals toward cooperative rather than adversarial interactions.

In a step 2770, models and policies are updated by screening logged episodes for undesirable reinforcement, applying preventative steering, and adapting curricula for juvenile versus adult timescales. This continuous updating ensures that strategies evolve safely and effectively, preventing inadvertent encouragement of maladaptive behaviors and tailoring interventions to developmental stage.

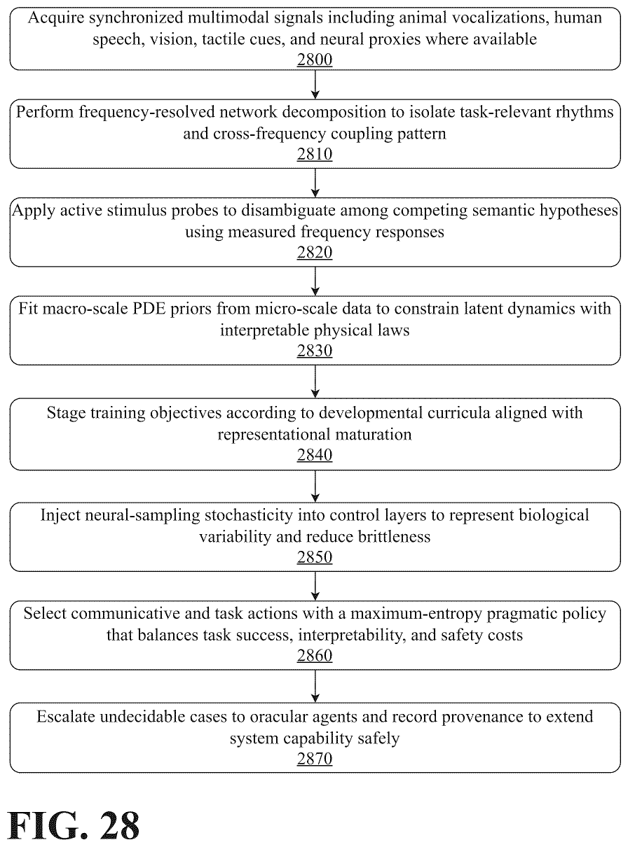

FIG. 28 is a flow diagram illustrating an exemplary method for bio-complexity-aware pragmatic world-modeling and planning. In a first step 2800, synchronized multimodal signals are acquired including animal vocalizations, human speech, vision, tactile cues, and neural proxies where available. Collecting signals across multiple sensory channels ensures that communicative acts and environmental interactions are represented with high fidelity and contextual richness.

In a step 2810, frequency-resolved network decomposition is performed to isolate task-relevant rhythms and cross-frequency coupling patterns. Analytical techniques decompose input signals into their constituent frequency components, revealing oscillatory dynamics and interactions that indicate underlying states such as attention, arousal, or semantic intent.

In a step 2820, active stimulus probes are applied to disambiguate among competing semantic hypotheses using measured frequency responses. Probes are chosen to selectively engage neural or behavioral circuits, and responses are monitored for distinguishing features. This interrogation resolves uncertainty by testing hypotheses directly against observable evidence.

In a step 2830, macro-scale partial differential equation priors are fit from micro-scale data to constrain latent dynamics with interpretable physical laws. Data from small-scale events or interactions are lifted into meso- or macro-scale models that follow mathematical forms such as diffusion or advection, providing transparent constraints on how system states evolve.

In a step 2840, training objectives are staged according to developmental curricula aligned with representational maturation. Training proceeds in phases that mirror natural representational trajectories, beginning with simple, short-timescale associations and advancing to more complex, long-timescale abstractions. This pacing improves learning efficiency and robustness.

In a step 2850, neural-sampling stochasticity is injected into control layers to represent biological variability and reduce brittleness. By modeling inherent unpredictability in biological processes, the method prevents overfitting to narrow patterns and improves generalization across contexts and individuals.

In a step 2860, communicative and task actions are selected with a maximum-entropy pragmatic policy that balances task success, interpretability, and safety costs. The policy seeks actions that achieve objectives while maintaining diversity, avoiding overcommitment, and ensuring safety and transparency.

In a step 2870, undecidable cases are escalated to oracular agents and provenance is recorded to extend capability safely. When evidence remains insufficient to resolve a decision, higher-level evaluators or human experts are consulted, and the escalation is documented so that system knowledge expands in a transparent, auditable manner.

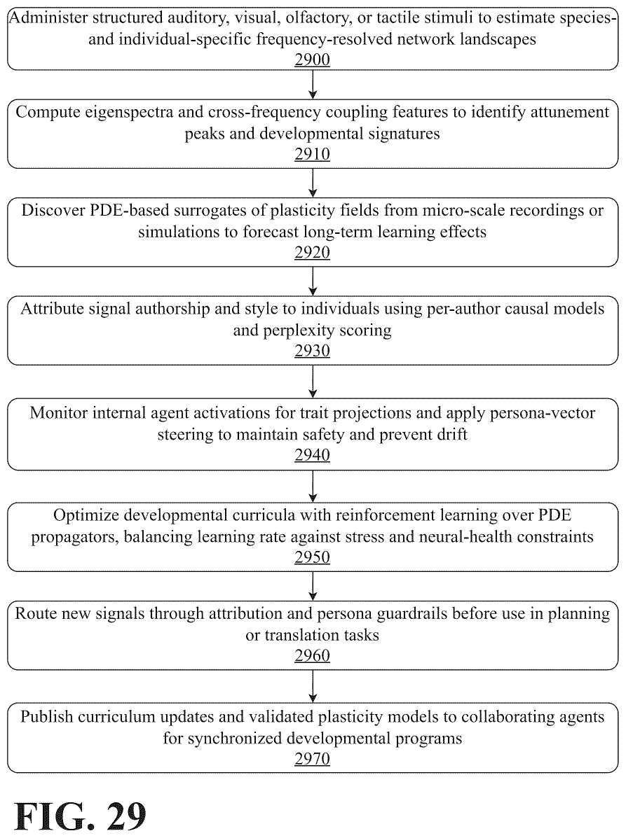

FIG. 29 is a flow diagram illustrating an exemplary method for frequency-persona curriculum learning and developmental co-optimization. In a first step 2900, structured auditory, visual, olfactory, or tactile stimuli are administered to estimate species- and individual-specific frequency-resolved network landscapes. Stimuli are selected to engage sensory and neural circuits in a controlled fashion, producing measurable responses that reveal characteristic frequency preferences and attunement patterns.

In a step 2910, eigenspectra and cross-frequency coupling features are computed to identify attunement peaks and developmental signatures. Analytical methods decompose responses into spectral components and quantify interactions between frequency bands, providing insight into how attention and communication capacities vary across age, context, or individual identity.

In a step 2920, partial differential equation-based surrogates of plasticity fields are discovered from micro-scale recordings or simulations to forecast long-term learning effects. Short-timescale neural or behavioral data are transformed into governing mathematical models that predict how plasticity and learning unfold over extended periods, ensuring foresight into developmental trajectories.

In a step 2930, signal authorship and style are attributed to individuals using per-author causal models and perplexity scoring. Individual differences in vocalizations, gestures, or response patterns are leveraged to identify unique emitters and to track continuity of learning and behavior across sessions.

In a step 2940, internal agent activations are monitored for trait projections and persona-vector steering is applied to maintain safety and prevent drift. By projecting activations onto interpretable trait directions, undesirable tendencies can be detected early, and steering interventions are applied to constrain training and inference within safe behavioral ranges.

In a step 2950, developmental curricula are optimized with reinforcement learning over PDE propagators, balancing learning rate against stress and neural-health constraints. Reinforcement learning agents simulate alternative curricula through PDE models and select schedules that maximize efficiency while maintaining welfare.

In a step 2960, new signals are routed through attribution and persona guardrails before use in planning or translation tasks. Identity verification and persona-safety screening ensure that only trustworthy and non-drifting data are used to influence downstream processes.

In a step 2970, curriculum updates and validated plasticity models are published to collaborating agents for synchronized developmental programs. Updates are shared with distributed collaborators to align learning, reinforce safe practices, and enable large-scale co-training across species, humans, and machines.

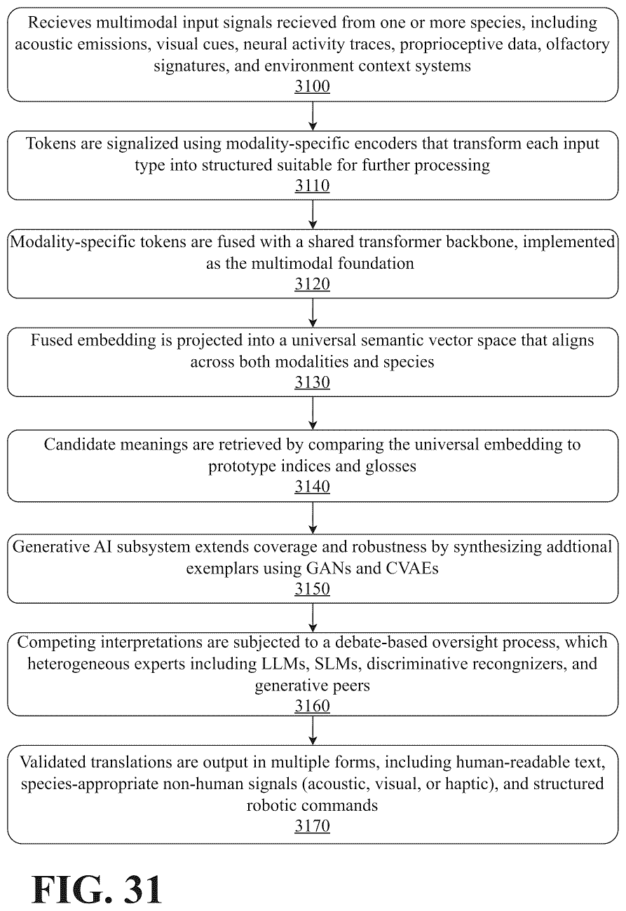

FIG. 31 is a flow diagram illustrating an exemplary method for multimodal integration with large language model (LLM) and non-LLM artificial intelligence models, according to one embodiment.

At step 3100 multimodal input signals are received from one or more species, including acoustic emissions, visual cues, neural activity traces, proprioceptive data, olfactory signatures, and environmental context streams.

At step 3110, the signals are tokenized using modality-specific encoders that transform each input type into structured sequences suitable for further processing.

At step 3120, the modality-specific tokens are fused within a shared transformer backbone, implemented as the multimodal foundation encoders and transformer, which yields a joint latent representation configured for universal semantic alignment.

At step 3130, the fused embedding is projected into a universal semantic vector space that aligns across both modalities and species, providing a canonical basis for downstream interpretation.

At step 3140, candidate meanings are retrieved by comparing the universal embedding to prototype indices and glosses, and at step 3150, a generative AI subsystem (246) extends coverage and robustness by synthesizing additional exemplars using generative adversarial networks (GANs), conditional variational autoencoders (CVAEs), and diffusion-based generative models conditioned on the semantic embedding and contextual vectors.

At step 3160, competing interpretations are subjected to a debate-based oversight process, in which heterogeneous experts—including LLMs, small language models (SLMs), discriminative recognizers, and generative peers—advance hypotheses that are arbitrated by a judge module to ensure correctness, coherence, and policy compliance.

Finally, at step 3170, validated translations are output in multiple forms, including human-readable text, species-appropriate non-human signals (acoustic, visual, or haptic), and structured robotic commands. This arrangement provides robust cross-modal grounding, enables counterfactual testing and augmentation, and closes the loop between multimodal interpretation and actionable outputs across humans, animals, and robotic agents.

To increase generative coverage and robustness generative AI subsystem (246) extends beyond adversarial and variational architectures to include diffusion-based generative models that act as peers in the expert pool. GANs (e.g., WaveGAN/InfoGAN/fiwGAN) and conditional variational autoencoders (CVAEs) are augmented with a conditional denoising diffusion process operating in the audio spectrotemporal domain for vocalizations and in pixel or radiance-field domains for visual scenes. These diffusion models are conditioned on the universal semantic embedding and, optionally, on explicit behavioral context vectors (e.g., social state, habitat acoustics, ambient noise). This arrangement enables synthesis of rare or safety-critical exemplars, such as endangered species' alarm codas under adverse conditions, with calibrated diversity. Training proceeds with a cosine noise schedule and classifier-free guidance on the semantic embedding, and decoding to waveform is performed by an inverse mel-spectrogram vocoder aligned to the hearing range of the target species. Synthetic outputs are then routed through the debate/oversight fabric for counterfactual testing and data augmentation, and curated samples that survive adversarial review are added to the training corpus and embeddings cache for amortized reuse in subsequent episodes.

The LLM orchestrator coordinates these specialists as a planning and tool-use executive. It constructs a directed acyclic graph (DAG) of reasoning steps, explores competing branches with an MCTS module tuned for super-exponential regret awareness, and refines policies via iterative preference learning with direct preference optimization. Outputs are synthesized by an LLM output generation module and distributed across a semantic event bus, with consensus, pub/sub routing, and audit logging to a cross-application agent grid. In effect, the LLM “brain” plans which experts to call (e.g., bioacoustic classifier, posture recognizer, biometrics anomaly detector, diffusion generator for hypothesis testing), sequences their execution on the DAG, and arbitrates their results with the debate subsystem.

Bidirectional multimodal generation closes the loop from human intent to species-appropriate outputs and machine actuation. After an interpretation is selected, the system associates the meaning with a human-readable gloss and/or a robot command via an additional translation stage; the same debate oversight can be applied to that stage before actuation. The multi-species output unit renders results across audio (including synthesized conspecific calls or ultrasonic pulses), visual, and haptic channels tailored to the perceptual limits of the target species. For example, a text-to-sound stack may map the universal semantic embedding into a parametric spectrogram synthesized by the diffusion decoder and vocoded to waveform. Outputs are band-limited and timbre-shaped for canids, or include narrowband click trains for odontocetes at species-typical inter-click intervals. Robot interfaces consume the same embedding to generate structured commands (e.g., ROS-compatible motion primitives), allowing animal and robotic collaborators to receive semantically equivalent cues through different modalities.

The debate-based oversight module provides principled arbitration across heterogeneous experts and acts as a generator-aware robustness harness. Multiple expert models (LLMs, SLMs, discriminative recognizers, and GAN/diffusion generators used adversarially) advance competing hypotheses; a judge agent scores alternatives using correctness, coherence, graph-consistency, and policy-compliance. The judge may also instruct generative experts to produce counterfactual probes—such as pitch-shifted codas, time-warped gestures, or noise-augmented inputs—to test stability of a proposed meaning under nuisance variation. Monte Carlo tree search consumes these scores to prune branches and re-rank nodes during streaming inference, thereby revising assumptions as new evidence arrives and converging with lower latency than naïve exhaustive search.

For pre-training and continual learning, the system incorporates an “animal-CLIP” style contrastive objective that aligns co-occurring acoustic segments, pose frames, scene context, and physiological cues into a shared latent space. During training, synchronized windows from multiple modalities are pulled together, while mismatched windows are pushed apart; the resulting “meaning vectors” function as canonical, species-agnostic representations consumed by the collaboration layer and LLM orchestrator. This universal alignment complements transformer-fusion embeddings and the prototype index used at inference for rapid retrieval of candidate meanings.

Integration with mapping and scene-understanding components further grounds the semantics in physical context. As the SLAM and geospatial summarization subsystems update the digital twin, the orchestrator re-scores affected DAG nodes and, when necessary, re-opens debates, propagating value changes through the search tree to yield revised interpretations and commands. This spatial grounding improves disambiguation—for example, biasing between “forage” and “alert” given trajectories and affordances—and ensures that outputs and robot maneuvers respect operational constraints such as geofences and standoff distances.

In edge-constrained deployments, SLM-only debate loops operate with cached prototypes and lightweight discriminators, deferring generator-augmented counterfactual analysis to the cloud when connectivity returns. Debate outcomes, expert traces, and validated synthetic exemplars are persisted in the embeddings cache to amortize future decisions. Thus, the disclosed arrangement of GANs, SLMs, and LLMs inside the oversight module, and their use for adversarial synthesis and robustness testing, is preserved in both edge and cloud modes, providing a uniform arbitration substrate across operating conditions.

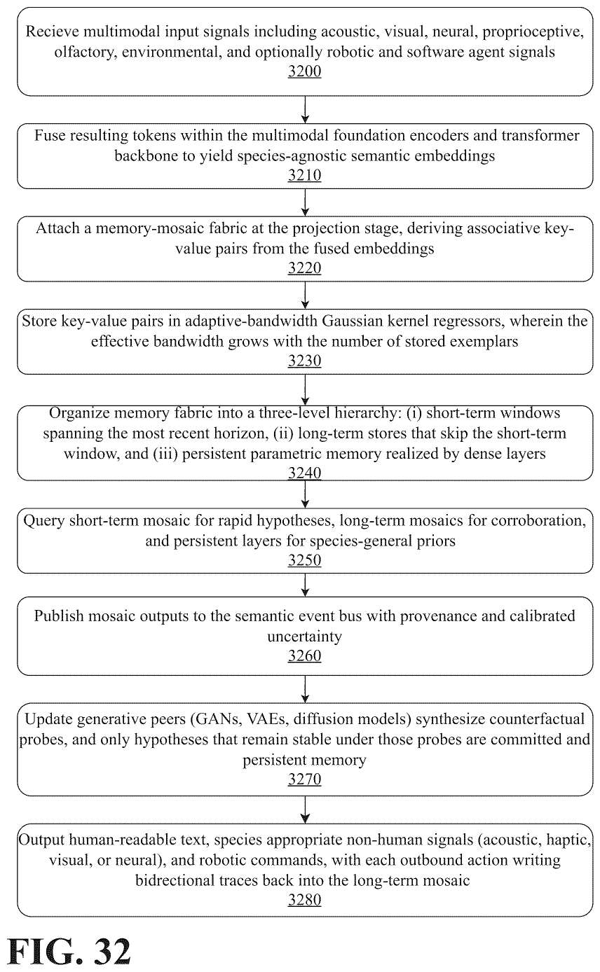

FIG. 32 is a flow diagram illustrating an exemplary method for memory-mosaic fabric integration into the multimodal orchestration system for cross-species communication and collaboration, according to one embodiment. At step 3200, multimodal input streams—including acoustic, visual, neural, proprioceptive, olfactory, environmental, and optionally robotic and software agent signals—are received and tokenized by modality-specific encoders.

At step 3210, the resulting tokens are fused within the multimodal foundation encoders and transformer backbone (MFUT) to yield species-agnostic semantic embeddings.

At step 3220, the system attaches a memory-mosaic fabric at the projection stage, deriving associative key-value pairs from the fused embeddings. Keys are generated through gated, time-variant extractors that mix current embeddings with exponentially weighted prefixes conditioned on state factors such as social context, ambient noise, or body posture, while values carry short-horizon predictions, latent meaning vectors, and execution traces suitable for downstream planning.

At step 3230, key-value pairs are stored in adaptive-bandwidth Gaussian kernel regressors, wherein the effective bandwidth grows with the number of stored exemplars to balance bias and variance. In one implementation, the bandwidth is scheduled as β=β₁n^{α}+β₀ with β₀, β₁>0 and 0<α<1, keys are normalized linear combinations of current and prior embeddings, and values follow analogous leaky updates toward anticipated near-future states. This yields stable interpolation when sparse and sharper discrimination when dense, while removing the need for explicit positional encoding.

At step 3240, the memory fabric organizes into a three-level hierarchy: (i) short-term windows spanning the most recent horizon (e.g., last 256 tokens), (ii) long-term stores that skip the short-term window to retain episodic evidence, and (iii) persistent parametric memory realized by dense layers for task-invariant priors.

At step 3250, during inference the LLM-orchestrated DAG/MCTS planner queries short-term mosaics for rapid hypotheses, long-term mosaics for corroboration, and persistent layers for species-general priors. Candidate meanings retrieved from the mosaics are reconciled with prototype centroids and glosses before debate-based adjudication.

At step 3260, mosaic outputs are published to the semantic event bus with provenance and calibrated uncertainty; the consensus layer merges distributed readings from collars, drones, hydrophones, or base stations via gossip-based CRDT protocols and finalizes safety-critical outputs with byzantine-tolerant consensus.

At step 3270, updates are applied to the mosaics: generative peers (GANs, VAEs, diffusion models) synthesize counterfactual probes, and only hypotheses that remain stable under those probes are committed to persistent memory. Write-backs are tagged with curriculum metadata to guide developmental context modules and macro-dynamics models, ensuring robustness against brittle behaviors.

Finally, at step 3280, validated outputs are emitted as human-readable text, species-appropriate non-human signals (acoustic, haptic, visual, or neural), and robotic commands, with each outbound action writing bidirectional traces back into the long-term mosaic (including key neighborhoods, selected DAG edges, stimulus parameters, and observed responses). This ensures auditable records and enables rapid in-context adaptation. The federated memory-mosaic design allows edge shards to maintain bounded footprints, emit privacy-preserving sketches, and synchronize through the event bus while remaining auditable and policy-constrained. The result is a distributed memory operating system that scales across agents and timescales, enabling robust, explainable, and continuously improving cross-species orchestration.

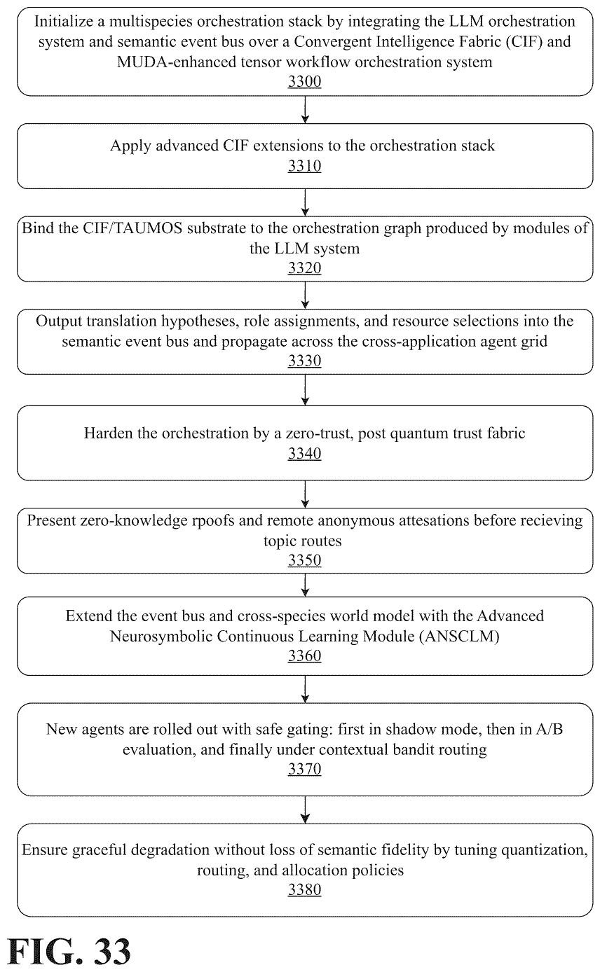

FIG. 33 is a flow diagram illustrating an exemplary method for the CIF/TAUMOS-orchestrated cross-species multimodal integration, according to one embodiment.

At step 3300, the multispecies orchestration stack described for system is initialized by integrating the LLM orchestration system and semantic event bus over a Convergent Intelligence Fabric and a MUDA-enhanced tensor workflow orchestration system. At step 3310, the orchestration stack applies an advanced CIF extensions layer comprising: (i) a quantum-resistant asynchronous multi-domain trust establishment protocol, (ii) a heterogeneous dynamic neural architecture search controller, (iii) a differential tensor coherence protocol, (iv) a neuromorphic-accelerated sparse attention integration layer, (v) a non-linear embedding alignment and rectification framework, and (vi) an intelligent graph-based scheduler.

At step 3320, the CIF/TAUMOS substrate binds these components to the orchestration graph produced by modules of the LLM system.

At step 3330, orchestration outputs such as translation hypotheses, role assignments, and resource selections flow into the semantic event bus and propagate across the cross-application agent grid, while CIF/TAUMOS ensures secure transport, dynamic model and hardware selection, and precision-aware consistency across distributed animal, robotic, human, and software agents.

At step 3340, the orchestration is hardened by a zero-trust, post-quantum trust fabric. The semantic event bus is coupled to QAMDTEP to enforce quantum-resistant, lattice-based commitments. At step 3350, every publisher/subscriber—whether a canine collar, marine robot, welfare monitor, or LLM proxy—must present zero-knowledge proofs and remote anonymous attestations before receiving topic routes. This delayed revelation mechanism enables asynchronous trust accumulation, which is particularly useful for low-duty-cycle edge devices such as wildlife tags. The audit log further binds provenance to privacy-preserving hierarchical credentials (PHCs), enabling verifiable replay, least-privilege scopes, and safety-critical quorum topics for robotic actuation.

At step 3360, the orchestration stack extends the event bus and cross-species world model with the Advanced Neuro-Symbolic Continuous Learning Module (ANSCLM). ANSCLM integrates dual-process cognition: System-1 neural transformers with adaptive attention for rapid pattern recognition, and System-2 symbolic probabilistic reasoning for structured inference. A Dynamic Neural-Symbolic Knowledge Transfer Engine (DNSKTE) mediates between the two, allowing symbolic concepts (e.g., “group alarm→east corridor”) to persist while neural pathways adapt to new individuals, habitats, and sensors without catastrophic forgetting. Negotiation Policy Manager 2150 consumes this enriched graph to generate cross-species proposals that can be explained by LLM 242 in human-readable terms and compiled into animal- or robot-appropriate signals. When telemetry indicates a capability gap (such as regret in decoding novel infrasound motifs or a new olfactory cue), an Agent Genesis and Registration pipeline is triggered. AGR issues a spawn ticket, generates a candidate specialist using parameter-efficient fine-tuning (PEFT), subgraph encapsulation, or simulator-backed training, and packages it into an Agent Capsule. Each capsule carries an Agent Capability Contract specifying I/O schemas, pre- and post-conditions, latency/compute envelopes, enclave/privacy requirements, and fallback policies.

At step 3370, new agents are rolled out with safe gating: first in shadow mode, then in A/B evaluation, and finally under contextual bandit routing (e.g., Thompson sampling) where probabilities are conditioned on cohort signature, latency, and safety flags. Policy compliance checks enforce capsule constraints, and violations trigger immediate fallback. Compute, memory, and attention paths are optimized for specific habitats and devices. HDNAS selects neural architectures tailored to workload and hardware profiles (e.g., spiking-friendly attention kernels on neuromorphic coprocessors for acoustic vigilance). DTCP maintains tensor coherence across distributed nodes with bounded precision updates, NASAIL offloads sparse attention to neuromorphic arrays, NEARF rectifies embeddings from heterogeneous modalities, and GISESTO dynamically schedules these kernels into the global DAG. The SLAM system is extended with a stimulus synthesizer, frequency analyzer, attunement atlas, and active stimulus planner. Safe probes are crafted to elicit disambiguating responses, which are fused into a digital twin representation consumed by the LLM orchestration system. The planner executes orchestration in-the-loop: generating DAG expansions, exploring branches with MCTS enhanced for super-exponential regret awareness, refining policies with direct preference optimization, and allocating multispecies roles. Outputs are synthesized by LLM output generation into textual, symbolic, animal-appropriate, and robotic signals. Validated outputs are published under consensus gating onto the event bus and grid, and delivered as human-readable text, animal signals, or robotic commands. All all provenance, decisions, and safety envelopes are recorded by the audit system and by quantum-resistant secure enclaves, with PHCs ensuring replay, verification, and regulatory alignment.

Finally, at step 3380, a precision-adaptive memory controller and neural fabric controller tune quantization, routing, and allocation policies to maintain portability across habitats and devices, ensuring graceful degradation without loss of semantic fidelity.

Through these stages, the CIF/TAUMOS embodiment provides a secure, zero-trust, neurosymbolic, and dynamically extensible orchestration substrate, enabling real-time, explainable, and auditable collaboration across animals, humans, robots, and software agents.

In an embodiment, a Convergent Intelligence Fabric (CIF) operates in concert with Adaptive Elastic Funnel (AEF) capabilities to yield a context-specific, modular skill system that can reason, plan, and coordinate across humans, robots, non-human animals, AI agents, and software services. The CIF/AEF synthesis provides (i) self-learning orchestration over a universal multi-modal key-value (KV) subsystem, (ii) disaggregated, policy-preserving pipelines with cache fusion, and (iii) an operational substrate for secure delegation and resource governance. The AEF contributes scenario intelligence and interpretable decision logic, while CIF supplies orchestration primitives and memory; together they create a multi-level optimization and collaboration layer with reinforcement-learning-driven allocation, hierarchical search, and privacy-preserving sharing of intermediate results.

At the input/orchestration tier, mixed-modal context—including animal neural or behavioral state, human instructions, and robotic telemetry—is ingested by the LLM-orchestration stack. The orchestration stack constructs a reasoning DAG with explicit modules for DAG generation, Monte-Carlo-style candidate expansions, and regret-aware search control. This DAG provides the stable scaffolding under uncertainty on which subsequent skill selection and scheduling operate. Within the CIF stratum, a task encoder embeds the active task-graph fragment while a capability-manifold encoder embeds the registered agent/skill population into a shared metric space. A Distance Oracle computes composite distances between the two embeddings and emits capability-gap signals where the current cohort is insufficient. To prevent flapping and over-reactivity as context evolves, a Hysteresis Controller damps spurious oscillations and a Contrastive Calibration Layer widens/narrows decision margins using hard-negative/near-miss structure in the manifold. The result is a context-specific skill roster (cohort) rather than brittle single-model picks.

Each selected skill is realized as an agent capsule (AC) governed by an agent capability contract (ACC) that specifies inputs/outputs, retrieval guarantees and freshness windows, safety class, privacy constraints, and performance SLAs. Capsules carry capability signatures, telemetry, and provenance, and are indexed in a policy-controlled Capability Registry providing read/write APIs, dependency resolution, semantic search, and a provenance ledger. The registry lets the orchestrator assemble auditable, context-specific subgraphs while enforcing privacy and compliance across organizational boundaries.

When the cohort lacks a required function, the gap-closure and subgraph-surgery tier activates. A candidate generator synthesizes blueprints by parameter-efficient specialization (e.g., PEFT), distillation from macro-agents, program/tool synthesis, or retriever-augmented constructs with explicit index-freshness and privacy constraints. A Spawn Coordinator provisions candidates into a sandbox for evaluation against cohort rehearsal buffers; successful candidates are packaged/registered and grafted into the live plan as macro-agent subgraphs. Promotion is measured and reversible: shadow mode→A/B evaluation→contextual bandit gating with policy and SLO checks, and instant fallback chains on violation.

The memory and long-context tier leverages the CIF universal multi-modal KV subsystem with policy based cache fusion (overlay retrieval) so partial computations can be shared with privacy guarantees. Long prompts and map-scale context are converted to constant-time, constant-space lookups via cartridge/overlay structures while preserving cryptographic integrity and latency SLAs. Reasoning steps and plan states are written as symbolically compressed traces—typed KV tuples with causal edges—for replay, attribution, and cohort learning at scale. Optionally, Memory-Mosaic levels (short-term/long-term/persistent) supply adaptive-bandwidth associative retrieval with gated time-variant keys, giving position-invariant access to far context and rapid new-task adaptation without re-training; these mosaics complement CIF overlays.

Neurosymbolic planning occurs under the AEF decision-logic domain. The LLM orchestrator proposes DAG expansions; AEF's interpretable, differentiable logic layers enforce rule-level constraints—e.g., animal-welfare protocols, airspace rules for drones, habitat ethics—and the CIF orchestrator routes work to capsules accordingly. A Resource Allocation Arbiter solves convex/MILP assignments over FLOPs, memory bandwidth, and accelerator cycles, ensuring the context-specific plan is feasible under live system budgets, while a Plugin Lifecycle Orchestrator and RDMA-backed inter-plugin fabric provide dependable execution.

The multispecies collaboration layer (MCL) forms the output/effectors tier. It includes species-specific communication modules, animal neural-decoding that produces meaning vectors, cross-species behavioral models, and an output generator that selects audio/visual/haptic/neural stimuli appropriate to each species. Plans can target MCL modules directly, enabling bidirectional intent exchange among humans, animals, and robots.

A data and continual-learning pipeline closes the loop. A dataset builder enclave assembles rehearsal buffers, augmentation, labeling, and privacy controls backed by shared KV partitions. New or updated capsules are trained/validated on cohort-scoped benchmarks to mitigate drift. A lifecycle manager performs similarity clustering and de-duplication, drift detection, rehearsal-based refresh, and graceful retirement; all operations are logged to the provenance ledger so improved skills become discoverable with known SLAs and compatibility guarantees.

Finally, a security, privacy, and deployability envelope spans the stack: secure delegation, instruction-data separation, quantum-resistant enclaves, and policy-based cache fusion enable cross-organization and cross-tenant collaboration with accountability. The modular design supports incremental adoption—from single node to distributed field deployments—and positions the CIF/AEF substrate as an extensible base for domain-specific skill app stores, with ACC-declared SLAs, versioning, migration shims, and semantic search governing capsule lifecycle and interoperability.

In sum, this presents a layered, auditable, and safely extensible system in which CIF provides orchestration and memory foundations, AEF supplies interpretable scenario logic and governance, and together they enable stable context modeling, cohorting, live subgraph surgery, far-context reasoning, multispecies actuation, and continuous improvement in dynamic, real-world settings.

In an embodiment, a secure, multi-tenant, multispecies communication platform coordinates humans, robots, animals, artificial agents, and software applications via a neurosymbolic, multimodal pipeline. A unified interaction bus normalizes audio, video, kinematics, biosignals, text, robot telemetry, and software messages into typed events. Modality experts—comprising both LLM and non-LLM models such as diffusion systems, VAEs, and discriminative classifiers—are orchestrated by a reasoning controller that compiles symbolically compressed traces of goal stacks, plan graphs, predicate bindings, and temporal constraints from distributed evidentiary signals. A policy-and-security fabric enforces quantum-resistant cryptography, homomorphic analytics, and privacy-preserving federation. Edge devices (e.g., wearables, collars, drones, robots, gateways) host debate microservices that can reach local consensus on state and action proposals when bandwidth is constrained or cloud connectivity is unavailable. The platform exposes real-time translation APIs, tenancy isolation, and subscription metering to support conservation, agriculture, veterinary, insurance, research, consumer, and robotics verticals.

In another embodiment, the system provides biometric authentication for animals to realize a cross-species digital identity. A persistent, multimodal identity stack enables cryptographically verifiable authentication, individualized model personalization, and longitudinal health/behavior tracking. The identity operates at the edge (e.g., smart collar, barn robot, drone, autonomous buoy) and in the cloud, and interworks with human, robot, and software agents via the standardized message bus. Each animal is represented by a species-aware, individual-discriminative embedding bound to a Decentralized Identifier (DID:animal) anchored to a post-quantum keypair. Identity services expose APIs for 1:1 verification, 1:N identification, continuous authentication, and policy-gated actuation (e.g., which robot may interact or which treatment protocol may execute), with calibrated abstain/unknown outcomes under uncertainty. The pipeline includes an enrollment orchestrator for guided capture; modality extractors for acoustic, kinematic/gait, visual/posture, and behavioral rhythms; a fusion/metric-learning head producing per-species embeddings with individual discriminability; a probabilistic identity inference layer supporting open-set rejection; a liveness/spoof-resistance module combining active challenge-response with passive cross-modal consistency; and an identity vault that binds the DID to fine-tuning deltas, care/safety policies, and RBAC rights for devices and agents. The vault synchronizes with a multi-tenant ledger under quantum-resistant signatures, while edge nodes hold short-term verifiers and the cloud maintains archival trajectories and drift monitors. Enrollment captures species-typical audio, gait/video or IMU sequences, and behavioral state transitions across varying conditions to promote invariance; features are extracted (e.g., mel/CQT spectrograms with TCN/conformer encoders for audio; pose-graphs and stride-level features for gait) and fused by a species-conditioned transformer optimized with ArcFace/AM-Softmax and triplet/n-pair objectives and calibrated with temperature scaling. Profiles store distributional parameters and liveness baselines, and DIDs are provisioned in secure elements. At run-time, Bayesian posteriors over enrolled profiles are computed and smoothed with semi-Markov filters and cross-modal consistency checks; continuous authentication enforces sliding-window re-verification for safety-critical actuation. Liveness integrates active edge challenges (e.g., vibrotactile/acoustic cues with expected micro-movements) and passive signal forensics; successful authentication indexes personalization artifacts (per-animal model deltas, care protocols, RBAC policies) and executes under signed, attested manifests. All operations are time-stamped and signed; the vault supports key rotation, revocation, custody transfer, and multi-signature guardianship, and optional homomorphic analytics permit privacy-preserving watchlists and epidemiology. Drift monitoring triggers assisted re-enrollment, and open-set handling promotes provisional clusters to enrolled profiles as needed. This identity layer enables personalization, safe autonomy through identity-gated actuation, and regulatory-grade traceability across multi-tenant deployments.

In a further embodiment, a safety-critical multimodal synthetic data foundry generates high-fidelity training/evaluation corpora for rare or emergency behaviors (e.g., distress, predation, disease onset, poisoning, hypothermia, separation, wildfire/flood exposure). The foundry can be invoked proactively to close data gaps or reactively to probe model invariances and failure modes. A generative ensemble, parameterized by a structured condition vector (species, subspecies, age/sex, reproductive state, vocal apparatus, environmental context, physiological state), synthesizes coordinated audio, vision/pose, and biometrics bound by a shared timeline. Audio is produced by conditional spectrogram diffusion models with neural vocoders and optional low-dimensional control latents; pose/video are generated by pose-conditioned latent diffusion subject to dynamics and contact constraints; biometrics are generated by conditional time-series synthesizers coupled to audio/pose for coherence; and cross-modal consistency is enforced with cycle/contrastive objectives and mutual-information critics. A simulator-in-the-loop ties synthesis to agent-based ecology and robot digital twins, constraining kinematics, acoustics, and sensor observations to field-feasible regimes. Counterfactual suites sweep semantic sliders (e.g., pitch, inter-call interval, stride variability, HRV) to audit robustness and inform abstain/guardrail rules. All artifacts are cryptographically watermarked and recorded with signed provenance; synthetic catalogs are segregated with leakage controls and holdout “phantoms” reserved for stress tests. Training schedulers mix real/synthetic data with domain-alignment losses; inference calibrators are trained on synthetic shocks and expose abstain modes when inputs fall into uncovered regions.

In yet another embodiment, edge-native debate systems provide federated consensus at the edge. A mesh of on-device debaters—collars, tags, fixed IoT nodes, robots, mobile handsets—produces low-bitrate evidences with micro-experts (e.g., keyword/syllable detectors, beat trackers, pose estimators, biosignal anomaly detectors, environment recognizers), a micro-planner that forms claims with posteriors and symbolic reasoning sketches, a gossip layer, a lightweight BFT consensus with committee sampling, and a neurosymbolic arbitration layer enforcing safety and ethics. Devices reach local, privacy-preserving consensus on tuples [symbol] species, individual_ID, state, urgency, recommended_action, validity_horizon [symbol] and retain compact, cryptographically chained debate graphs for audit and global learning. Message grammars are size-bounded and signed; energy budgets accommodate MCU-class devices; transport is AEAD-encrypted and can employ post-quantum KEMs; identity gates ensure that individual-linked actions are permitted under confidence thresholds. This enables ultra-low-latency, fault-tolerant operation in remote or bandwidth-limited environments and defines an edge API for third-party devices.

Engineering variations include tight coupling to the LLM-based orchestrator (which plans foundry jobs, selects micro-experts, and updates rule packs using text-serializable interfaces), symbolic coverage accounting to target synthesis where semantics are sparse, edge/cloud co-training with differential privacy, device-specific domain randomization to improve fleet transfer, and certification hooks whereby watermarked synthetic suites and debate traces serve as regulator/insurer evidence packs.

Finally, in a commercial platform embodiment for cross-species learning transfer and real-time translation/control, the service exposes low-latency APIs for streaming observations and issuing safety-gated actions, hosts per-tenant model stacks with isolation, and offers subscription layers for advanced analytics while retaining a free translation tier. A neurosymbolic core grounded in a long-context memory substrate and a cross-species ontology aligns continuous embeddings with logic-level predicates so explanations, audits, and privacy-preserving analytics are first-class. The memory substrate may employ a three-level associative design (short-term, long-term, persistent) with adaptive kernel bandwidth, thereby sustaining in-context learning and constant-time retrieval over very long traces and providing superior new-task learning at inference time relative to attention-only baselines.

In one implementation, the platform maintains a phylogenetic knowledge graph (PKG) whose nodes correspond to species, including “robot species” characterized by morphology and capability descriptors, and whose edges encode evolutionary proximity, vocal-tract similarity, gait/kinematics affinities, and social structure (for example, solitary, pair-bonded, herd). Each node stores distributional priors over acoustic formants, gesture kinematics, prosodic contours, and canonical social acts (ALARM, APPEASE, CALL-TO-MOVE). During both training and inference, a graph-conditioned adapter layer performs message passing over the PKG to synthesize adapter weights and calibration constants for the active subject, such as expected energy bands, stride statistics, and latency tolerances. Novel species or new robot platforms bootstrap from the most proximate nodes and adapt with a few enrolled exemplars, while domain-shift monitors detect negative transfer and trigger reversion to species-neutral baselines with increased abstention.

A symbol-alignment module binds continuous observations to logic-level predicates via a cross-species ontology. Learned translators map these ontology predicates to species-specific surface realizations: vocalizations for animals, gesture scripts for robots, and UI/notification primitives for software agents. Because the ontology lives at the predicate layer, a single plan such as APPEASE(Subject=A, Target=B) can compile to an orca prosodic motif, a dog-whistle pattern, a choreographed UGV approach, or a mobile-app message, each selected by capability negotiation and local safety rules. A long-context memory substrate supports comparative reasoning across families and seasons using short-term and long-term associative stores; an adaptive-bandwidth mechanism scales retrieval fidelity with the number of available exemplars and the context length, enabling robust few-shot transfer in field conditions.

The system exposes real-time translation and control APIs over streaming endpoints (for example, gRPC/WebRTC) that accept multiplexed channels—audio in PCM/Opus, video in H.264/HEVC, and inertial/physiological telemetry such as IMU, HRV, and temperature—with per-stream timestamps, jitter buffers, and backpressure control to sustain edge operation. Contracts and schemas (e.g., AVRO or Protocol Buffers) define canonical messages including Observation, IdentityAssertion, Interpretation (predicates with confidences), ActionProposal, Plan, and DebateOutcome. Every ActionProposal carries a machine-readable safety case enumerating invariants checked, risk scores, provenance of experts invoked, and a symbolic proof sketch generated by the rule layer; consumers must acknowledge capabilities (actuator types, maximum force/speed, spatial constraints) before capability-scoped tokens are minted for actuation. Extensibility is provided by a plug-in expert registry where new modalities or algorithms register with self-describing metadata, test vectors, and safety manifests. The orchestrator—implemented as an LLM or a memory-mosaics-based controller—invokes experts via function-calling contracts, composes their outputs, and persists symbolically compressed traces (predicates, bindings, temporal relations) signed with post-quantum (PQ) signatures. The long-context memory stack enables on-the-fly tool composition over extended scenes (for example, hours-long herd migration), supporting stable task decomposition and reuse of earlier observations during continuous operation.

A multi-tenant enterprise platform provides strong isolation. Each tenant is provisioned a logical data vault protected by a dedicated KMS domain; compute is sandboxed using namespaces and cgroups with policy firewalls governing inter-service calls. Access control combines RBAC/ABAC with purpose binding (e.g., a conservation ranger may read poaching-alert traces but cannot invoke veterinary interventions). Tenant-specific model stacks are assembled by loading base encoders with adapter/LoRA layers tuned to the tenant's species mix, sensors, and environments. Risk-controlled rollout is supported via A/B slots and canary traffic, while online drift monitors trigger rollbacks or automatic elevation of abstain thresholds. Every decision links to a compact audit artifact comprising hashed inputs, consulted experts and versions, debate graphs, rules fired and proofs, memory pointers used during inference (short-term/long-term), and PQ signatures for non-repudiation. Persistent ontology versioning allows regulators and insurers to reproduce historical decisions under prior semantics, and the memory design's separation between persistent knowledge and scene-specific evidence improves explainability during audits.

To democratize access while monetizing advanced automation, the service is tiered. A free/basic tier provides on-device summaries and delayed cloud insights; a pro tier enables real-time streaming, identity personalization, and API access; and an enterprise tier unlocks predictive health, cross-species transfer modules, edge-debate federation, and compliance packs. Usage is metered at the API gateway (for example, minutes of audio processed, events interpreted, actions executed) and is signed with PQ tokens; feature flags gate model families, context lengths, and safety curves. A curated marketplace offers certified plug-ins such as marine prosody decoders and avian flocking planners, with revenue share enforced by signed execution receipts. Tenants can upgrade or downgrade without migration by hot-swapping adapter stacks and policy bundles.

Cross-cutting neurosymbolic and memory features enforce safety and maintain long-horizon competence. A neurosymbolic arbitration layer encodes safety and ethics constraints in temporal logic (event calculus), evaluates plans produced by the orchestrator, and issues vetoes or requirement refinements before actuation. For bandwidth and privacy efficiency, the system persists symbolically compressed traces in lieu of raw media wherever feasible, enabling encrypted statistics, homomorphic-encryption-based analytics, and compact re-explanations. Bidirectional generation compiles human intents to species-appropriate outputs—diffusion-based audio for calls, gesture scripts for robots, and vibration/light patterns for wearables—selected by ontology mappings and gated by rules. The memory substrate combines short-term and long-term associative stores with a dense persistent layer so that the controller can retrieve relevant history and exemplars over very long operations (such as migration seasons and evolving herd social structure). Adaptive kernel bandwidth and gated, time-variant key extraction maintain retrieval fidelity as the memory grows, enabling scaling to long contexts without explicit positional encodings and supporting few-shot adaptation in the field.

Representative end-to-end scenarios include ranch operations and coastal conservation. In a ranch workflow, a human issue “hold the north gate,” the system authenticates the herding dog and nearest UGV, and the ontology compiles canine whistle sequences for the dog and waypoint constraints for the vehicle. Edge debaters (collars plus UGV) form a quorum, confirm low agitation, and approve a staged plan; the long-context memory retrieves recent agitation and location traces to anticipate spillover; and execution artifacts (debate graph, rule proof, memory pointers) are archived for insurer review. In a coastal conservation scenario, hydrophones detect atypical orca calls and buoy nodes exchange claims; mesh debate converges on “distress/entanglement,” the plan compiler emits drone dispatch plus a calming prosodic motif conditioned on the family signature, actuation tokens are released only after vessel capabilities are acknowledged and safety invariants pass, and all decisions include long-term memory links to prior family interactions so responders immediately see context.

Implementation notes include construction of the PKG from curated taxonomies and sensor-derived similarities; training graph-conditioned adapter generators (for example, GNNs or hypernetworks) that output per-species calibration vectors such as acoustic band and stride priors; and coupling with few-shot routines that store adapter deltas in identity-scoped slots. The orchestrator emits function-call DAGs over registered experts, each with type-checked request/response schemas and safety manifests; predicate-level outcomes are persisted with provenance, and memory keys/values reference raw media only when necessary. A three-level memory strategy derives keys from the recent past (gated recurrent extractor) and values from the near future, populates short-term and long-term associative stores under adaptive bandwidth scheduling, and reserves persistent memory for dense layers; at inference, the controller blends short-term and long-term results before rule evaluation. APIs define Observation, Interpretation, ActionProposal, Plan, DebateOutcome, and AuditTrace messages; capability acknowledgments and embedded safety cases are required before actuation; per-tenant rate limits and signed receipts support billing. Tenancy is isolated by per-vault KMS, namespaces, and policy firewalls, and every decision emits an AuditTrace with hashes, expert lineage, debate graph, rules, memory references, and PQ signatures to a write-once ledger for regulator and insurer access.

### Exemplary Computing Environment

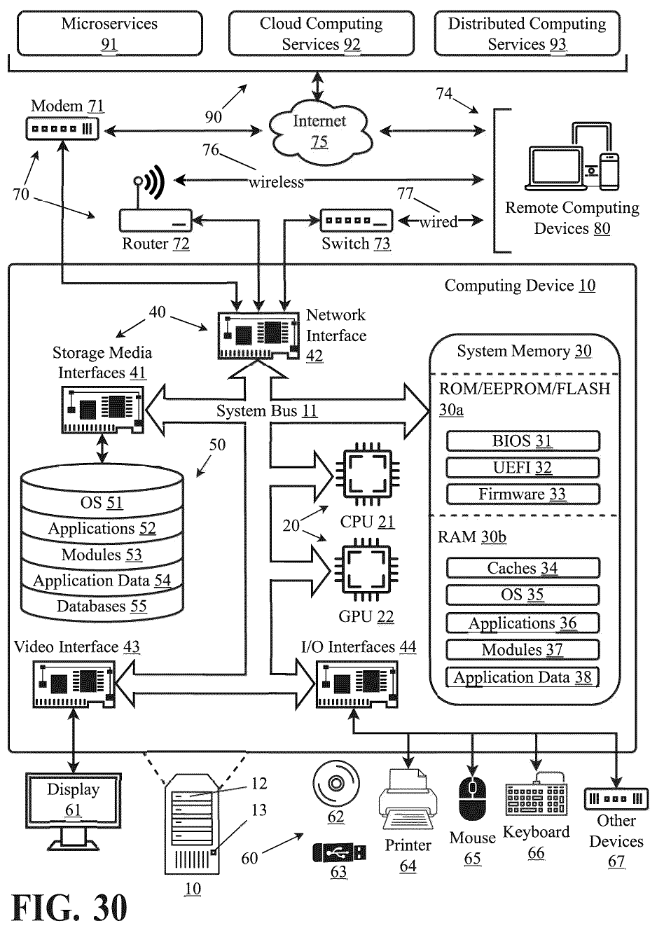

FIG. 30 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid-state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, BOSQL databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that enables packaging and running applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containers or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, gRPC, or message queues such as Kafka. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for animal-to-human communication, comprising:
a computing device comprising at least a memory and a processor; and
a plurality of programming instructions that, when operating on the processor, cause the computing device to:
receive non-human animal communication data comprising at least two modalities selected from vocalizations, neural signals, movement patterns, and biometric indicators; and
process the non-human animal communication data through a machine-learning system, wherein the machine-learning system is trained using unsupervised clustering and pattern recognition techniques on unlabeled multimodal animal behavioral data, and wherein the machine-learning system is configured to:
perform a debate-based oversight process using at least two competing machine learning models to obtain a decision on one or more meanings for the non-human animal communication data;
associate the one or more meanings with a human interpretation based on contextual correlation with observed behavioral outcomes; and
perform a cross-species operation based on the human interpretation.

2. The system of claim 1, wherein the plurality of programming instructions further includes instructions to perform an additional translation stage, wherein the additional translation stage comprises converting the human interpretation to a robot command.

3. The system of claim 2, wherein the plurality of programming instructions further includes instructions to perform a debate-based oversight process on the additional translation stage as part of the converting the human interpretation to the robot command.

4. The system of claim 3, wherein the plurality of programming instructions further includes instructions to store the non-human animal communication data, debate-based oversight outcome data, and human interpretation in an embeddings cache.

5. The system of claim 3, wherein the debate-based oversight process is configured to use a primary debate machine-learning system and a secondary debate machine-learning system, wherein the primary debate machine-learning system is trained on a primary dataset, and wherein the secondary debate machine-learning system is trained on a secondary dataset, wherein the primary dataset is larger than the secondary dataset.

6. The system of claim 5, wherein the primary debate machine-learning system comprises a large language model, and the secondary debate machine-learning system comprises a small language model.

7. The system of claim 5, wherein the primary debate machine-learning system comprises a large language model, and the secondary debate machine-learning system comprises a generative adversarial network (GAN).

8. The system of claim 3, wherein the debate-based oversight process is configured to use a first expert debate machine-learning system, a second expert machine-learning system, and a judge machine-learning system, wherein the first expert debate machine-learning system and second expert debate machine-learning system are trained on a primary dataset, and wherein the judge machine-learning system is trained on a secondary dataset, wherein the primary dataset is larger than the secondary dataset, and wherein the judge machine-learning system is configured to select a human interpretation result from one of the first expert debate machine-learning system and the second expert debate machine-learning system.

9. The system of claim 8, wherein the plurality of programming instructions further includes instructions to perform a Monte Carlo Tree Search process to prune a branch corresponding to the human interpretation result that was selected, based on multimodal input data.

10. A method for animal-to-human communication, comprising:
receiving non-human animal communication data comprising at least two modalities selected from vocalizations, neural signals, movement patterns, and biometric indicators; and
processing the non-human animal communication data through a machine-learning system, wherein the machine-learning system is trained using unsupervised clustering and pattern recognition techniques on unlabeled multimodal animal behavioral data, and wherein the machine-learning system is configured to:
performing a debate-based oversight process using at least two competing machine learning models to obtain a decision on one or more meanings for the non-human animal communication data;
associating the one or more meanings with a human interpretation based on contextual correlation with observed behavioral outcomes; and
performing a cross-species operation based on the human interpretation.

11. The method of claim 10, further comprising performing an additional translation stage, wherein the additional translation stage comprises converting the human interpretation to a robot command.

12. The method of claim 11, further comprising performing a debate-based oversight process on the additional translation stage as part of the converting the human interpretation to the robot command.

13. The method of claim 12, further comprising storing the non-human animal communication data, debate-based oversight outcome data, and human interpretation in an embeddings cache.

14. The method of claim 12, wherein performing the debate-based oversight process comprises using a primary debate machine-learning system and a secondary debate machine-learning system, wherein the primary debate machine-learning system is trained on a primary dataset, and wherein the secondary debate machine-learning system is trained on a secondary dataset, wherein the primary dataset is larger than the secondary dataset.

15. The method of claim 12, wherein performing the debate-based oversight process comprises using a first expert debate machine-learning system, a second expert machine-learning system, and a judge machine-learning system, wherein the first expert debate machine-learning system and second expert debate machine-learning system are trained on a primary dataset, and wherein the judge machine-learning system is trained on a secondary dataset, wherein the primary dataset is larger than the secondary dataset, and wherein the judge machine-learning system is configured to select a human interpretation result from one of the first expert debate machine-learning system and the second expert debate machine-learning system.

16. The method of claim 15, further comprising performing a Monte Carlo Tree Search process to prune a branch corresponding to the human interpretation result that was selected, based on multimodal input data.

17. A non-transitory, computer-readable medium comprising programming instructions for an electronic computation device executable by a processor to cause the electronic computation device to:
receive non-human animal communication data comprising at least two modalities selected from vocalizations, neural signals, movement patterns, and biometric indicators; and
process the non-human animal communication data through a machine-learning system, wherein the machine-learning system is trained using unsupervised clustering and pattern recognition techniques on unlabeled multimodal animal behavioral data, and wherein the machine-learning system is configured to:
perform a debate-based oversight process using at least two competing machine learning models to obtain a decision on one or more meanings for the non-human animal communication data;
associate the one or more meanings with a human interpretation based on contextual correlation with observed behavioral outcomes; and
perform a cross-species operation based on the human interpretation.

18. The computer-readable medium of claim 17, wherein the computer-readable medium further comprises programming instructions that, when executed by the processor, cause the electronic computation device to perform an additional translation stage, wherein the additional translation stage comprises converting the human interpretation to a robot command.

19. The computer-readable medium of claim 18, wherein the computer-readable medium further comprises programming instructions that, when executed by the processor, cause the electronic computation device to perform a debate-based oversight process on the additional translation stage as part of the converting the human interpretation to the robot command.

20. The computer-readable medium of claim 19, wherein the computer-readable medium further comprises programming instructions that, when executed by the processor, cause the electronic computation device to store the non-human animal communication data, debate-based oversight outcome data, and human interpretation in an embeddings cache.
